(19) United States
(12) Patent Application Publication
(10) Pub. No.: US 2021/0301229 A1
(43) Pub. Date: Sep. 30, 2021

(54) Device And Method For Producing A Water-Soluble Shell And Washing Or Cleaning Agent Portions Containing This Water-Soluble Shell

(71) Applicant: Henkel AG & Co. KGaA, Duesseldorf (DE)

(72) Inventors: Matthias Sunder, Duesseldorf (DE); Katja Gerhards, Duesseldorf (DE); Steffen Ristau, Duesseldorf (DE); Thomas Weber, Weimar (Lahn) (DE)

(21) Appl. No.: 17/347,331

(22) Filed: Jun. 14, 2021

Related U.S. Application Data
(63) Continuation of application No. PCT/EP2019/083344, filed on Dec. 2, 2019.

(30) Foreign Application Priority Data
Dec. 13, 2018 (DE) 102018221674.6

(51) Int. Cl. C11D 17/04; C11D 13/16

(52) U.S. Cl. CPC C11D 17/045; C11D 13/16

(57) ABSTRACT

A device for producing a water-soluble shell for receiving a filling substance, the device having a basin which is filled with a melt of a shell material, wherein the shell material is polymer-containing and water-soluble and solid under normal conditions, and a male mold which is movably arranged in the region of the basin, can be automatically submerged into the melt and can be removed from the basin in order to form a water-soluble shell optionally abutting the male mold. The invention also relates to a corresponding method and a corresponding shell and a corresponding portion for use as a washing or cleaning agent.

### FIELD OF THE INVENTION

The invention relates to a method for producing a water-soluble shell and/or a water-soluble washing or cleaning agent portion.

### BACKGROUND OF THE INVENTION

Water-soluble metering units are known, for example, from EP 2 102 326 A1. A washing or cleaning agent portion of this kind comprises a first metering unit having a completely closed water-soluble container made of a transparent or translucent polymeric material and a first washing or cleaning agent preparation enclosed in the container.

Such a portion contains a filling substance which generally comprises one or more than one active ingredient.

In the context of this patent application, an active ingredient is understood to be a chemical compound other than water which (optionally in conjunction with further ingredients of a washing or cleaning agent) has an effect on a substrate surface, in particular on textile surfaces or hard surfaces (such as dishes). Such effects are in particular a cleaning effect, a care effect, a protective effect or mixtures thereof.

The production of said metering units or portions is often associated with considerable time and effort. In the production process of said washing or cleaning agent portions, water-soluble films are generally used as the shell material. The device used for production processes said water-soluble film and has thermoforming chambers, in which said water-soluble film is formed into a desired shape. The film can be damaged in the process, and modifications to the shell geometry are only possible by providing alternative thermoforming chambers, which requires considerable costs and manufacturing complexity.

Washing or cleaning agent portions are also known from WO 02/06431 A2, of which the filling substance is encased in shells made of cast shell material. The shell material can be created by filling the flowable shell material into an open shaping die and removing the excess mass from the shaping die. In this case, an optionally cooled male mold can press the shell material against the walls of the shaping die, as a result of which a hollow shape is produced which functions as a shell for the portion.

In addition to the production-related tasks, the washing or cleaning agent portions must have good dissolving or dispersing power in an aqueous washing or rinsing liquor when used, in particular when used in a washing machine or dishwasher, and must deliver a good cleaning performance on the substrate.

### BRIEF SUMMARY OF THE INVENTION

The object of the present invention is that of providing a device and a method in which simplified manufacturing of water-soluble shells and water-soluble washing or cleaning agent portions containing said shells is possible. The resulting shells, or the washing or cleaning agent portions according to the invention, should each dissolve well in water, in particular when used in a washing machine for textiles (preferably when metered into the drum of the washing machine for textiles) or a dishwasher.

The aforementioned objects are achieved by means of a device for producing a water-soluble shell for receiving a filling substance, a method for producing the water-soluble shell, and portions for use as a washing or cleaning agent. The claims specify advantageous further developments of the invention.

The invention provides a device for producing a water-soluble shell for receiving a filling substance, the device comprising a basin which is filled with a melt of a shell material, wherein the shell material is polymer-containing and water-soluble and solid under normal conditions, and a male mold which is movably arranged in the region of the basin, can be automatically submerged into the melt and can be removed from the basin in order to form a water-soluble and solid shell (optionally, but preferably abutting the male mold) made of the shell material.

A substance (e.g., a composition) is liquid according to the definition of the invention if it is in the liquid state of matter at 20° C. and 1013 mbar.

A substance (e.g., a composition) is solid or solidified according to the definition of the invention if it is in the solid state of matter at 20° C. and 1013 mbar.

As is known, and therefore according to the invention, a substance (e.g., a composition) is viscoelastic and solid when the storage modulus of the substance is greater than the present loss modulus at 20° C. When mechanical forces are applied to the substance, it has the properties of an elastic solid, and also exhibits a viscosity similar to that of a liquid. The terms of the storage modulus and the loss modulus, and the determination of the values of these moduli, are notoriously familiar to a person skilled in the art (cf. Christopher W. Macosco, “Rheology Principles, Measurements and Applications,” VCH, 1994, p. 121 ff. or Gebhard Schramm, “Introduction to Rheology and Rheometry,” Karlsruhe, 1995, p. 156 ff. or WO 02/086074 A1, p. 2, 3rd paragraph up to p. 4, end of 1st paragraph).

In the context of this invention, the rheological characterization is carried out by means of a rotational rheometer, for example type AR G2 from TA-Instruments or “Kinexus” from Malvern, using a cone-plate measuring system of a 40 mm diameter and 2° opening angle at a temperature of 20° C. The above-mentioned rheometer is a shear stress-controlled rheometer. However, the determination can also be carried out using other instruments or measurement geometries of comparable specifications.

The measurement of the storage modulus (abbreviation: G′) and of the loss modulus (abbreviation: G″) (the unit in each case was Pa) is taken using the above-described equipment in an experiment involving oscillating deformation. For this purpose, the linear viscoelastic region is first determined in a stress sweep experiment. In this case, the shear stress amplitude is increased at a constant frequency of, for example, 1 Hz. The moduli G′ and G″ are plotted in a log-log plot. Either the shear stress amplitude or the (resulting) deformation amplitude can be plotted on the x axis. The storage modulus G′ is constant below a certain shear stress amplitude or deformation amplitude, above which it collapses. The break point is expediently determined by applying tangents to the two portions of the curve. The corresponding deformation amplitude or shear stress amplitude is usually referred to as “critical deformation” or “critical shear stress.”

In order to determine the frequency dependence of the moduli, a frequency ramp, e.g. between 0.01 Hz and 10 Hz, is performed at a constant deformation amplitude. The deformation amplitude has to be selected such that it is within the linear range, i.e. below the above-mentioned critical deformation. In the case of the compositions according to the invention, a deformation amplitude of 0.1% has been found to be suitable. The moduli G′ and G″ are plotted against the frequency in a log-log plot.

Normal conditions are understood to mean everyday ambient conditions with regard to temperature and pressure, for example temperatures in the range of from 0° C. to 45° C., in particular 15° C. to 30° C., preferably 20° C. to 25° C., and, in each case, an air pressure of approximately 0.9 atm to 1.1 atm. Unless explicitly defined differently below, parameters that must explicitly be met in the context of this invention under normal conditions must be met for all everyday ambient conditions with regard to temperature and pressure, in particular for the temperature and pressure ranges mentioned.

A substance is water-soluble if at least 0.1 g of the substance dissolves in 100 ml of distilled water at 20° C.

The water solubility of the shell material can be determined using a cuboid piece of said shell material that is centrally fixed (long edge frame in parallel with the long edge of the shell material) in a rectangular metal frame (edge lengths on the inside in mm: 33×22, thickness: 3 mm; outside in mm: 52×42, thickness: 2 mm) having edge lengths in mm of 60×22×2 (produced from the melt of the shell material in a silicone casting mold; weighed in said frame before being fixed) according to the following measurement protocol. Said framed cuboid shell material is submerged into 800 ml of distilled water, temperature-controlled to 20° C., in a 1 liter beaker with a circular base (Schott, Mainz, beaker glass 1000 ml, low shape), so that the surface of the tensioned shell material is arranged at a right angle to the base of the beaker, the upper edge (shorter edge) of the frame is 2 cm below the water surface, and the lower edge of the frame (shorter edge) is oriented in parallel with the base of the beaker such that the lower edge of the frame extends along the diameter of the base of the beaker and the center of the lower edge of the frame is arranged above the center of the diameter of the beaker bottom. The shell material should dissolve when stirred (stirring speed, magnetic stirrer 400 rpm, stirring rod: 6.8 cm long, diameter 10 mm) within 6000 seconds in such a way that it is immediately filtered out of the aqueous phase after the measurement (folded filter paper: diameter: 185 mm, 0.16 mm thick, 70 g/m²) and, after drying (120 minutes at 50° C. in a drying cabinet), gravimetrically determined residue mass of the shell material is less than 30 wt. % based on the weight of the rectangular initial shell material. The mean value from 5 experiments is formed (arithmetic mean).

A chemical compound is an organic compound if the molecule of the chemical compound contains at least one covalent bond between carbon and hydrogen. This definition applies, mutatis mutandis, to, inter alia, “organic solvent” as the chemical compound.

By implication from the definition of an organic compound, a chemical compound is an inorganic compound if the molecule of the chemical compound does not contain a covalent bond between carbon and hydrogen.

A person skilled in the art understands a polymer to be a macromolecule which, in its molecular structure, contains at least ten repeating units (repeat units) which have been formed by the polyreaction of at least one monomer. According to the present invention, polymers have an average molar mass of at least 800 g/mol. A monomer is a set of molecules having the same molecular structure which, through polyreaction, can form a macromolecule which contains repeat units formed from the monomer. A homopolymer is a polymer which has been formed from a monomer. A copolymer is a polymer which has been formed from at least two monomers. Polyreaction is a method for converting at least one monomer into polymers.

The average molar masses specified for polymers and/or polymeric ingredients in the context of this application are always, unless explicitly stated otherwise, weight-average molar masses M_{w}, which can in principle be determined by means of gel permeation chromatography using an RI detector, it being expedient for the measurement to be carried out as per an external standard.

Within the meaning of the invention, a surfactant-containing liquor is a liquid preparation for treating a substrate that can be obtained by using a surfactant-containing agent which has been diluted with at least one solvent (preferably water). Hard surfaces (such as dishes) or fabrics or textiles (such as clothing), for example, are considered as the substrate. The portions according to the invention are preferably used to provide a surfactant-containing liquor in the context of automatic cleaning processes, as are carried out, for example, by a dishwasher or a washing machine for textiles.

“At least one,” as used herein, refers to 1, 2, 3, 4, 5, 6, 7, 8, 9 or more. In connection with components of the compositions described herein, this information does not refer to the absolute amount of molecules, but to the type of the component. “At least one inorganic base” therefore signifies, for example, one or more different inorganic bases, i.e. one or more different types of inorganic bases. Together with quantity information, the quantity information refers to the total amount of the correspondingly designated type of component.

If, in the context of the application, numerical ranges are defined from one number to another number, then the limit values are included in the range.

If, in the scope of the application, numerical ranges are defined between one number and another number, the limit values are not included in the range.

The device necessarily comprises at least one basin which is filled with a melt of a shell material. The shell material is solid and water-soluble under normal conditions.

For the production of the melt made of the shell material, it has been found to be preferred if the ingredients of the shell material which are solid under normal conditions are present in powder form before melting. Therefore, in the context of a preferred embodiment, in order to provide the melt, the ingredients of the shell material that are solid under normal conditions are comminuted before melting in such a way that a powder having an average particle size X_{50.3} (volume average) of less than 100 μm, preferably of less than 60 μm, particularly preferably of less than 30 μm. The melt is then produced from it. Said particle sizes can be determined by sieving or by means of a Camsizer particle size analyzer from the company Retsch.

Said melt in the basin of the device preferably has a temperature of at least 60° C., more preferably at least 70° C., even more preferably at least 80° C., particularly preferably at least 100° C., very particularly preferably at least 110° C., before the male mold is immersed.

The melt of the shell material should solidify within the shortest possible time. Long solidification times would result in long production time and thus lead to high costs. According to the invention, “solidification time” is understood to mean the period of time during which the shell material transitions from a flowable state to a dimensionally stable state which is non-flowable at room temperature during production. Room temperature is to be understood as a temperature of 20° C. Without constituting a restriction, this can be done through the crosslinking of the at least one polymer.

Furthermore, the shell material must be storage stable under normal storage conditions. The shell material according to the invention formed into a shell is a constituent of a portion of a washing or cleaning agent. Washing or cleaning agents are usually stored for a certain period of time in a household. They are usually stored near the washing machine or dishwasher. The shell material should be stable for such storage. Therefore, the shell should be stable, in particular after a storage period of 4 to 12 weeks, in particular 10 to 12 weeks or longer at a temperature of up to 40° C., particularly at 30° C., in particular at 25° C. or at 20° C., and should not deform or otherwise change in consistency during this time.

Visually, the surface of the shell should stand out, for example, through its smoothness or a pronounced shine.

For an optimized dissolving speed, the shell preferably has a wall thickness in the range of from 150 to 3000 in particular from 200 to 1000 μm.

A change in volume or shrinkage of the shell during storage would be disadvantageous since this would result in poor consumer acceptance of the portion pack. A leakage of liquid during the production of the portion or the exudation of constituents from the shell is also undesirable. Here, too, the visual impression is relevant. The stability of the shell can be influenced by the leakage of liquid, such as solvents, such that the components are no longer stably contained and the washing or cleaning effect of the portion pack comprising the shell can also be influenced as a result.

Furthermore, it is possible for the filling substance and the shell to be in direct contact with one another. In this case there should be no negative interaction between the filling substance and the shell. What is understood by “no negative interaction” in this case is that, for example, no ingredients or solvents pass from the filling substance to the shell or that the stability, in particular storage stability, preferably for 4 weeks and at a storage temperature of 30° C., and/or the aesthetics of the product are not impaired in any way, for example through a change in color or by the formation of moist-looking edges, or the like.

Surprisingly, it has been found that an especially high level of storage stability is achieved if the shell material of the shell is low in water. Within the meaning of the present invention, “low in water” is understood to mean that small quantities of water can be used for producing the shell. The proportion of water in the shell material of the shell and in the melt thereof is in particular 20 wt. % or less, preferably 15 wt. % or less, particularly 12 wt. % or less, in particular between 10 and 5 wt. %. The amounts in wt. % refer to the total weight of the composition. This has the advantage that the small amounts of water in combination with the at least one polymer contained in the shell material of the shell (in particular in the case of PVOH and gelatin) can have a structure- or gel-forming effect.

According to a further embodiment, the shell is substantially water-free. This means that the shell material is preferably substantially free from water. “Substantially free” is understood to mean, in this case, that the shell may contain small quantities of water. This water can be introduced into the shell material or its melt, for example, by means of a solvent or as water of crystallization or as a result of reactions of constituents of the shell material or its melt with one another. However, water is preferably not used as a solvent for producing the shell. In this embodiment, the proportion of water in the shell material and in the melt thereof is 4.9 wt. % or less, 4 wt. % or less, preferably 2 wt. % or less, in particular 1 wt. % or less, particularly 0.5 wt. % or less, in particular 0.1 wt. % or 0.05 wt. % or less. The amounts in wt. % refer to the total weight of the composition.

The shell material and its melt necessarily contain at least one polymer. According to the invention, the shell material of the shell and its melt can comprise one polymer or two or more polymers that differ from one another.

Polymers for use in said shell material include in particular (optionally acetalized) polyvinyl alcohol (PVOH), copolymers of polyvinyl alcohol, polyvinyl pyrrolidone, polyethylene oxide, gelatin, cellulose and derivatives thereof, acrylic acid-containing polymers, polyacrylamides, oxazoline polymers, polystyrene sulfonates, polyurethanes, polyesters, polyethers and mixtures thereof, more preferably (optionally acetalized) polyvinyl alcohol (PVOH), copolymers of polyvinyl alcohol, polyethylene oxide, gelatin and mixtures thereof.

One or more material(s) from the following exemplary, but non-limiting, list can be named with particular advantage:
Mixtures of 50 to 100% polyvinyl alcohol or poly(vinyl alcohol-co-vinyl acetate) having molecular weights in the range of from 10,000 to 200,000 g/mol and acetate contents of from 0 to 30 mol %; these can contain processing additives such as plasticizers (glycerol, sorbitol, water, PEG etc.), lubricating agents (stearic acid and other mono-, di- and tricarboxylic acids), referred to as “slip agents” (e.g. “Aerosil”), organic and inorganic pigments, salts, blow molding agents (citric acid-sodium bicarbonate mixtures);
Acrylic acid-containing polymers, such as copolymers, terpolymers or tetrapolymers which contain at least 20% acrylic acid and have a molecular weight of 5,000 to 500,000 g/mol; particularly preferred comonomers are acrylic acid esters such as ethyl acrylate, methyl acrylate, hydroxyethyl acrylate, ethylhexyl acrylate, butyl acrylate, and salts of acrylic acid such as sodium acrylate, methacrylic acid and the salts and esters thereof such as methyl methacrylate, ethyl methacrylate, trimethylammonium methyl methacrylate chloride (TMAEMC) and methacrylamidopropyltrimethylammonium chloride (MAPTAC). Further monomers such as acrylamide, styrene, vinyl acetate, maleic anhydride and vinylpyrrolidone can also be advantageously used;
Polyalkylene oxides, preferably polyethylene oxides having molecular weights of 600 to 100,000 g/mol and derivatives thereof modified by graft copolymerization with monomers such as vinyl acetate, acrylic acid and salts and esters thereof, methacrylic acid and salts and esters thereof, acrylamide, styrene, styrene sulfonate and vinylpyrrolidone (example: poly(ethylene glycol-graft-vinyl acetate). The polyglycol proportion should be 5 to 100 wt. %, the graft proportion should be 0 to 95 wt. %; the graft can consist of one or more monomers. A graft fraction of 5 to 70 wt. % is particularly preferred; the water solubility decreases with the proportion of graft;
Polyvinylpyrrolidone (PVP) having a molecular weight of from 2,500 to 750,000 g/mol;
Polyacrylamide having a molecular weight of from 5,000 to 5,000,000 g/mol;
Polyethyloxazoline and polymethyloxazoline having a molecular weight of from 5,000 to 100,000 g/mol;
Polystyrene sulfonates and copolymers thereof having comonomers such as ethyl (meth)acrylate, methyl (meth)acrylate, hydroxyethyl (meth)acrylate, ethylhexyl (meth)acrylate, butyl (meth)acrylate and the salts of (meth)acrylic acid such as sodium (meth)acrylate, acrylamide, styrene, vinyl acetate, maleic anhydride, vinylpyrrolidone; the comonomer content should be from 0 to 80 mol %, and the molecular weight should be in the range of from 5,000 to 500,000 g/mol;
Polyurethanes, in particular the reaction products of diisocyanates (e.g. TMXDI) with polyalkylene glycols, in particular polyethylene glycols having a molecular weight of 200 to 35,000, or with other difunctional alcohols to give products having molecular weights of from 2,000 to 100,000 g/mol;
Polyesters having molecular weights of from 4,000 to 100,000 g/mol, based on dicarboxylic acids (e.g. terephthalic acid, isophthalic acid, phthalic acid, sulfoisophthalic acid, oxalic acid, succinic acid, sulfosuccinic acid, glutaric acid, adipic acid, and sebacic acid, etc.) and diols (e.g. polyethylene glycols, for example having molecular weights of from 200 to 35,000 g/mol);
particularly preferably a polyester which comprises at least one repeat unit from sulfoisophthalic acid as a monomer;
Cellulose ethers/esters, e.g. cellulose acetates, cellulose butyrates, methyl cellulose, hydroxypropyl cellulose, hydroxyethyl cellulose, methylhydroxypropyl cellulose; methyl hydroxyethyl cellulose;
Polyvinyl methyl ether having molecular weights of from 5,000 to 500,000 g/mol,
Polyamide polymer which preferably has molecular weights in the range of from 5,000 to 30,000 g/mol (for example Crystasense® HP 4 ex Croda); the polyamide polymer particularly preferably contains polyalkylene oxide units.

The polymer is preferably a structuring polymer, for example polyvinyl alcohol (also referred to as PVOH), PEG or gelatin. A structuring polymer is particularly suitable for forming a network. In particular, it has one, two, or more, in particular one or two, preferably one polymer which is suitable for forming a network. In addition, the shell material of the shell and its melt can have one or more polymers which do not form a network, but rather lead to a thickening and thus an increase in the dimensional stability of the shell, referred to as thickening polymers.

According to the invention, the shell material and its melt comprise the polymer suitable for forming a network in a proportion of from approximately 5 wt. % to 40 wt. %, in particular from 7 wt. % to 35 wt. %, preferably from 10 wt. % to 20 wt. %, based on the total weight of the shell material in each case. Significantly lower proportions of polymer, in particular gelatin and/or PVOH, mean that a stable shell is formed only with difficulty.

The shell material preferably comprises at least PVOH (polyvinyl alcohol) and/or at least gelatin as polymer. PVOH and gelatin are suitable for forming a network and are therefore structuring polymers. Derivatives of PVOH are also suitable.

Polyvinyl alcohols are thermoplastic polymers which are produced as white to yellowish powders, usually by hydrolysis of polyvinyl acetate. Polyvinyl alcohol (PVOH) is resistant to almost all water-free organic solvents. Polyvinyl alcohols having a molar mass of from 30,000 to 60,000 g/mol are preferably contained in the shell material.

Within the meaning of the invention, derivatives of PVOH are preferably copolymers of polyvinyl alcohol with other monomers, in particular copolymers with anionic monomers. Suitable anionic monomers are preferably vinyl acetic acid, alkyl acrylates, maleic acid and derivatives thereof, in particular monoalkyl maleates (in particular monomethyl maleate), dialkyl maleates (in particular dimethyl maleate), maleic anhydride, fumaric acid and derivatives thereof, in particular monoalkyl fumarate (in particular monomethyl fumarate), dialkyl fumarate (in particular dimethyl fumarate), fumaric anhydride, itaconic acid and derivatives thereof, in particular monomethyl itaconate, dialkyl itaconate, dimethyl itaconate, itaconic anhydride, citraconic acid (methylmaleic acid) and derivatives thereof, monoalkyl citraconic acid (in particular methyl citraconate), dialkyl citraconic acid (dimethyl citraconate), citraconic anhydride, mesaconic acid (methyl fumaric acid) and derivatives thereof, monoalkyl mesaconate, dialkyl mesaconate, mesaconic anhydride, glutaconic acid and derivatives thereof, monoalkyl glutaconate, dialkyl glutaconate, glutaconic anhydride, vinylsulfonic acid, alkyl sulfonic acid, ethylene sulfonic acid, 2-acrylamido-1-methylpropanesulfonic acid, 2-acrylamido-2-methylpropanesulfonic acid, 2-methylacrylamido-2-methylpropanesulfonic acid, 2-sulfoethyl acrylate and combinations thereof, and the alkali metal salts or esters of the above-mentioned monomers.

Particularly preferred derivatives of PVOH are those selected from copolymers of polyvinyl alcohol with a monomer, in particular selected from the group of monoalkyl maleates (in particular monomethyl maleate), dialkyl maleates (in particular dimethyl maleate), maleic anhydride, and combinations thereof, and the alkali metal salts or esters of the above-mentioned monomers. The values stated for polyvinyl alcohols themselves apply to the suitable molecular masses.

In the context of the present invention, it is preferable for the shell material to comprise a polyvinyl alcohol of which the degree of hydrolysis is preferably from 70 to 100 mol. %, in particular from 80 to 90 mol. %, particularly preferably from 81 to 89 mol. %, and in particular from 82 to 88 mol. %.

Preferred polyvinyl alcohols are those present as white-yellowish powders or granules having degrees of polymerization in the range of from approximately 100 to 2,500 (molar masses of from approximately 4,000 to 100,000 g/mol) and degrees of hydrolysis of from 80 to 99 mol. %, preferably from 80 to 90 mol. %, in particular from 87 to 89 mol. %, for example 88 mol. %, which polyvinyl alcohols accordingly also contain a residual content of acetyl groups.

PVOH powders which have the above-mentioned properties and are suitable for use in the shell material are marketed by Kuraray, for example, under the name Mowiol® or Poval®. Poval® grades are particularly suitable, in particular grades 3-83, 3-88 and preferably 4-88, and Mowiol® 4-88 from Kuraray.

The water solubility of polyvinyl alcohol can be altered by post-treatment with aldehydes (acetalization) or ketones (ketalization). Particularly preferred and, due to their decidedly good solubility in cold water, particularly advantageous polyvinyl alcohols have been produced which can be acetalized or ketalized with the aldehyde or keto groups of saccharides or polysaccharides or mixtures thereof. It is extremely advantageous to use the reaction products of polyvinyl alcohol and starch. Furthermore, the water solubility can be altered and thus set at desired values in a targeted manner using Ni or Cu salts or by treatment with dichromates, boric acid, or borax.

Gelatin is a mixture of substances composed of taste-neutral animal protein. The main component is denatured or hydrolyzed collagen, which is produced from the connective tissue of various animal species. Gelatin lacks the essential amino acid tryptophan, so it is not considered to be a complete protein. Gelatin swells in water and dissolves when heated from approximately 50° C. When cooled, a gel forms which becomes liquid again when reheated.

Surprisingly, it has been found that, with the aid of gelatin, dimensionally stable shells can be produced within a short curing time. Furthermore, the shape and size of shells produced in this way remain stable over a long period of time. No size-shrinkage is observed. Pig or bovine gelatin is preferably used as the gelatin. It has been found that the quantity of gelatin necessary varies depending on the bloom value. Preferably, the shell material therefore has gelatin having a bloom value in the range of from 60 to 225. The bloom value describes the gel strength or gelling quality of gelatin. The characteristic number is the mass in grams that is required in order for a male mold measuring 0.5 inches in diameter to deform the surface of a 6.67% gelatin/water mixture four millimeters deep without breaking it. The experiment is conducted in a standardized manner at exactly 10° C. with preceding aging of the gelatin for 17 hours.

If the shell material comprises gelatin having a bloom value of 150 or more, in particular from 180 to 225, preferably from 200 to 225, the proportion of gelatin with respect to the total weight of the shell material is preferably in the range of from 10 wt. % to 20 wt. %, in particular of from 15 wt. % to 18 wt. %. If the bloom value is less than 150, particularly from 60 to 120, preferably from 60 to 100, the proportion of gelatin with respect to the total weight of the shell material is preferably in the range of from 15 wt. % to 30 wt. %, in particular from 20 wt. % to 25 wt. %. Gelatin with a bloom value of 180 or more, in particular 200 or more, particularly 225, is preferred. By using gelatin that has an appropriate bloom value, the viscosity of the melt of the shell material can be monitored effectively during production. Additionally, the quantity of gelatin required in this case is less than when gelatins having a lower bloom value are used, which can result in a reduction in costs.

Surprisingly, it has been found that PVOH and/or gelatin is particularly well suited to producing shell material that meets the specifications outlined above. Shell material which comprises gelatin and/or PVOH is therefore particularly preferred. If the shell material also comprises PVOH in addition to gelatin, the toughness of the shell material is increased during production.

As a preferred polymer, in particular as a structuring polymer, the shell material preferably contains at least one polyalkylene glycol, in particular polyethylene glycol.

In particular, those polyethylene glycols having an average molecular weight between 800 and 8000 g/mol are suitable. The above-mentioned polyethylene glycols are particularly preferably used in quantities of from 1 to 40 wt. %, preferably from 5 to 35 wt. %, in particular from 10 to 30 wt. %, for example from 15 to 25 wt. %, in each case based on the total weight of the shell material.

A particularly preferred embodiment relates to a shell material or its melt which contains polyvinyl alcohol as a polymer in combination with polyethylene glycol. Polyethylene glycols having an average molar mass of 800 and approximately 2000 g/mol are particularly preferably used in combination with polyvinyl alcohol.

According to a particularly preferred embodiment, the shell material and its melt comprise PVOH (polyvinyl alcohol). These shell materials produced in this way are particularly high-melting, dimensionally stable (even at 40° C.) and do not change in shape during storage, or change only insignificantly. In particular, they are also less reactive with respect to a direct negative interaction with components of the filling substance. PVOH can in particular also produce low-water or water-free shell materials without any difficulties. Using PVOH as the polymer for the shell material results in low-viscosity melts at 110-120° C. which can therefore be processed particularly easily; in particular filling the melt into the container of the device can be carried out quickly and accurately without any bonding or without being inaccurately metered. Due to the rapid solidification of the melts of the shell materials using PVOH, the shells can be further processed particularly quickly. Furthermore, the good solubility of the shells produced is particularly favorable for the overall solubility of the portion as a washing or cleaning agent.

Surprisingly, it has been found that the addition of non-polymeric polyethylene glycols, i.e. those having average molar masses below 800 g/mol, to the shell material, in particular for shell material comprising polyvinyl alcohol as the polymer and for shell material comprising polyethylene glycol as the polymer, accelerates the solidification time of the melts of the shell material. This is highly advantageous, in particular for the production sequences, since further processing the shells made of said shell material in the solidified state can take place much more quickly and therefore usually more cost-effectively. It is therefore particularly advantageous if, in addition to polyvinyl alcohol, the shell material also has non-polymeric polyethylene glycols having a molar mass of between 200 and 800 g/mol, particularly preferably between 300 and 800 g/mol, for example around 400 g/mol INCI: PEG400).

Most preferably, the shell material contains non-polymeric polyethylene glycol having a molar mass between 300 and 800 g/mol in amounts of from 10 to 30 wt. % based on the total weight of the shell material.

In addition to the at least one polymer, the shell material and its melt particularly preferably additionally comprise at least one polyhydric alcohol. The at least one polyhydric alcohol allows the production of a dimensionally stable, non-flowable shell within a short solidification time which is within 15 minutes or less, particularly 10 minutes or less. Polyhydric alcohols within the meaning of the present invention are hydrocarbons in which two, three or more hydrogen atoms are replaced by OH groups. The OH groups are each bonded to different carbon atoms. No carbon atom has two OH groups. This is in contrast with (simple) alcohols, in which only one hydrogen atom is replaced by an OH group in hydrocarbons. Polyhydric alcohols having two OH groups are referred to as alkanediols, and polyhydric alcohols having three OH groups are referred to as alkanetriols. A polyhydric alcohol thus corresponds to the general formula [KW](OH)x, where KW represents a hydrocarbon that is linear or branched, saturated or unsaturated, substituted, or unsubstituted. Substitution can take place, for example, with —SH or —NH groups. Preferably, KW is a linear or branched, saturated or unsaturated, unsubstituted hydrocarbon. KW comprises at least two carbon atoms. The polyhydric alcohol comprises 2, 3 or more OH groups (x=2, 3, 4, . . . ), with only one OH group being bonded to each C atom of the KW. Particularly preferably, KW comprises 2 to 10, i.e. 2, 3, 4, 5, 6, 7, 8, 9 or 10, carbon atoms. Polyhydric alcohols in which x=2, 3, or 4 can be used in particular (for example, pentaerythritol where x=4). Preferably, x=2 (alkanediol) and/or x=3 (alkanetriol).

Particularly preferably, the shell material comprises at least one alkanetriol and/or at least one alkanediol, in particular at least one C₃ to C₁₀ alkanetriol and/or at least one C₃ to C₁₀ alkanediol, preferably at least one C₃ to C₈ alkanetriol and/or at least one C₃ to C₈ alkanediol, particularly at least one C₃ to C₆ alkanetriol and/or at least one C₃ to C₈ alkanediol, as a polyhydric alcohol. Preferably, it comprises one alkanetriol and one alkanediol as at least one polyhydric alcohol. In a preferred embodiment, the shell material thus comprises at least one polymer, in particular gelatin and/or PVOH and/or polyethylene glycol, and at least one alkanediol and at least one alkanetriol, in particular one alkanetriol and one alkanediol. A shell material comprising at least one polymer, in particular gelatin and/or PVOH and/or polyethylene glycol, and a C₃ to C₈ alkanediol and a C₃ to C₈ alkanetriol, is also preferred. A shell material comprising at least one polymer, in particular gelatin and/or PVOH and/or polyethylene glycol, and a C₃ to C₈ alkanediol and a C₃ to C₆ alkanetriol is more preferred.

Surprisingly, it has been found that, when a corresponding triol (alkanetriol) is combined with a corresponding diol (alkanediol), particularly short solidification times of the melt of the shell material can be achieved. The shells obtained are also transparent and have a glossy surface which ensures an attractive visual impression of the shells according to the invention and the portions contained therein. The terms “diol” and “alkanediol” are used synonymously herein. The same applies to “triol” and “alkanetriol.”

According to the invention, the polyhydric alcohols do not comprise any derivatives thereof, such as ethers, esters, etc.

The quantity of polyhydric alcohol or polyhydric alcohols used in the shell material according to the invention is preferably at least 45 wt. %, in particular 55 wt. % or more. Preferred amount ranges are from 5 wt. % to 75 wt. %, in particular from 10 wt. % to 70 wt. %, based on the total weight of the shell material.

Preferably, the C₃ to C₆ alkanetriol is glycerol and/or 2-ethyl-2-(hydroxymethyl)-1,3-propanediol (also called 1,1,1-trimethylolpropane) and/or 2-amino-2-(hydroxymethyl)-1,3-propanediol (TRIS, tris hydroxymethyl aminoethane).

The C₃ to C₆ alkanetriol is particularly preferably glycerol and/or 2-ethyl-2-(hydroxymethyl)-1,3-propanediol (also called 1,1,1-trimethylolpropane). The C₃ to C₅ alkanediol is preferably 1,3-propanediol and/or 1,2-propanediol. Surprisingly, it has been found that the chain length of the diol and, in particular, the position of the OH groups has an influence on the transparency of the shell. The OH groups of the diol are therefore preferably not arranged on immediately adjacent C atoms. In particular, three or four carbon atoms, in particular 3 carbon atoms, are located between the two OH groups of the diol. Particularly preferably, the diol is 1,3-propanediol. Surprisingly, it has been found that particularly good results are obtained with mixtures that comprise glycerol and 1,3-propanediol and/or 1,2-propanediol.

Particularly preferably, the shell material comprises gelatin, glycerol, and 1,3-propanediol or gelatin, 1,1,1-trimethylolpropane and 1,3-propanediol. Here, a non-flowable consistency that is dimensionally stable at room temperature can be achieved within a solidification time of 10 minutes or less that remains dimensionally stable even after an extended storage period. In addition, a corresponding shell is transparent and has a glossy surface. A particularly preferred shell and a particularly preferred shell material therefore comprises gelatin or PVOH as a polymer and 1,3-propanediol and glycerol or 1,1,1-trimethylolpropane as polyhydric alcohols.

If the shell material or its melt comprises an alkanetriol, in particular glycerol or 1,1,1-trimethylolpropane, then the proportion of alkanetriol, in particular glycerol or 1,1,1-trimethylolpropane, is between 3 and 75 wt. %, preferably 5 wt. % to 70 wt. %, in particular 10 wt. % to 65 wt. %, particularly 20 wt. % to 40 wt. %, based on the total weight of the shell material.

If the shell material or its melt optionally comprises a plurality of alkanetriol(s), then the total proportion of alkanetriol(s) is between 3 and 75 wt. %, preferably 5 wt. % to 70 wt. %, in particular 10 wt. % to 65 wt. %, particularly 20 wt. % to 40 wt. %, based on the total weight of the shell material.

If glycerol is contained as an alkanetriol in the shell material, then the proportion of glycerol is preferably 5 wt. % to 70 wt. %, in particular 10 wt. % to 65 wt. %, particularly 20 wt. % to 40 wt. %, based on the total weight of the shell material.

If 1,1,1-trimethylolpropane is contained in the shell material, then the proportion of 1,1,1-trimethylolpropane is preferably 5 wt. % to 70 wt. %, in particular 10 wt. % to 65 wt. %, particularly preferably 18 to 45 wt. %, in particular preferably 20 wt. % to 40 wt. %, based on the total weight of the shell material.

If 2-amino-2-hydroxymethyl-1,3-propanediol is contained in the shell material, then the proportion of 2-amino-2-hydroxymethyl-1,3-propanediol is preferably 5 wt. % to 70 wt. %, in particular 10 wt. % to 65 wt. %, particularly 20 wt. % to 40 wt. %, based on the total weight of the shell material.

If a plurality of alkanediols are optionally contained in the shell material, the proportion of alkanediols is preferably 5 wt. % to 70 wt. %, in particular 7 wt. % to 65 wt. %, particularly 10 wt. % to 40 wt. %, based on the total weight of the shell material.

If the shell material comprises at least one alkanediol, in particular 1,3-propanediol or 1,2-propanediol, then the proportion of alkanediol, in particular 1,3-propanediol or 1,2-propanediol, is preferably 5 wt. % to 70 wt. %, in particular 10 wt. % to 65 wt. %, particularly 20 wt. % to 45 wt. %, based on the total weight of the shell material. If the shell material contains 1,3-propanediol, the proportion of 1,3-propanediol is in particular 10 wt. % to 65 wt. %, particularly 20 wt. % to 45 wt. %, based on the total weight of the shell material.

The shell material preferably contains 20 to 45 wt. % of 1,3 propanediol and/or 1,2 propanediol and 10 to 65 wt. % of 2-amino-2-hydroxymethyl-1,3-propanediol, in each case based on the total weight of the shell material. The shell material or its melt also preferably contains 20 to 45 wt. % of 1,3 propanediol and/or 1,2 propanediol and 10 to 65 wt. % of 1,1,1 trimethylolpropane, in each case based on the total weight of the shell material. In particular, the shell material preferably contains 20 to 45 wt. % of 1,3 propanediol and/or 1,2 propanediol and 10 to 65 wt. % of glycerol, in each case based on the total weight of the shell material.

It has been found that, in these ranges, quick solidification of a shell material is possible at 20° C.; the shells obtained are stable in storage and transparent. In particular, the glycerol proportion has an impact on the curing time.

If the shell material according to the invention comprises a C₃ to C₆ alkanetriol and a C₃ to C₅ alkanediol, then the weight ratio thereof is preferably 3:1 to 2:1. In particular, the weight ratio thereof is 2:1 if glycerol and 1,3-propanediol are contained as polyhydric alcohols. Surprisingly, it has been found that, with these weight ratios, storage-stable, glossy, transparent shells can be obtained within short solidification times of 10 minutes or less at 20° C.

According to a further preferred embodiment, triethylene glycol can be contained in the shell material, in particular the shell material described above as preferred, in addition to the aforementioned alkanols, in particular if this shell material contains PVOH as the polymer. Triethylene glycol advantageously accelerates the solidification of the melt of the shell material. It is particularly preferred if the shell material contains, in addition to 1,3- and/or 1,2-propanediol and glycerol, between 0.1 and 20 wt. %, preferably between 1 and 15 wt. %, in particular between 5 and 12 wt. %, for example 8 to 11 wt. %, triethylene glycol, based on the weight of said shell material.

As a recipe for a shell material according to the invention, for example, the following compositions, designated as E1 to E7 in weight percent, are conceivable:

| | E1 | E2 | E3 | E4 | E5 |
|---|---|---|---|---|---|
| | [wt. %] | [wt. %] | [wt. %] | [wt. %] | [wt. %] |
| Polymer Acusol 588 G¹ | 8 | 8 | 8 | 8 | 8 |
| PEG 400 | 0 | 6 | 8 | 8 | 6 |
| Glycerol | 40 | 40 | 40 | 30 | 40 |
| 1,3-propanediol | 26 | 22 | 20 | 30 | 22 |
| Polyvinyl alcohol ² | 20 | 18 | 18 | 18 | 18 |
| Citric acid anhydrate | 6 | 6 | 6 | 6 | 6 |
| Total | 100 | 100 | 100 | 100 | 100 |

| | E6 | E7 |
|---|---|---|
| | [wt. %] | [wt. %] |
| DL-Alanine N,N-diacetic acid trisodium | 15.0 | 15.0 |
| salt (MGDA) (powder <100 μm) | | |
| Genapol EC 50 ⁴ | 7.0 | 7.0 |
| Polymer Acusol 588 G | 8.0 | 8.0 |
| (powder <100 μm) | | |
| Crystasense HP4 ⁵ | 13.0 | 13.0 |
| HEDP ⁶ (powder <100 μm) | 7.0 | 7.0 |
| PEG 300 | 15.0 | 15.0 |
| PEG 6000 | 22.0 | 22.0 |
| Citric acid anhydrate (powder <100 μm) | 4.0 | 3.8 |
| Dye (blue) | — | 0.2 |
| Total | 100 | 100 |

¹copolymer of acrylic acid having sulfonic acid group-containing monomer (DOW)
² partially hydrolyzed polyvinyl alcohol having a degree of polymerization (DP) of 900 and a degree of hydrolysis of 87.5 mol % (Kuraray)
3 obtainable as Trilon M ® (BASF SE)
⁴ non-ionic surfactant: waxy alkyl ether having ethylene oxide and propylene oxide units (Clariant)
⁵ polyamide polymer having an average molecular weight of 9500 g/mol (ex Croda)
⁶ etidronic acid-tetrasodium salt (Zschimmer & Schwarz)

In a further improvement of the invention, the shell material additionally contains at least one active ingredient. As a result, an appropriately produced shell can act as a washing or cleaning agent in addition to its function as a container.

The active ingredient is preferably selected from soil-release active ingredients, enzymes, builders, optical brighteners (preferably in portions for textile washing), pH adjusters, perfume, dyes, dye transfer inhibitors or mixtures thereof. Further preferred representatives of these active ingredients are the embodiments of these active ingredients explained in more detail below in connection with the filling substance (vide infra).

A bittern, such as denatonium benzoate, can preferably also be contained in the melt. It can thus be prevented that a shell produced by means of the device or a portion according to the invention containing this shell is swallowed, for example, by children or pets. It is therefore preferred according to the invention if at least one bittering agent is contained in the shell material according to the invention.

Preferred bittering agents have a bitter value of at least 1,000, preferably at least 10,000, particularly preferably at least 200,000. In order to determine the bitter value, the European Pharmacopoeia (5th Edition, Grundwerk, Stuttgart 2005, Volume 1, General Part, Monograph Groups, 2.8.15 bitter value p. 278) uses the standardized procedures described. An aqueous solution of quinine hydrochloride, of which the bitter value is fixed at 200,000, is used as a comparison. This means that 1 gram of quinine hydrochloride makes 200 liters of water bitter. The inter-individual taste differences in the organoleptic bitterness test are compensated for by a correction factor in this method.

Very particularly preferred bittering agents are selected from denatonium benzoate, glycosides, isoprenoids, alkaloids, amino acids, and mixtures thereof, particularly preferably denatonium benzoate.

Glycosides are organic compounds of the general structure R—O—Z, in which an alcohol (R—OH) is linked to a sugar part (Z) by means of a glycosidic bond.

Suitable glycosides are, for example, flavonoids, such as quercetin or naringin, or iridoidglycosides, such as aucubin, and in particular secoiridoidglycosides, such as amarogentin, dihydrofoliamentin, gentiopicroside, gentiopikrin, swertiamarin, sweroside, gentioflavoside, centauroside, methiafolin, harpagoside and centapikrin, sailicin or condurangin.

Isoprenoids are compounds that are formally derived from isoprene. Examples are in particular terpenes and terpenoids.

Suitable isoprenoids comprise, for example, sequiterpene lactones, such as absinthin, artabsin, cnicin, lactucin, lactucopikrin or salonitenolide, monoterpene ketones (thujones), such as α-thujon or β-thujone, tetranortriterpenes (limonoids), such as deoxylimones, desoxylimonic acid, limonin, ichangin, iso-obacunonic acid, obacunone, obacunonic acid, nomilin or nomilic acid, and terpenes such as marrubin, premarrubin, carnosol, carnosolic acid or quassin.

Alkaloids refer to naturally occurring, chemically heterogeneous, mostly alkaline, nitrogen-containing organic compounds of secondary metabolism that act on the animal or human organism.

Suitable alkaloids are, for example, quinine hydrochloride, quinine hydrogen sulfate, quinine dihydrochloride, quinine sulfate, columbine and caffeine.

Suitable amino acids comprise, for example, threonine, methionine, phenylalanine, tryptophan, arginine, histidine, valine and aspartic acid.

Particularly preferred bitterns are quinine sulfate (bitter value=10,000), naringin (bitter value=10,000), sucrose octaacetate (bitter value=100,000), quinine hydrochloride, denatonium benzoate (bitter value>100,000,000) and mixtures thereof, very particularly preferably denatonium benzoate (for example available as Bitrex).

The shell material preferably contains bittering agents in a total amount of at most 1 part by weight bittern to 250 parts by weight shell material (1:250), particularly preferably at most 1:500, very particularly preferably at most 1:1,000, based on the total weight of said shell material.

The shell material is particularly preferably elastic under normal conditions. The elasticity of the shell material is determined within the meaning of the invention by creating a force/displacement graph. The melt of the shell material is poured into a shaped body measuring 47×19×8 mm and stored at room temperature for 12 h before the measurement. The sample was taken in modified plastic inserts having external dimensions of 25×20×20 mm and having a recess of 10×10×20 mm for the mass to be measured. The measurement instrument used is a Lloyd LRX+(Lloyd Instruments) having a 5 kN measuring head, with a feed rate of 50 mm/min and a measurement pickup at 1 N preload (zero point) having been set. As a result, the force necessary to compress the shaped body by 8 mm is given in N. Due to the elasticity of the shell material, the initial dimensions of the shaped body are reset within a period of 15 minutes after the measurement has ended. The values measured in this way (for a compression by 8 mm) are preferably between 10 N and 40 N, preferably between 15 N and 30 N.

A shell produced accordingly has advantageous mechanical properties and can in particular be transported, stored and handled undamaged. In addition, when material is filled into the interior of a shell, it can thus yield and adapt to its shape, for example in the case of a material configured as a solid body.

Granules or particles or solids are more preferably contained in the melt.

The male mold is preferably polished, for example polished to a high gloss.

The male mold can, for example, be implemented by means of a mechanism having a degree of freedom, such as by means of a roller rotatable about a horizontal axis having one or more revolving rows of radially outwardly pointing male molds, or by means of a vertically movable lifting platform having male molds pointing downward, i.e. in the direction of gravity. Mechanics having a plurality of degrees of freedom can also be provided such that the male mold is not only submerged into the melt and lifted out of it, but is then transported further as desired, for example by means of a vertical movement for submerging and removing the male mold and by means of a further horizontal movement for further transporting it, for example in order for the male mold to be detached or filled or hardened.

One of the advantages of this device is that it has a simplified structure compared to known solutions, with main bodies in the form of male molds that can be easily technically produced and replaced. For example, the male molds do not have to have evacuation channels, as are provided in thermoforming, since the shell material is formed by hydrostatic pressure within the melt instead of an artificially generated air pressure difference.

The male mold can preferably also have temperature regulators which can preferably be arranged at least partly in the interior of the male mold in order to heat or cool the male mold.

Such a temperature regulator can be designed, for example, as a heating coil or as a Peltier element or as a liquid cooling system. In this way, the formation of the shell can be controlled, for example accelerated or slowed down in time, or the geometric thickness of the shell can be influenced; shells can also be easily detached from the male mold by heating the male mold and/or faulty shells can be destroyed and/or their material detached from the male mold.

It is also conceivable that the male mold sits on a cooling block through which cooling brine flows. The solidification of the shell material can thereby be influenced, for example accelerated.

In a preferred further development of the invention, the basin has a shape which substantially corresponds to an inversion of the shape of the male mold. As a result, only small amounts of melt have to be provided and heated above its melting temperature in order to submerge the male mold into the melt, which reduces the technical cost and energy expenditure during production of the shell and operation of the device. In addition, the geometry of the shell can be influenced in this way. For example, a constant or even variable distance from the male mold to the basin can be from up to 1 cm, 1 mm, 100 μm or 10 μm.

A shell in direct contact with the surface of the male mold is also referred to as a primary shell layer in the context of this invention. A primary shell layer can serve as such as a shell for a washing or cleaning agent portion according to the invention. However, further shell material in the form of a further melt can preferably be applied to the primary shell layer located on the male mold and converted into a further shell layer in contact with the primary shell layer before the shell is removed from the male mold. It is therefore particularly preferable for at least one further basin having at least one further melt of a further shell material to be provided for the device according to the invention, wherein the male mold having the shell already abutting it can be automatically submerged into the further melt and removed from the further melt in order to form a further water-soluble shell abutting the shell which abuts the male mold.

In this way, at least two, or even more than two, shell layers or shell segments abutting one another in an onion skin-like manner can be implemented. These can, for example, increase the mechanical strength of the composite shell. In the case of two shells abutting one another, the inner shell in each case preferably has a lower melting point or a lower melting temperature than the outer one.

It is particularly preferred that the multiple melts contain different active ingredients and/or different granules.

Thus, for example, different cleaning cycles that are specifically staggered in time can be defined. For example, an outer shell can contain no active ingredient, a first inner shell can contain a pre-cleaning active ingredient such as a pre-washer or a pre-washing detergent and a second inner shell can contain a dish-washing agent or detergent and abrasive or even active cleaning granules. Any other combination can also be implemented.

It is also preferred if the plurality of melts have different optical properties, in particular in the solidified state under normal conditions. These optical properties can relate, for example, to the color, shine, mattness, transparency, translucency or to the refractive index.

In this way, information, for example about the intended purpose or the contents of the shell, or also a visually appealing appearance can be conveyed to a user of the shell to be produced.

An additional improvement of the invention is achieved in that one end of the male mold has a portion comprising a filling substance.

This filling substance arranged at the end of the male mold, which, like the rest of the male mold, defines the shape of the shell and thus acts as a male mold, preferably has a melting temperature under normal conditions which is above the temperature of the melt. As a result, this filling substance does not melt when it is submerged into the melt. Thus, when the shell is detached, a filling substance arranged in the shell and connected thereto can directly be detached from the rest of the male mold, for example broken off or pushed off or split off or separated. The filling substance preferably has an active ingredient.

In a special development of the invention, the male mold is designed in such a way that a rigid shell abutting it cannot be stripped off.

This makes it possible to prevent the shell from being inadvertently detached from the male mold, for example as a result of gravity. Only, for example, by deforming a deformable or elastic shell or, for example, by destroying a rigid shell, i.e. by applying force in addition to gravity, can a corresponding shell be detached from a male mold of this kind.

The male mold is preferably wider in a distal region than in a proximal region, the distal region facing toward one end of the male mold and the proximal region facing toward an opposite end, a shell abutting the male mold being closed in the distal region and open in the proximal part. The transition from the distal to the proximal part can preferably be continuous, i.e. without jumps or steps. For example, a male mold oriented in the direction of gravity can taper upwards so that it is, for example, at least partly conical.

The male mold can likewise preferably have a lateral unevenness and can preferably have a protruding projection or an inward indentation.

Such an unevenness creates an undercut that can fix the shell on the male mold. By applying additional force, by means of which the shell is, for example, elastically or inelastically deformed or destroyed in places, the shell can nevertheless be released. In the absence of additional exertion of force, the undercut prevents unintentional detachment or stripping off or falling off of the shell, for example when it expands to a small extent relative to the unevenness or when the male mold contracts to such a small extent, or in particular when there are vibrations.

The male mold can also advantageously be set in vibration. Such a vibration can be triggered by mechanical actuators or piezo elements and, depending on the intended function, have frequencies in the range of more than 0.1 Hz, 1 Hz, 10 Hz, 100 Hz, 1 kHz or 10 kHz. During immersion, for example, this can be used to level the melt pool by means of preferably lower frequencies, for example below 10 Hz. Likewise, preferably higher frequencies, for example above 1 Hz, can facilitate the detachment of the shell.

Likewise, at least one air duct which can be connected to a compressed air source is preferably provided in the interior of the male mold and opens onto the surface of the male mold. By applying compressed air to the at least one air duct, the shell can thus be detached by blowing it off.

In a method according to the present invention, a device as described above is provided for producing a water-soluble shell for receiving a filling substance, the male mold is lowered into the melt at a temperature below a melting temperature of the melt such that a contact surface of the male mold is covered with shell material, a shell is formed by solidifying a layer of the shell material on the male mold, and the male mold is lifted together with a shell adhering thereto from the melt before, after or during solidification, and the shell is detached from the male mold. The shell can then, for example, be placed on a conveyor belt in order to be further processed.

For example, the melt can be heated from 80° C. to 150° C., for example up to 120° C. Likewise, for example, the male mold can be cooled from −20° C. to 0° C., for example −10° C.

The male mold is particularly preferably lowered into the melt to a depth which is greater than a maximum width of the male mold.

In this way, an elongate shell can be provided, which in classic thermoforming would lead to considerable mechanical stresses and potential damage during or after production.

The shell is particularly preferably detached by rolling it out or turning it inside out.

This means that the shell is not released, or is not released only by stripping off or pulling off or sliding off the male mold, but at least partly by turning an inside of the shell abutting the male mold, preferably at an open end of the shell, inside out. As a result, sticky shells which are difficult to take off can be detached, and shells can also be removed from male molds which have an unevenness, for example projections or indentations or undercuts or other geometries deviating from parallel lateral walls.

Alternatively, the shell is released by blowing it off. For this purpose, at least one air duct which can be connected to a compressed air source and opens onto the surface of the male mold can be provided in the interior of the male mold. By applying compressed air to the at least one air duct, the shell is released by the shell being blown off the male mold. If there is more than one air duct, the air pressure can be output in a specific, non-simultaneous sequence at different points on the surface of the male mold by means of a corresponding fluidic circuit, for example by means of valves actuated in a time-offset manner. In this way, for example, in the case of a male mold having a proximal region which the shell laterally circumferentially abuts, and a distal region which the shell abuts at the end, compressed air can first be conducted into the proximal region and only then into the distal region, as a result of which an abutting shell is first lifted in the laterally circumferential region and then pushed off the end. This avoids excessive mechanical loading, in particular longitudinal tensile stress, on the shell.

In a very preferred embodiment of the invention, one end of the male mold has a portion comprising a filling substance and the portion is detached when the shell is released such that the shell is detached having the filling substance arranged therein.

This has several advantages. For example, only one work step is necessary in order to provide a shell filled with filling substance. In addition, the direct contact of the liquid and hardening shell material with the filling substance in the end of the male mold allows a particularly stable connection between the shell and the filling substance arranged therein. In particular, but not only, if the filling substance is in the form of a solid, in particular a porous solid, the melt can therefore connect particularly well with the solid, for example by the laminar or gel or liquid or low-viscous melt in microscopic bulges of a porous filling substance flowing, diffusing or seeping.

A further preferred embodiment of the invention is one in which the shell is detached under the effect of sound waves, in particular ultrasonic waves.

Detaching the shell in this way can be carried out particularly gently, avoiding stressing the shell with, in particular, inhomogeneous mechanical loads. It is conceivable, for example, to detach the shell locally periodically from the male mold under the influence of a sound wave and thus for said shell to be slid down the male mold solely by means of the effect of directed force due to gravity, for example.

More preferably, the shell is hardened by drying said shell with hot air. Alternatively or additionally, a layer can preferably be vapor-deposited onto the shell.

As a result, regardless of the condition of the shell, a protective layer produced by means of hot-air drying or added by means of vapor deposition can be produced that is more resistant to environmental influences or mechanical influences than a main body of the shell lying under the protective layer.

The shell can also be stabilized by being cooled or hardened.

Such a shell is particularly preferably further processed into a portion for use as a washing or cleaning agent by filling the shell according to the invention with at least one filling substance and then closing the shell in an optional step which is preferred for particular applications.

This at least one filling substance necessarily comprises at least one granular mixture. In addition, at least one further filling substance different therefrom can be present in the portion, which substance can be liquid, solid or granular, for example. This is referred to below as a further phase.

Within the meaning of the present invention, a phase is a spatial region in which physical parameters and the chemical composition are homogeneous. One phase differs from another phase through its different features, such as ingredients, physical properties, external appearance, etc. Preferably, different phases can be differentiated visually from one another. For the consumer, the filling substance, comprising at least one granular mixture, must be distinguished from the further phase(s). If the portion according to the invention has more than one filling substance, then they can also each be distinguished from one another with the naked eye because of their different coloration, for example. The same applies if two or more further phases are present. In this case as well, a visual differentiation of the phases, for example on the basis of a difference in coloration or transparency, is possible. Within the meaning of the present invention, phases are thus self-contained regions that can be differentiated visually from one another by a consumer with the naked eye. The individual phases can have different properties when used, such as the speed at which the phase dissolves in water and hence the speed and the sequence of the release of the ingredients contained in the particular phase.

A granular mixture is formed from a large number of loose, solid particles, which in turn comprise what are known as grains. A grain is a name for the particulate constituents of powders (grains are the loose, solid particles), dusts (grains are the loose, solid particles), granular material (loose, solid particles are agglomerates of several grains), and other granular mixtures. According to the invention, the granular mixtures therefore comprise powder, dust and/or granules. Said solid particles of the granular mixture in turn preferably have a particle diameter X_{50.3} (volume average) of from 10 to 1,500 μm, more preferably from 200 μm to 1,200 μm, particularly preferably from 600 μm to 1,100 μm. Said particle sizes can be determined by sieving or by means of a Camsizer particle size analyzer from the company Retsch.

In a particular embodiment, it is preferred that the filling substance consists of at least one granular mixture, preferably at least one free-flowing granular mixture. This granular mixture can contain a plurality of different granules, particles and/or powders, preferably a granular mixture of a plurality of different washing and/or cleaning agent active substances.

The granular mixture is preferably free-flowing. The free-flowing ability of a granular mixture relates to its ability to flow freely under its own weight. The free-flowing ability is determined by measuring the outflow time of 1,000 ml of the granular mixture out of a standardized flow-test funnel, which is initially closed in its outlet direction and has an outlet of 16.5 mm in diameter, by measuring the time for the complete outflow of the granular mixture, in particular the powder phase, preferably of the powder and/or granules, e.g. of the powder after opening the outlet, and comparing it with the flow-out speed (in seconds) of a standard test sand of which the flow-out speed is defined as 100%. The defined sand mixture for calibrating the flow apparatus is dry sea sand. In this case, sea sand having a particle diameter of from 0.4 to 0.8 mm is used, as is available for example from Carl Roth, Germany, CAS no. [14808-60-7]. For drying, the sea sand is dried before the measurement for 24 hours at 60° C. in a drying cabinet on a plate at a maximum layer height of 2 cm.

Granular mixtures of a solid composition, in particular powders having a free-flowing ability in %, compared with the above-mentioned standard test substance, of greater than 40%, preferably greater than 50, in particular greater than 55%, particular preferably greater than 60%, in particular preferably between 63% and 80%, for example between 65% and 75%, are particularly suitable. Granular mixtures of a solid composition, in particular powders and/or granules having a free-flowing ability in %, compared with the above-mentioned standard test substance, of greater than 40%, preferably greater than 45%, in particular greater than 50%, particularly preferably greater than 55%, in particular preferably greater than 60%, are particularly suitable, the free-flowing ability being measured 24 hours following the production of the powder and storage at 20° C. Lower values for the free-flowing ability are rather unsuitable since, from a procedural point of view, precise dosing of the granular mixture into the shell in order to produce the portion is necessary. In particular, the values greater than 50%, in particular greater than 55%, preferably greater than 60% (where the measurement of the free-flowing ability is carried out 24 hours following the production of the powder and storage at 20° C.) have proved to be advantageous, since the good dosing ability of the granular mixture leads to only minor fluctuations in the dosed amount or composition. The more accurate dosing leads to consistent product performance, and economic losses due to overdosing are thus avoided. It is further advantageous for the granular mixture, in particular the powder, to be well dosed so that a faster sequence of the dosing process can be achieved. Furthermore, a good free-flowing ability prevents the granular mixture, in particular the powder, from getting onto the outer part of the shell.

Preferred embodiments of the filling substance according to the invention, comprising at least one granular mixture, have an angle of repose/angle of slope of from 26 to 35, preferably from 27 to 34, particularly preferably from 28 to 33, the repose angle being determined according to the method mentioned below after 24 hours following the production of the granular mixture of the solid composition and storage at 20° C. Such angles of repose have the advantage that the cavities are filled with the filling substance comprising at least one granular mixture comparatively quickly and precisely.

To determine the angle of repose (also referred to as the angle of slope) of the filling substance comprising at least one granular mixture, a powder funnel having a capacity of 400 ml and an outlet having a diameter of 25 mm is simply suspended in a tripod. The funnel is moved upwards by means of a manually operated knurling wheel at a speed of 80 mm/min such that the granular mixture flows out. As a result, what is known as a conical heap is formed. The conical heap height and the conical heap diameter are determined for the filling substance comprising at least one granular mixture. The angle of slope is calculated from the quotient of the conical heap height and the conical heap diameter*100.

The opening of the shell defined by the male mold can be closed by sealing said opening with a water-soluble film.

For example, the film can be glued, welded—for example by heat and/or ultrasound—or attached by means of form fit. The use of solvents for attaching, i.e. sealing, is also conceivable.

It is particularly preferred for the shell to be closed by wrapping it in a shrink film made of water-soluble film. This not only seals the entire shell, even spatially away from at least one opening that necessarily remains after being detached from the male mold, sealed by the film, i.e. protected against external influences, but the mechanical stability is also increased.

The water-soluble film preferably contains at least one water-soluble polymer, particularly preferably selected from polymers or polymer mixtures.

It is preferable that the water-soluble film contains polyvinyl alcohol or a copolymer of polyvinyl alcohol.

A bittering agent is preferably incorporated into said water-soluble film to increase product safety. Corresponding embodiments of the water-soluble films having a bittering agent are described in publications EP-B1-2 885 220 and EP-B1-2 885 221. The bittering agents preferably used in the shell material are also preferably suitable for use in the water-soluble film. A particularly preferred bittering agent for the water-soluble film is denatonium benzoate.

Suitable water-soluble films are sold by MonoSol LLC under the name Monosol M8630 or M8720. Other suitable films include films having the designation Solublon® PT, Solublon® KA, Solublon® KC, or Solublon® KL from Aicello Chemical Europe GmbH, or the VF-HP films from Kuraray, or HiSelon SH2312 or S-2100 from Nippon Gohesi.

Such a film, like all other components of each shell or portion described here, can also contain a bittering agent such as denatonium benzoate.

Alternatively or additionally, the shell can be closed by applying a melt, in particular the melt by means of which the shell material was originally provided. When such a melt is applied, an already solidified part of the shell may liquefy again, especially in an edge region of an opening in the shell such that a connection is created there, preferably in the form of a seamless substance bond.

For example, after the shell has been detached and filled—for example by detachment or only afterwards—it can be turned over and immersed with an open end facing down, i.e. in the direction of gravity, into the melt originally used for the shell. Alternatively, the melt can be applied to the opening from above or poured into it. However, another melt can also be provided for sealing.

Closing or sealing by means of form fit, by mechanical connection of a lid, for example made of shell material, to the opening of the shell, for example to a screw cap or a latching mechanism or an undercut, is also conceivable.

According to a particularly preferred embodiment, the shell (2) or the opening located in the shell, in particular the one which was necessary for filling the filling substance(s), is closed by applying a lid made of shell material (5). The lid can be produced beforehand from the shell material, subsequently applied and adhesively connected to the shell. However, it can also be generated in situ at the same time or after the shell has been produced. It is preferred that, in a further production step, shell material or its melt is applied to the opening in the shell in such a way that the opening is closed with it.

According to a different preferred embodiment, the shell (2) is at least partly, preferably completely, closed by applying the shell material and/or a preferably viscoelastic and solid covering substance (14) different from the shell material used for the shell. This at least partial closure of the opening can take place, for example, through the shell material already described or its melt. The viscoelastic and solid covering substance (14) can preferably match the further viscoelastic and solid phase, defined in more detail below, preferably with the preferred properties detailed there.

### BRIEF DESCRIPTION OF THE DRAWINGS

In the drawings:

FIG. 1 is a schematic view of an embodiment of a device according to the invention,

FIG. 2 is a schematic view of a further embodiment of a device according to the invention,

FIG. 3 is a schematic view of a further embodiment of a device according to the invention,

FIG. 4 is a schematic view of an embodiment of a male mold according to the invention,

FIGS. 5a-5c are schematic views of embodiments of shells and male molds according to the invention,

FIG. 6 shows a schematic view of an embodiment of a portion for use as a washing or cleaning agent according to the invention, and

FIG. 7 is a schematic view of an embodiment of a method according to the invention.

### DETAILED DESCRIPTION OF THE INVENTION

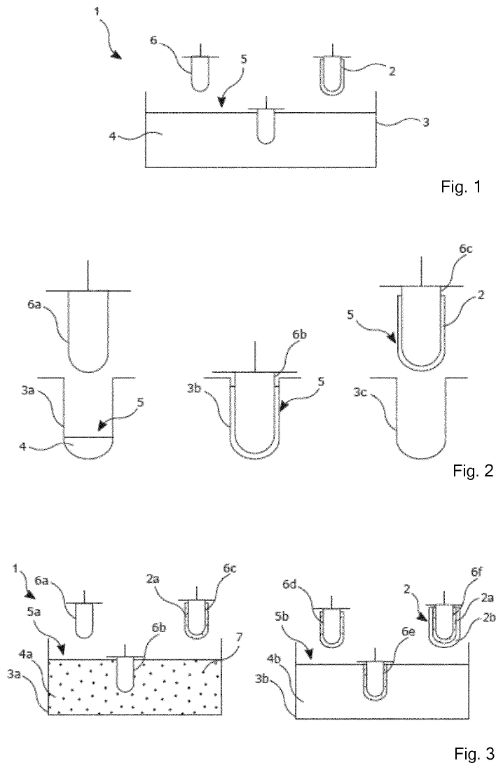

FIG. 1 shows a device 1 for producing a water-soluble shell 2 for receiving a filling substance (not shown in greater detail here). A melt 4 of a polymer-containing shell material 5 is filled into a basin 3. This shell material 5 is elastic, solid and water-soluble under normal conditions, i.e. in order to be present as a melt 4, said shell material is kept in the basin 3 at a temperature above its melting temperature. The shell material 5 also contains a cleaning active ingredient and denatonium benzoate.

In the region of the basin, a male mold 6a is movably arranged in an initial state, specifically vertically movable by means of an actuator (not shown in greater detail here), the male mold 6a being automatically submerged into the melt 4 and removed from the melt 4.

In a subsequent step, a male mold 6b is submerged into the melt 4, i.e. arranged in such a way that at least part of the male mold 6b is located below the surface of the melt. The male mold 6a is immersed in the melt 4 over a length which is greater than the maximum width of the male mold 6b. Due to, inter alia, the temperature difference between the melt 4 and the male mold 6b and the stickiness and viscosity of the melt 4, and its specific heat capacity, a layer of shell material 5 is formed in this state, which layer abuts the male mold 6b and adjoins it.

A male mold 6c is removed from the basin 3 and the melt 4 in a further subsequent step. A solid, gel, water-soluble shell 2 has formed therefrom by cooling the shell material 5 abutting the male mold 6c. The shell 2 does not have to be gel.

The male mold 6a; 6b; 6c has a temperature regulator (not shown in greater detail) on the inside in order to accelerate the cooling and solidification of the shell 2 and to influence or specify the thickness of the shell 2.

In FIG. 2, a device 1 is shown in which a basin 3a; 3b; 3c substantially has an inverted shape of a male mold 6a; 6b; 6c. In this example, this means that the male mold 6a; 6b; 6c is shaped as an elongate dome and the basin 3a; 3b; 3c is shaped as an elongate trough. As a result, the male mold 6a; 6b; 6c has, in this example, a constant small distance from the basin 3a; 3b; 3c when it is lowered along the submerged part of the surface thereof.

In a first state, a basin 3 is only partly filled with a melt 4 of a shell material 5. In a second state, the male mold 6b is lowered into the basin 3b, as a result of which the melt 4 is displaced such that its level rises and the male mold 6b is effectively submerged into the melt 4. In a third state, the male mold 6c is lifted out of the basin 3c, a shell 2 made of the shell material 5 adhering to the male mold 6c. The basin 3c is now empty, but a residual amount of melt 4 or shell material 5 can also remain there.

In FIG. 3, a device 1 is shown having two spatially separated basins 3a, 3b, a first basin 3a being filled with a melt 4a having granules 7 contained therein, which granules contain an active ingredient, and a second basin 3b being filled with a melt 4b which does not contain granules. The male molds 6a-6f are in different states which are provided for producing the shell 2.

In the region of the basin 3a, a male mold 6a is arranged above it in an initial state, it being possible for the male mold 6a to be automatically submerged into the melt 4a and removed from the melt 4a.

In a subsequent step, a male mold 6b is submerged into the melt 4a having the granules 7 contained therein. Due to, inter alia, the temperature difference between the melt 4a and male mold 6b and the stickiness, viscosity and specific heat capacity of the melt 4a and the amount, density and specific heat capacity of the granules 7, a layer of shell material 5a is formed in this state, which layer abuts the male mold 6b and adjoins it, in any case molds onto it.

A male mold 6c is removed from the basin 3a and the melt 4a in a further subsequent step. By cooling the shell material 5a abutting the male mold 6c, a solid, water-soluble shell 2a containing granules 7 has formed therefrom.

Then, as shown on male molds 6d and 6e, a male mold 6d having a first shell 2a adjoining it is submerged into the second melt 4b of a second shell material 5b without granules such that a second shell 2b is formed that encloses the first shell 2a. In the final state, the male mold 6f is lifted out of the second melt 4b and the abutting shell 2a, 2b are cooled such that they solidify and form a shell 2 composed of two layers.

The first shell 2a is opaque, while the second shell 2b is at least partly transparent such that the first shell 2a and the granules 7 contained therein are visible from the outside.

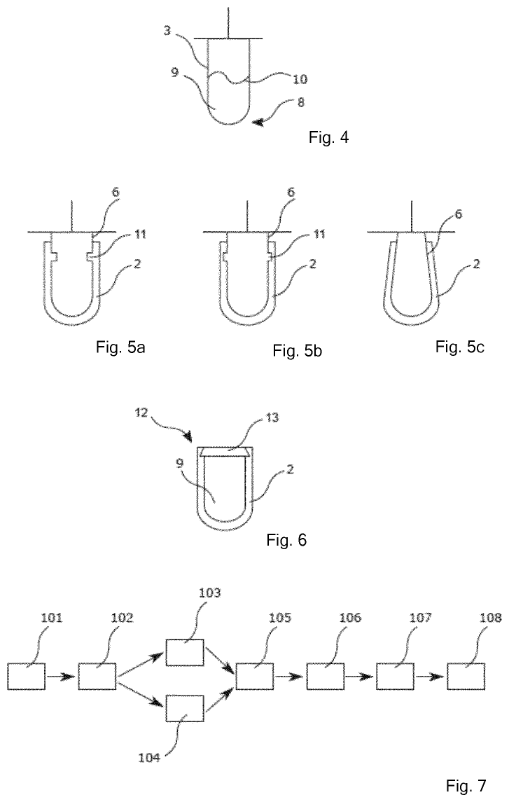

According to FIG. 4, one end 8 of the male mold 3 has a portion comprising filling substance 9. The separating surface 10 between the portion comprising the filling substance 9 and the rest of the male mold 6 is undulating, but can also be flat or have any shape. If such a male mold 6 is submerged in a melt 4 made of shell material 5 and removed therefrom such that subsequently the shell material 5 solidifies to form a shell 2 abutting the portion comprising filling substance 9, it is possible to separate this portion having the shell 2 abutting it from the remaining male mold 6, for example to break it off or remove it. In this way, a water-soluble shell 2 filled with a filling substance 9 is obtained in one work step.

FIGS. 5a, 5b and 5c show male molds 6 which are designed such that the rigid shells 2 abutting them cannot be stripped off.

FIG. 5a shows a male mold 6 which has an unevenness 11 in the shape of an indentation deviating from a cylindrical shape. FIG. 5b shows a male mold 6 which has an unevenness 11 in the shape of a projection deviating from a cylindrical shape. Each unevenness forms an undercut with regard to the shell 2 to be detached such that this shell cannot be stripped off and cannot slip off. Only when the shell 2 (not shown here in further detail) is turned inside out, pulled apart, radially expanded or destroyed in the region below the unevenness, can the shell be released from the male mold.

FIG. 5c shows a male mold 6 which is wider in a distal region than in a proximal region, the male mold 6 being partially conical. The conical shape forms an obstacle with regard to the shell 2 to be detached such that this shell cannot be stripped off and cannot slip off. Only when the shell 2 (not shown in greater detail here) is turned inside out, pulled apart, expanded radially or destroyed in places, can the shell be detached from the male mold.

FIG. 6 shows a portion for use as a washing or cleaning agent 12, having a shell 2, a filling substance 9 arranged therein and a lid 13 which is form-fittingly inserted into the shell 2. The lid consists of the shell material 5 of the shell 2 so it is in particular solid and water-soluble.

FIG. 7 shows the steps of a method for producing a water-soluble shell 2 for receiving a filling substance 9 and for producing a corresponding portion for use as a washing or cleaning agent.

First of all, in a first step 101, a device as described above for producing a water-soluble shell 2 is provided, comprising a basin 3 filled with a melt 5 of a shell material 4 and a male mold 6. Then, in a step 102, the male mold 6 is lowered into the melt 4 at a temperature below a melting temperature of the melt 4 such that a contact surface of the male mold 6 is covered with the shell material 5. This makes it possible for a shell 2 to be formed in a step 103 by solidifying the shell material 5 on the male mold 6. Before, after or during the solidification in accordance with step 103, the male mold 6 is lifted out of the melt in a step 104 such that a shell 2 is provided on the male mold 6, which shell is released from the male mold 6 in a step 105. In a step 106, the shell 2 is hardened further by drying it with hot air and, in a step 107, a protective layer (not shown in greater detail here) is vapor-deposited onto the shell 2. The shell 2 is therefore provided.

In a step 108, the shell 2 is filled with at least one filling substance 9. Subsequently, the shell 2 can optionally be closed in a step 109 by means of sealing with a water-soluble film, as a result of which a portion is provided for use as a washing or cleaning agent 12.

A further subject matter of the invention is a portion (12) for use as a washing or cleaning agent, in particular as a textile washing agent or automatic dishwashing detergent, containing
(a) a shell (2) made of a melt (4) of a polymer-containing and water-soluble shell material (5) which is solid under normal conditions, and
(b) a filling substance (9) located in said shell (2) and comprising at least one granular mixture which preferably contains at least one washing and/or cleaning agent active substance, and
(c) optionally a further phase, preferably a viscoelastic and solid phase.

The filling substance (9) preferably comprises at least one free-flowing granular mixture. It is preferred that the filling substance comprising a free-flowing, granular mixture is also present in the finished portion (12) in a free-flowing manner.

At least one washing and/or cleaning agent active substance is preferably contained in the at least one granular mixture. This at least one washing and/or cleaning agent active substance is preferably selected from the group of builders, enzymes, copolymers comprising at least one sulfonic acid group-containing monomer, alkalizing agents, optical brighteners, color transfer inhibitors, soil-release polymers, bleaching agents, bleach activators, bleach catalysts, silver protecting agents and/or glass corrosion inhibitors.

It is particularly preferred if a cleaning agent, preferably a dishwashing detergent, in particular an automatic dishwashing detergent, contains two, three or more of the washing and/or cleaning agent active substance in the at least one granular mixture. In particular, these are preferably selected from the group of builders, enzymes, copolymers comprising at least one sulfonic acid group-containing monomer, bleaching agents, bleach activators, bleach catalysts, silver protecting agent and/or glass corrosion inhibitors.

It is particularly preferred if a washing agent, in particular a textile washing agent, contains two, three or more of the washing and/or cleaning agent active substance in the at least one granular mixture. These washing and/or cleaning agent active substances are preferably selected from the group of enzymes, alkalizing agents (preferably carbonate and/or hydrogen carbonate), optical brighteners, color transfer inhibitors and soil-release polymers (preferably CMC, anionic polyesters made of phthalic acid and/or sulfoisophthalic acid).

A preferred cleaning agent, in particular an automatic dishwashing detergent, preferably also comprises a bleaching agent, in particular an oxygen bleaching agent, and, optionally, a bleach activator and/or bleach catalyst. If present, these are preferably predominantly, in particular exclusively, contained in the filling substance comprising at least one granular mixture.

As a preferred bleaching agent, washing and/or cleaning agents according to the invention contain an oxygen bleaching agent from the group of sodium percarbonate, sodium perborate tetrahydrate, and sodium perborate monohydrate. Further examples of bleaching agents which may be used are peroxypyrophosphates, citrate perhydrates as well as H₂O₂-yielding peracid salts or peracids, such as perbenzoates, peroxophthalates, diperazelaic acid, phthaloiminoperacid or diperdodecane diacid. Moreover, bleaching agents from the group of the organic bleaching agents can also be used. Typical organic bleaching agents are the diacyl peroxides, such as dibenzoyl peroxide. Other typical organic bleaching agents are the peroxy acids, with the alkylperoxy acids and the arylperoxy acids meriting special mention as examples. Due to its good bleaching performance, sodium percarbonate is particularly preferred. One particularly preferred oxygen bleaching agent is sodium percarbonate.

Compounds which, under perhydrolysis conditions, result in aliphatic peroxocarboxylic acids having preferably 1 to 10 C atoms, in particular 2 to 4 C atoms, and/or optionally substituted perbenzoic acid, may be used as bleach activators. Substances that carry the O- and/or N-acyl groups of the stated number of C atoms and/or optionally substituted benzoyl groups are suitable. Multiply acylated alkylene diamines are preferred, with tetraacetylethyl ethylenediamine (TAED) having proven to be particularly suitable.

The bleach catalysts, which are particularly preferably used in the dishwashing detergents, are bleach-boosting transition metal salts or transition metal complexes such as, for example, Mn-, Fe-, Co-, Ru-, or Mo-salene complexes or -carbonyl complexes. Mn-, Fe-, Co-, Ru-, Mo-, Ti-, V-, and Cu-complexes with N-containing tripod ligands as well as Co-, Fe- Cu-, and Ru-ammine complexes can also be used as bleach catalysts. Complexes of manganese in oxidation stage II, III, IV, or IV are particularly preferably used which preferably contain one or more macrocyclic ligands with the donor functions N, NR, PR, O and/or S. Preferably, ligands are used which have nitrogen donor functions. It is particularly preferred to use bleach catalyst(s) in the agents according to the invention which contains or contain, as macromolecular ligands, 1,4,7-trimethyl-1,4,7-triazacyclononane (Me-TACN), 1,4,7-triazacyclononane (TACN), 1,5,9-trimethyl-1,5,9-triazacyclododecane (Me-TACD), 2-methyl-1-1,4,7-trimethyl-1,4,7-triazacyclononane (Me/Me-TACN), and/or 2-methyl-1,4,7-triazacyclononane (Me/TACN). Suitable manganese complexes are, for example, [Mn^{III}₂ (μ-O)₁(μ-OAc)₂(TACN)₂](CIO₄)₂, [Mn^{III}Mn^{IV}(μ-O)₂(μ-OAc)₁(TACN)₂](BPH₄)₂, [Mn^{IV}₄(μ-O)₆(TACN₄)](CIO₄)₄, [Mn^{III}₂(μ-O)₁(μ-OAc)₂(Me-TACN)₂]CIO₄)₂, [Mn^{III}Mn^{Iv}(μ-O)₁(μ-OAc)₂(Me-TACN)₂](CIO₄)₃, [Mn^{IV}₂ (μ-O)₃(Me-TACN)₂](PF₆)₂ and [Mn^{IV}₂ (μt-O)₃(Me/Me-TACN)₂](PF₆)₂ (where OAc ═OC(O)CH₃).

According to a further particularly preferred embodiment, the portion (12) according to the invention contains the filling substance which comprises at least one granular mixture, in an amount of from 1 to 40 g, preferably in an amount of from 5 to 35 g, in particular in an amount of from 7 to 30 g, particularly preferably in an amount of from 10 to 25 g, in particular preferably in an amount of from 12 to 20 g.

A particularly preferred embodiment of the present invention is a portion which, in addition to the filling substance comprising at least one granular mixture, contains a further phase, preferably a viscoelastic and solid phase. This further phase is preferably to be regarded as a further filling substance (9) within the meaning of the present invention. Such a further phase advantageously offers the possibility of separating mutually incompatible active substances, in particular if it preferably contains at least one washing and/or cleaning agent active substance.

According to a preferred embodiment, the portion (12) contains a total amount of all filling substances of from 1 to 50 g, preferably in an amount of from 3 to 40 g, in particular in an amount of from 5 to 35 g, particularly preferably in an amount of from 7 to 30 g, in particular preferably in an amount of from 10 to 25 g.

This further phase of the portion (12) can be arranged in the shell (2) below, above and/or next to the filling substance comprising at least one granular mixture. In particular, it is preferred that the further phase is arranged in the shell (2) next to and/or on the filling substance comprising at least one granular mixture. Advantageously, in particular in the case of a different color and/or optical design, and/or in particular in the case of a transparent viscoelastic and solid phase, an appearance that is appealing to the consumer can also be achieved.

It is preferred if the further phase, preferably the viscoelastic and solid filling substance, at least partially covers the filling substance comprising at least one granular mixture in the shell (2). Particularly preferably, the viscoelastic, solid phase covers the surface of the filling substance in the shell (2) comprising at least one granular mixture, preferably a free-flowing granular mixture, up to at least 10%, up to at least 20%, up to at least 30% to at least 40%, up to at least 50%, preferably up to at least 60%, in particular up to at least 70%, very particularly preferably up to at least 80%, in particular preferably up to at least 90%, in particular up to at least 95%, most preferably up to 100%, based on the total surface of the filling substance comprising at least one granular mixture in the shell (2).

A high degree of coverage of the filling substance filled into the shell of the portion, for example 100%, by at least one further phase, in particular by the viscoelastic, solid filling substance, has the advantage that the granular mixture can be poured in easily and precisely in the first production step; the further phase(s) applied in a second or third production step, in particular the viscoelastic, solid filling substance, solidifies on the first introduced filling substance comprising at least one granular mixture, and thus the granular mixture falling out or the granular mixture being displaced within the portion can be avoided. The granular mixture can thus be fixed in a desired position in the portion by covering it by means of the further phase(s), in particular the solid, viscoelastic filling sub stance.

According to a preferred embodiment, it is possible that the at least one opening in the shell (2) of the portion is covered at least partially, preferably by the further phase, in particular by the viscoelastic and solid filling substance. The at least one opening of the shell is covered by the further phase, in particular by the viscoelastic, solid filling substance, is particularly preferred up to at least 10%, up to at least 20%, up to at least 30% to at least 40%, up to at least 50%, preferably up to at least 60%, in particular up to at least 70%, very particularly preferably up to at least 80%, in particular preferably up to at least 90%, in particular up to at least 95%, most preferably up to 100%, based on the total area of the at least one opening.

It is particularly preferred if the further phase, in particular the viscoelastic and solid phase, completely covers and/or closes at least one opening in the shell. Then the further phase, in particular the viscoelastic and solid phase, corresponds to the aforementioned viscoelastic and solid covering substance (14) or, after it has solidified, a closure and/or lid (13) of the shell. This has the advantage that, in addition to separating mutually incompatible active substances, as described above, the granular mixture is covered and/or the opening of the portion is closed without an additional method step such that the at least one granular mixture, in particular the free-flowing granular mixture, is fixed in the portion and preferably cannot flow out of the portion after production, for example during transport.

According to a preferred embodiment of the present invention, the portion (12) is characterized in that the further phase, preferably viscoelastic and solid phase, contains at least one polymer which is selected from (optionally acetalized) polyvinyl alcohol (PVOH), copolymers of polyvinyl alcohol, polyvinylpyrrolidone, polyethylene oxide, gelatin, cellulose and derivatives thereof, acrylic acid-containing polymers, polyacrylamides, oxazoline polymers, polystyrene sulfonates, polyurethanes, polyesters, polyethers and mixtures thereof, preferably from (optionally acetalized) polyvinyl alcohol (PVOH), copolymers of polyvinyl alcohol, polyethylene oxide, gelatin and mixtures thereof.

According to another preferred embodiment of the present invention, the portion (12) is characterized in that it comprises, in said shell as a further phase, preferably as a viscoelastic and solid phase, based on the total weight of said further phase,
(i) a total amount of from 0.1 to 70 wt. % of at least one surfactant, and
(ii) a total amount of at least 0.5 wt. % of at least one organic gelator compound having a molar mass of <1000 g/mol, a solubility in water of less than 0.1 g/l (20° C.) and a structure containing at least one hydrocarbon structural unit having 6 to 20 carbon atoms (preferably at least one carbocyclic, aromatic structural unit) and additionally an organic structural unit covalently bonded to the aforementioned hydrocarbon unit which structural unit has at least two groups selected from —OH, —NH—, or mixtures thereof and
(iii) optionally water.

For this subject matter of the invention, it is preferred that the embodiments of the shell material described above as preferred are used for the shell of the portion (vide supra).

It is also preferred if the shell of the portion is produced according to the method described above (vide supra).

The further preferred embodiments relate, unless explicitly stated otherwise, to all viscoelastic, solid phases according to the invention, in particular the viscoelastic, solid phases containing a gelator compound and/or one of the above-mentioned polymers.

The viscoelastic, solid filling substance of the portion can be produced by first bringing a liquid composition containing, based on the total weight thereof, a total amount of at least 0.5 wt. % of at least one previously defined gelator compound, in the presence of a solvent (optionally containing water) and 0.1 to 70 wt.-% surfactant and optionally optional additives, to a temperature above the sol-gel transition temperature of the liquid composition, and then the heated liquid composition being placed in said shell and in said form under the sol-gel transition temperature being cooled to form a viscoelastic, solid shaped body.

It is also possible to first bring a first liquid composition containing at least one said gelator compound to a temperature above the sol-gel transition temperature of the first liquid composition and to mix this first liquid composition with a second liquid composition at a temperature below the sol-gel transition temperature of the first composition containing water and at least one surfactant to obtain a liquid composition containing at least 0.5 wt. % of at least one said gelator compound, 0.1 to 70 wt. % of at least one surfactant and optionally water and to add it to the shell to harden.

Each liquid composition is brought in the mold for harden the liquid composition below the sol-gel transition temperature of the liquid composition. In this case, it is preferable according to the invention for the liquid composition to be cooled to no less than 30° C., in particular to no less than 35° C., particularly preferably to no less than 45° C., in order to form the above-mentioned filling substance.

The stability of the portion and the dissolving or dispersing power of the portion is further improved, when the above-mentioned filling substance has a storage modulus between 10³ Pa and 10⁸ Pa, (preferably between 10⁴ Pa and 10⁸ Pa, particularly preferably in a range from 10⁵ Pa to 10⁷ Pa) and a loss modulus (in each case at 20° C., with a deformation of 0.1% and a frequency of 1 Hz), and the storage modulus in the frequency range between 10′ Hz and 10 Hz is at least twice as great as the loss modulus, preferably five times greater than the loss modulus, particularly preferably at least ten times greater than the loss modulus.

The viscoelastic, solid filling substance according to the invention is preferably transparent or translucent. If a filling substance according to the invention has a residual light output (transmission) of at least 20% in the spectral range between 380 nm and 780 nm, based on the reference measurement, it is considered transparent within the meaning of the invention.

The transparency of the viscoelastic, solid filling substance according to the invention can be determined using various methods. The Nephelometric Turbidity Unit (NTU) is frequently used as an indication of transparency. It is a unit, used e.g. in water treatment, for measuring turbidity e.g. in liquids. It is the unit of turbidity measured using a calibrated nephelometer. High NTU values are measured for clouded compositions, whereas low values are determined for clear, transparent compositions.

The HACH Turbidimeter 2100Q from Hach Company, Loveland, Colo. (USA) is used with the calibration substances StabICal Solution HACH (20 NTU), StabICal Solution HACH (100 NTU) and StabICal Solution HACH (800 NTU), all of which can also be produced by Hach Company. The measurement is filled with the composition to be analyzed in a 10 ml measuring cuvette having a cap and is carried out at 20° C.

At an NTU value (at 20° C.) of 60 or more, viscoelastic, solid filling substances have a perceptible turbidity within the meaning of the invention, as can be seen with the naked eye. It is therefore preferred if the viscoelastic, solid filling substance according to the invention has an NTU value (at 20° C.) of at most 120, more preferably at most 110, more preferably at most 100, particularly preferably at most 80.

In the context of the present invention, the transparency of the viscoelastic, solid filling substances according to the invention was determined by a transmission measurement in the visual light spectrum over a wavelength range of from 380 nm to 780 nm at 20° C. To do this, a reference sample (water, deionized) is first measured in a photometer (Specord S 600 from AnalytikJena) with a cuvette (layer thickness 10 mm) that is transparent in the spectrum to be examined. The cuvette is then filled with a sample of the filling substance according to the invention and measured again. The sample is filled in the liquid state and solidified in the cuvette and then measured.

It is preferred if the viscoelastic, solid filling substance according to the invention has a transmission (20° C.) of particularly preferably at least 25%, more preferably at least 30%, more preferably at least 40%, in particular at least 50%, very particularly preferably at least 60%.

It is very particularly preferred if the viscoelastic, solid filling substance according to the invention has a transmission (at 20° C.) of at least 30% (in particular of at least 40%, more preferably of at least 50%, particularly preferably of at least 60%) and an NTU value (at 20° C.) of at most 120 (more preferably at most 110, more preferably at most 100, particularly preferably at most 80).

The viscoelastic, solid filling substance according to the invention contains a total amount of from 0.1 to 70 wt. % surfactant, based on the total weight of said filling substance. Suitable surfactants according to the invention are preferably anionic surfactants, non-ionic surfactants, zwitterionic surfactants, amphoteric surfactants or cationic surfactants.

Preferred viscoelastic, solid filling substances contain, based on the total weight thereof, a total amount of 5 to 70 wt. %, more preferably from 5 to 65 wt. %, more preferably from 5 to 60 wt. %, more preferably from 10 to 70 wt. %, more preferably from 10 to 65 wt. %, more preferably from 10 to 60 wt. %, more preferably from 15 to 70 wt. %, more preferably from 15 to 65 wt. %, more preferably from 15 to 60 wt. %, particularly preferably from 20 to 70 wt. %, more preferably from 20 to 65 wt. %, more preferably from 20 to 60 wt. %, very particularly preferably from 25 to 70 wt. %, more preferably from 25 to 65 wt. %, more preferably from 25 to 60 wt. %, even more preferably from 30 to 70 wt. %, more preferably from 30 to 65 wt. %, more preferably from 30 to 60 wt. % of at least one surfactant. These surfactant compositions are in particular suitable for treating textiles, but in particular for use in a washing machine for washing textiles. It is in turn particularly preferable for the viscoelastic, solid filling substance to contain at least one anionic surfactant and optionally also at least one non-ionic surfactant.

Preferred embodiments of a viscoelastic, solid filling substance according to the invention for use as an automatic dishwashing detergent, in particular for use in an automatic dishwasher, contain, in each case based on the total weight of the total filling substance i.e. of all filling substances, 0.1 to 5.0 wt. %, in particular 0.2 to 4.0 wt. %, of at least one surfactant.

A filling substance preferred according to the invention, in particular the granular mixture and/or the viscoelastic, solid filling substance is characterized in that it contains at least one anionic surfactant. Filling substances according to the invention, in particular the granular mixture and/or the viscoelastic, solid filling substances having anionic surfactant are particularly suitable for washing textiles, particularly preferably for use in a washing machine for washing textiles. Preferred filling substances according to the invention, in particular the granular mixture and/or the viscoelastic, solid filling substances which are suitable as automatic dishwashing detergents (in particular for use in a dishwasher), contain, in each case based on the weight of the filling substances according to the invention, 0 to 1 wt. %, in particular 0 to 0.5 wt. %, particularly preferably 0 to 0.25 wt. %, of anionic surfactant.

If the viscoelastic, solid filling substance according to the invention contains anionic surfactant and is used as a textile washing agent, it is preferred that, based on the total weight of the composition, anionic surfactant is contained in a total amount of from 5 to 70 wt. %, more preferably 5 to 60 wt. %, more preferably 10 to 70 wt. %, in particular 10 to 60 wt. %, particularly preferably from 10 to 40 wt. %, even more preferably from 25 to 40 wt. %.

Regardless of the field of application of the filling substances according to the invention, in particular the at least one granular mixture and/or the viscoelastic, solid filling substances, sulfonates and/or sulfates can preferably be used as the anionic surfactant.

Surfactants of the sulfonate type that can be used are preferably C₉₋₁₃ alkylbenzene sulfonates, olefin sulfonates, i.e. mixtures of alkene and hydroxyalkane sulfonates, and disulfonates, as obtained, for example, from C₁₂₋₁₈ monoolefins having a terminal or internal double bond by way of sulfonation with gaseous sulfur trioxide and subsequent alkaline or acid hydrolysis of the sulfonation products. C₁₂₋₁₈ alkane sulfonates and the esters of α-sulfofatty acids (ester sulfonates) are also suitable, for example the α-sulfonated methyl esters of hydrogenated coconut, palm kernel or tallow fatty acids.

Particularly preferred viscoelastic, solid filling substances according to the invention, in particular textile washing agents, contain at least one compound of the formula (T-1) as the anionic surfactant,

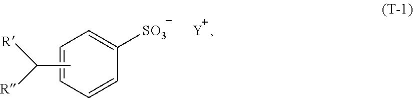

where
R′ and R″ are, independently of one another, H or alkyl, and together contain 9 to 19, preferably 9 to 15 and in particular 9 to 13, C atoms, and Y⁺ is a monovalent cation or the nth part of an n-valent cation (in particular Na⁺).

The alkali salts and in particular the sodium salts of the sulfuric acid half-esters of C₁₂-C₁₈ fatty alcohols, for example from coconut fatty alcohol, tallow fatty alcohol, lauryl alcohol, myristyl alcohol, cetyl alcohol or stearyl alcohol, or of C₁₀-C₂₀ oxo alcohols and the half-esters of secondary alcohols having these chain lengths are preferred as alk(en)yl sulfates. From a washing perspective, C₁₂-C₁₆ alkyl sulfates, C₁₂-C₁₅ alkyl sulfates and C₁₄-C₁₅ alkyl sulfates are preferred. 2,3-alkyl sulfates are also suitable anionic surfactants.

Fatty alcohol ether sulfates, such as the sulfuric acid monoesters of straight-chain or branched C₇₋₂₁ alcohols ethoxylated with 1 to 6 mol ethylene oxide, such as 2-methyl-branched C₉₋₁₁ alcohols having, on average, 3.5 mol ethylene oxide (EO) or C₁₂₋₁₈ fatty alcohols having 1 to 4 EO, are also suitable.

Other suitable anionic surfactants are soaps. Saturated and unsaturated fatty acid soaps are suitable, such as the salts of lauric acid, myristic acid, palmitic acid, stearic acid, (hydrogenated) erucic acid and behenic acid, and in particular soap mixtures derived from natural fatty acids, such as coconut, palm kernel, olive oil or tallow fatty acids.

The anionic surfactants, and the soaps, can be present in the form of sodium, potassium, magnesium or ammonium salts thereof. The anionic surfactants are preferably present in the form of the ammonium salts thereof. Preferred counterions for the anionic surfactants are the protonated forms of choline, triethylamine, monoethanolamine or methylethylamine.

In a very particularly preferred embodiment, the viscoelastic, solid filling substance according to the invention, in particular as a textile washing agent, contains an alkyl benzene sulfonic acid, in particular C₉₋₁₃ alkyl benzene sulfonic acid, neutralized with monoethanolamine, and/or fatty acid neutralized with monoethanolamine.

A preferred viscoelastic, solid filling substance according to the invention contains at least one anionic surfactant selected from the group consisting of C₈₋₁₈ alkylbenzene sulfonates, olefin sulfonates, C₁₂₋₁₈ alkane sulfonates, ester sulfonates, alkyl sulfates, alkenyl sulfates, fatty alcohol ether sulfates and mixtures thereof.

In the context of a preferred embodiment, the viscoelastic, solid filling substance according to the invention, in particular as a washing or cleaning agent, contains at least one non-ionic surfactant.

The at least one non-ionic surfactant can be any known non-ionic surfactant that is suitable for the purpose according to the invention.

In the context of a preferred embodiment, the viscoelastic, solid filling substance contains at least one non-ionic surfactant.

Preferred embodiments of a filling substance according to the invention, in particular the at least one granular mixture and/or the viscoelastic, solid filling substance as an automatic dishwashing detergent, in particular for use in a dishwasher, contain, in each case based on the weight of the composition, 0.1 to 5.0 wt. %, in particular 0.2 to 4.0 wt. %, of at least one non-ionic surfactant.

Preferred embodiments of a viscoelastic, solid filling substance according to the invention as a textiles washing agent, in particular for use in a washing machine, contain, in each case based on the weight of the composition, 1.0 to 25 wt. %, preferably 2.5 to 20.0 wt. %, more preferably 5.0 to 18.0 wt. %, of at least one non-ionic surfactant.

The at least one non-ionic surfactant can be any known non-ionic surfactant that is suitable for the purpose according to the invention.

In a preferred embodiment of the invention, the filling substances described herein, in particular the at least one granular mixture and/or the viscoelastic, solid filling substances as non-ionic surfactant contain at least one fatty alcohol alkoxylate with the following formula (T-2),

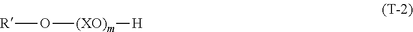

where R′ represents a linear or branched C₈-C₁₈-alkyl functional group, an aryl functional group or alkylaryl functional group, XO is, independently from one another, an ethylene oxide (EO) or propylene oxide (PO) group, and m is an integer from 1 to 50. In the above formula, R′ represents a linear or branched, substituted or unsubstituted alkyl functional group. In a preferred embodiment of the present invention, R¹ is a linear or branched alkyl functional group having 5 to 30 carbon atoms, preferably having 7 to 25 carbon atoms, and in particular having 10 to 19 carbon atoms. Preferred functional groups R′ are selected from decyl, undecyl, dodecyl, tridecyl, tetradecyl, pentadecyl, hexadecyl, heptadecyl, octadecyl, nonadecyl functional groups and mixtures thereof, the representatives having an even number of carbon atoms being preferred. Particularly preferred functional groups R′ are derived from fatty alcohols having 12 to 19 carbon atoms, for example from coconut fatty alcohol, tallow fatty alcohol, lauryl, myristyl, cetyl or stearyl alcohol, or from oxo alcohols having 10 to 19 carbon atoms.

XO in formula (T-2) is an ethylene oxide (E0) or propylene oxide (PO) group, preferably an ethylene oxide group.

The index m in formula (T-2) is an integer from 1 to 50, preferably from 2 to 20, and more preferably from 2 to 10. In particular, m is 3, 4, 5, 6 or 7. The solid, viscoelastic filling substance according to the invention may contain mixtures of non-ionic surfactants which have different degrees of ethoxylation.

In summary, particularly preferred fatty alcohol alkoxylates are those of formula (T-3)

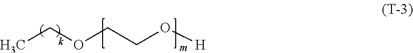

where k=9 to 17, and m=3, 4, 5, 6, or 7. Very particularly preferred representatives are fatty alcohols having 10 to 18 carbon atoms and 7 EO (k=11 to 17, m=7).

Fatty alcohol ethoxylates of this kind are available under the trade names Dehydol® LT7 (BASF), Lutensol® AO7 (BASF), Lutensol® M7 (BASF), and Neodol® 45-7 (Shell Chemicals).

Particularly preferably, the solid, viscoelastic filling substances according to the invention contain non-ionic surfactants from the group of alkoxylated alcohols. Non-ionic surfactants that are preferably used are alkoxylated, advantageously ethoxylated, in particular primary alcohols having preferably 8 to 18 C atoms and, on average, 1 to 12 mol ethylene oxide (EO) per mol of alcohol, in which the alcohol functional group can be linear or preferably methyl-branched in the 2 position, or can contain linear and methyl-branched functional groups in admixture, as are usually present in oxo alcohol functional groups. In particular, however, alcohol ethoxylates having linear functional groups of alcohols of native origin with 12 to 18 C atoms, for example from coconut, palm, tallow fat, or oleyl alcohol, and 2 to 8 EO per mol of alcohol on average are preferred. Preferred ethoxylated alcohols include, for example C₁₂₋₁₄ alcohols having 3 EO or 4 EO, C₈₋₁₁ alcohol having 7 EO, C₁₃₋₁₅ alcohols having 3 EO, 5 EO, 7 EO or 8 EO, C₁₂₋₁₈ alcohols having 3 EO, 5 EO or 7 EO and mixtures thereof, such as mixtures of C₁₂₋₁₄ alcohol having 3 EO and C₁₂₋₁₈ alcohol having 5 EO.

Preferred alcohol ethoxylates have a narrowed homolog distribution (narrow range ethoxylates, NRE). In addition to these non-ionic surfactants, fatty alcohols having more than 12 EO can also be used, in particular as cleaning agents for automatic dishwashing. Examples of these are tallow fatty alcohols having 14 EO, 25 EO, 30 EO, or 40 EO.

Ethoxylated non-ionic surfactants are particularly preferably used which were obtained from C₆₋₂₀ monohydroxy alkanols or C₆₋₂₀ alkyl phenols or C₁₆₋₂₀ fatty alcohols and more than 12 mol, preferably more than 15 mol, and in particular more than 20 mol, ethylene oxide per mol of alcohol. A particularly preferred non-ionic surfactant is obtained from a straight-chain fatty alcohol having 16 to 20 carbon atoms (C₁₆-20 alcohol), preferably from a C₁₈ alcohol and at least 12 mol, preferably at least 15 mol and in particular at least 20 mol, ethylene oxide. Of these, what are referred to as “narrow range ethoxylates” are particularly preferred.

Surfactants that are preferably used come from the group of the alkoxylated non-ionic surfactants, in particular the ethoxylated primary alcohols and mixtures of these surfactants with structurally complex surfactants such as polyoxypropylene/polyoxyethylene/polyoxypropylene ((PO/EO/PO) surfactants). Such (PO/EO/PO) non-ionic surfactants are also characterized by good foam control.

In the context of the present invention, low-foaming non-ionic surfactants which have alternating ethylene oxide and alkylene oxide units have been found to be particularly preferred non-ionic surfactants, in particular for cleaning agents for automatic dishwashing. Among these, in turn, surfactants having EO-AO-EO-AO blocks are preferred, with one to ten EO groups or AO groups being bonded to one another before a block of the other group follows. Here, non-ionic surfactants of general formula (T-4) are preferred

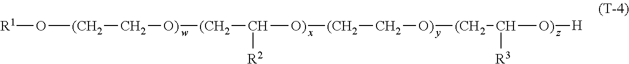

in which R¹ represents a straight-chain or branched, saturated or mono- or polyunsaturated C₆₋₂₄ alkyl or alkenyl functional group; each R² and R³ group is selected, independently of one another, from —CH₃, —CH₂CH₃, —CH₂CH₂—CH₃, —CH(CH₃)₂; and the indices w, x, y and z represent, independently of one another, integers from 1 to 6.

Preferred non-ionic surfactants of the above formula can be produced, using known methods, from the corresponding alcohols R¹—OH and ethylene or alkylene oxide. The R¹ functional group in the above formula can vary depending on the origin of the alcohol. If native sources are used, the R′ functional group has an even number of carbon atoms and is generally unbranched, with the linear functional groups of alcohols of native origin having 12 to 18 C atoms, such as coconut, palm, tallow fatty or oleyl alcohol, for example, being preferred. Some examples of alcohols that are available from synthetic sources are the Guerbet alcohols or functional groups that are methyl-branched in the 2 position, or mixtures of functional groups that are linear and methyl-branched, such as those usually present in oxa-alcohol functional groups. Irrespective of the approach taken in the production of the alcohol used in the non-ionic surfactants contained in the filling substances, in particular the at least one granular mixture and/or the viscoelastic, solid filling substance, non-ionic surfactants are preferred in which R¹ represents an alkyl functional group having 6 to 24, preferably 8 to 20, particularly preferably 9 to 15, and in particular 9 to 11, carbon atoms in the above formula.

Besides propylene oxide, butylene oxide in particular is worthy of consideration as an alkylene oxide unit that is contained alternately with the ethylene oxide unit in the preferred non-ionic surfactants. However, other alkylene oxides, in which R² and R³ are selected, independently of one another, from —CH₂CH₂—CH₃ and —CH(CH₃)₂, are also suitable. Preferably, non-ionic surfactants of the above formula are used in which R² and R³ represent a —CH₃ functional group; w and x represent, independently of one another, values of 3 or 4; and y and z represent, independently of one another, values of 1 or 2.

Further preferably used non-ionic surfactants, in particular for filling substances for use as cleaning agents for automatic dishwashing, are non-ionic surfactants of general formula (T-5)

R¹O (AlkO)ₓM(OAlk)_{y}OR² (T-5)

where R¹ and R² represent, independently of one another, a branched or unbranched, saturated or unsaturated, optionally hydroxylated, alkyl functional group having 4 to 22 carbon atoms; alk represents a branched or unbranched alkyl functional group having 2 to 4 carbon atoms; x and y represent, independently of one another, values of between 1 and 70; and M represents an alkyl functional group from the group CH₂, CHR³, CR³R⁴, CH₂CHR³ and CHR³CHR⁴, where R³ and R⁴ represent, independently of one another, a branched or unbranched, saturated or unsaturated alkyl functional group having 1 to 18 carbon atoms.

Preferred in this case are non-ionic surfactants of general formula (T-6)

R¹—CH(OH)CH₂—O(CH₂CH₂O)ₓCH₂CHR(OCH₂CH₂)_{y}—CH₂CH(OH)—R² (T-6),

where R, R¹ and R² represent, independently of one another, an alkyl functional group or alkenyl functional group having 6 to 22 carbon atoms; x and y represent, independently of one another, values of between 1 and 40.

Preferred in this case are, in particular, compounds of general formula (T-7)

R¹—CH(OH)CH₂—O(CH₂CH₂O)ₓCH₂CHR(OCH₂CH₂)_{y}O—CH₂CH(OH)—R² (T-7)

in which R represents a linear, saturated alkyl functional group having 8 to 16 carbon atoms, preferably 10 to 14 carbon atoms, and R¹ and R² represent, independently of one another, an alkyl functional group or alkenyl functional group having 6 to 22 carbon atoms, and n and m represent, independently of one another, values of from 20 to 30. Such compounds can be obtained, for example, by reacting alkyl diols HO—CHR—CH₂—OH with ethylene oxide, with a reaction with an alkyl epoxide being performed subsequently in order to close the free OH functions whilst forming a dihydroxy ether.

Preferred non-ionic surfactants are in this case, in particular for viscoelastic, solid filling substances for use as cleaning agents for automatic dishwashing, those of general formula (T-8)

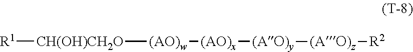

where
R¹ represents a straight-chain or branched, saturated or mono- or polyunsaturated C₆₋₂₄ alkyl or alkenyl functional group;
R² represents hydrogen or a linear or branched hydrocarbon functional group having 2 to 26 carbon atoms;
A, A′, A″ and A′″ represent, independently of one another, a functional group from the group —CH₂CH₂, —CH₂CH₂—CH₂, —CH₂—CH(CH₃), —CH₂—CH₂—CH₂—CH₂, —CH₂—CH(CH₃)—CH₂—, —CH₂—CH(CH₂—CH₃);
w, x, y and z represent values of between 0.5 and 120, where x, y and/or z can also be 0.

By adding the above-mentioned non-ionic surfactants of general formula (T-8)

R¹—CH(OH)CH₂O-(AO)_{w}-(A′O)ₓ-(A″O)_{y}-(A′″O)_{z}—R² (T-8)

hereinafter also referred to as “hydroxy mixed ethers,” the cleaning performance of preparations according to the invention can surprisingly be significantly improved, specifically in comparison with systems that contain alternative non-ionic surfactants, such as those from the group of polyalkoxylated fatty alcohols.

By using these non-ionic surfactants having one or more free hydroxyl groups on one or both terminal alkyl functional groups, the stability of the enzymes that may be additionally contained in the viscoelastic, solid filling substances according to the invention can be significantly improved.

In particular, those end-capped poly(oxyalkylated) non-ionic surfactants are preferred, in particular for cleaning agents for automatic dishwashing, which, according to the following formula (T-10)

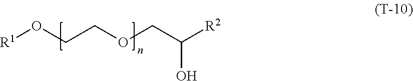

besides a functional group R¹, which represents linear or branched, saturated or unsaturated, aliphatic or aromatic hydrocarbon functional groups having 2 to 30 carbon atoms, preferably having 4 to 22 carbon atoms, also have a linear or branched, saturated or unsaturated, aliphatic or aromatic hydrocarbon functional group R² having 1 to 30 carbon atoms, where n represents values of between 1 and 90, preferably values of between 10 and 80, and in particular values of between 20 and 60. Surfactants of the above formula are in particular preferred in which R¹ represents C₇ to C₁₃, n represents a whole natural number from 16 to 28 and R² represents C₆ to C₁₂.

In particular for filling substances, preferably viscoelastic, solid filling substances for use as cleaning agents for automatic dishwashing, surfactants of the formula R¹O [CH₂CH(CH₃)O]ₓ[CH₂CH₂O]_{y} CH₂CH(OH)R² are particularly preferred, in which R¹ represents a linear or branched aliphatic hydrocarbon functional group having 4 to 18 carbon atoms or mixtures thereof, R² represents a linear or branched hydrocarbon functional group having 2 to 26 carbon atoms or mixtures thereof, and x represents values between 0.5 and 1.5, and y represents a value of at least 15. The group of these non-ionic surfactants includes, for example, C₂₋₂₆ fatty alcohol (PO)₁-(EO)₁₅₋₄₀-2-hydroxyalkyl ethers, in particular including C₈₋₁₀ fatty alcohol (PO)₁-(EO)₂₂-2-hydroxydecyl ethers.

In particular for filling substances, preferably viscoelastic, solid filling substances for use as cleaning agents for automatic dishwashing, those end-capped poly(oxyalkylated) non-ionic surfactants of the formula R¹O [CH₂CH₂O]ₓ[CH₂CH(R³)O]_{y} CH₂CH(OH)R² are particularly preferred, in which R¹ and R², independently of one another, represent a linear or branched, saturated or mono- or polyunsaturated hydrocarbon functional group having 2 to 26 carbon atoms, R³, independently of one another, is selected from —CH₃, —CH₂CH₃,—CH₂CH₂—CH₃—CH(CH₃)₂, but preferably represents —CH₃, and x and y, independently of one another, represent values between 1 and 32, with non-ionic surfactants in which R³═—CH₃ and values for x of from 15 to 32 and for y of from 0.5 and 1.5 being very particularly preferred.

Further non-ionic surfactants that can preferably be used, in particular for filling substance, particularly viscoelastic, solid filling substances for use as cleaning agents for automatic dishwashing, are the end-capped poly(oxyalkylated) non-ionic surfactants of the formula R¹O[CH₂CH(R³)O]ₓ[CH₂]ₖCH(OH)[CH₂]ⱼOR²,

in which R¹ and R² represent linear or branched, saturated or unsaturated, aliphatic or aromatic hydrocarbon functional groups having 1 to 30 carbon atoms, R³ represents H or a methyl, ethyl, n-propyl, iso-propyl, n-butyl, 2-butyl or 2-methyl-2-butyl functional group, x represents values between 1 and 30, and k and j represent values between 1 and 12, preferably between 1 and 5. If the value is x>2, each R³ in the above formula R¹O[CH₂CH(R³)O]ₓ[CH₂]ₖCH(OH)[CH₂]ⱼOR² can be different. le and R² are preferably linear or branched, saturated or unsaturated, aliphatic or aromatic hydrocarbon functional groups having 6 to 22 carbon atoms, with functional groups having 8 to 18 C atoms being particularly preferred. For the functional group R³, H, —CH₃ or —CH₂CH₃ are particularly preferred. Particularly preferred values for x are in the range of from 1 to 20, in particular from 6 to 15.

As described above, each R³ in the above formula can be different if x>2. In this way, the alkylene oxide unit in square brackets can be varied. For example, if x represents 3, the functional group R³ can be selected in order to form ethylene oxide (R³═H) or propylene oxide (R³═CH₃) units, which can be joined together in any sequence, for example (EO)(PO)(EO), (EO)(EO)(PO), (EO)(EO)(EO), (PO)(EO)(PO), (PO)(PO)(EO) and (PO)(PO)(PO). The value 3 for x has been selected here for the sake of example and can by all means be greater, in which case the range of variation increases as the values for x increase and includes a large number of (EO) groups combined with a small number of (PO) groups, for example, or vice versa.

Particularly preferred end-capped poly(oxyalkylated) alcohols of the above formula have values of k=1 and j=1, and therefore the previous formula is simplified to R¹O[CH₂CH(R³)O]ₓCH₂CH(OH)CH₂OR². In the formula mentioned last, R¹, R² and R³ are as defined above and x represents numbers from 1 to 30, preferably from 1 to 20, and in particular from 6 to 18. Surfactants in which the functional groups R¹ and R² have 9 to 14 C atoms, R³ represents H, and x assumes values from 6 to 15 are particularly preferred. Finally, the non-ionic surfactants of general formula R¹—CH(OH)CH₂O-(AO)_{w}—R² have been found to be particularly effective, in which
R¹ represents a straight-chain or branched, saturated or mono- or polyunsaturated C₆₋₂₄ alkyl or alkenyl functional group;
R² represents a linear or branched hydrocarbon functional group having 2 to 26 carbon atoms;
A represents a functional group from the group CH₂CH₂, CH₂CH₂CH₂, CH₂CH(CH₃), preferably CH₂CH₂, and
w represents values between 1 and 120, preferably 10 to 80, particularly 20 to 40.

The group of these non-ionic surfactants includes, for example, C₄₋₂₂ fatty alcohol-(EO)₁₀₋₈₀-2-hydroxyalkyl ethers, in particular also C₈₋₁₂ fatty alcohol-(EO)₂₂-2-hydroxydecyl ethers and C₄₋₂₂ fatty alcohol-(EO)₄₀₋₈₀-2-hydroxyalkyl ethers.

Furthermore, the viscoelastic, solid filling substance according to the invention may contain, as a non-ionic surfactant, amine oxide. In principle, all the amine oxides found in the prior art for this purpose, i.e. compounds that have the formula R¹R²R³NO, in which each of R¹, R² and R³, independently of the other, is an optionally substituted hydrocarbon chain having 1 to 30 carbon atoms, can be used as the amine oxide. Amine oxides that are particularly preferably used are those in which R¹ is an alkyl having 12 to 18 carbon atoms and R² and R³ are, independently of one another, an alkyl having 1 to 4 carbon atoms, in particular alkyl dimethyl amine oxides having 12 to 18 carbon atoms. Examples of representatives of suitable amine oxides are N-cocoalkyl-N,N-dimethyl amine oxide, N-tallow-alkyl-N,N-dihydroxyethyl amine oxide, myristyl-/cetyl dimethyl amine oxide or lauryl dimethyl amine oxide.

Suitable non-ionic surfactants include alkyl glycosides of the general formula RO(G)ₓ, for example, in which R corresponds to a primary straight-chain or methyl-branched aliphatic functional group, in particular an aliphatic functional group that is methyl-branched in the 2 position, having 8 to 22, preferably 12 to 18, C atoms, and G is the symbol that represents a glycose unit having 5 or 6 C atoms, preferably glucose. The degree of oligomerization x, which indicates the distribution of monoglycosides and oligoglycosides, is any number between 1 and 10; x is preferably between 1.2 and 1.4.

Another class of preferably used non-ionic surfactants, which are used either as the sole non-ionic surfactant or in combination with other non-ionic surfactants, are alkoxylated, preferably ethoxylated or ethoxylated and propoxylated fatty acid alkyl esters, preferably having 1 to 4 carbon atoms in the alkyl chain.

Other suitable surfactants are the polyhydroxy fatty acid amides that are known as PHFAs.

Other non-ionic surfactants that can be used may be, for example,
polyol fatty acid esters,
alkoxylated triglycerides,
alkoxylated fatty acid alkyl esters of the formula R³CO—(OCH₂CHR⁴)_{w}OR⁵, in which R³CO represents a linear or branched, saturated and/or unsaturated acyl functional group having 6 to 22 carbon atoms, R⁴ represents hydrogen or methyl, and R⁵ represents linear or branched alkyl functional groups having 1 to 4 carbon atoms, and w is 1 to 20,
hydroxy mixed ethers,
sorbitan fatty acid esters and addition products of ethylene oxide to sorbitan fatty acid esters such as the polysorbates,
sugar fatty acid esters and addition products of ethylene oxide to sugar fatty acid esters,
addition products of ethylene oxide to fatty acid alkanolamides and fatty amines,
fatty acid-N-alkyl glucamides.

The viscoelastic, solid filling substances according to the invention described herein may also contain several of the non-ionic surfactants described above.

According to the invention, particularly preferred viscoelastic, solid filling substances, in particular as textile washing agents, each contain, based on the total weight, a total amount of
from 10 to 60 wt. %, in particular 25 to 40 wt. %, of at least one anionic surfactant and
from 2 to 35 wt. %, in particular 18 to 28 wt. %, of at least one non-ionic surfactant.

Very particularly preferred viscoelastic, solid filling substances according to the invention for use as textiles washing agents contain, according to the invention, at least one surfactant combination as described below for the compositions (A) to (D):
(A) Viscoelastic, solid filling substance that contains, as a surfactant, in each case based on the total weight of the composition, at least a total amount of
   from 10 to 60 wt. % of at least one anionic surfactant, at least one C₉-13 alkyl benzene sulfonate being contained as an anionic surfactant, and
   from 2 to 35 wt. % of at least one non-ionic surfactant, at least one alkoxylated alcohol having 8 to 18 carbon atoms and on average 4 to 12 mol ethylene oxide (EO) per mol of alcohol being contained as a non-ionic surfactant.
(B) Viscoelastic, solid filling substance that contains, as a surfactant, in each case based on the total weight of the composition, at least a total amount of
   from 10 to 60 wt. % of at least one anionic surfactant, at least 5 to 60 wt. % of at least one C₉₋₁₃ alkyl benzene sulfonate being contained as an anionic surfactant, and
   from 2 to 35 wt. % of at least one non-ionic surfactant, at least 2 to 35 wt. % of at least one alkoxylated alcohol having 8 to 18 carbon atoms and on average 4 to 12 mol ethylene oxide (EO) per mol of alcohol being contained as a non-ionic surfactant.
(C) Viscoelastic, solid filling substance that contains, as a surfactant, in each case based on the total weight of the composition, at least a total amount of
   from 25 to 40 wt. % of at least one anionic surfactant, at least one C₉₋₁₃ alkyl benzene sulfonate being contained as an anionic surfactant, and
   from 18 to 28 wt. % of at least one non-ionic surfactant, at least one alkoxylated alcohol having 8 to 18 carbon atoms and on average 4 to 12 mol ethylene oxide (EO) per mol of alcohol being contained as a non-ionic surfactant.
(D) Viscoelastic, solid filling substance that contains, as a surfactant, in each case based on the total weight of the composition, at least a total amount of
   from 25 to 40 wt. % of at least one anionic surfactant, at least 25 to 40 wt. % of at least one C₉₋₁₃ alkyl benzene sulfonate being contained as an anionic surfactant, and
   from 18 to 28 wt. % of at least one non-ionic surfactant, at least 18 to 28 wt. % of at least one alkoxylated alcohol having 8 to 18 carbon atoms and on average 4 to 12 mol ethylene oxide (EO) per mol of alcohol being contained as a non-ionic surfactant.

When providing all of the aforementioned filling substances, preferably solid, viscoelastic filling substances, with a specific amount of selected surfactant, the amounts of the individual surfactant components are of course to be selected within the stated quantity ranges of the individual surfactant components so that the specified total amount of surfactant is adhered to.

Preferred viscoelastic and solid filling substances are characterized in that, based on the total weight thereof, the organic gelator compound is contained in said filling substance in a total amount of from 0.5 to 10.0 wt. %, in particular from 0.8 to 5.0 wt. %, more preferably between 1.0 wt. % and 4.5 wt. %, very particularly preferably between 1.0 wt. % and 4.0 wt. %.

In preferred viscoelastic and solid filling substances, the organic gelator compound is selected from benzylidene alditol compound, diketopiperazine compound, dibenzylcystine compound, hydrogenated castor oil, hydroxystearic acid, N—(C₈-C₂₄)-hydrocarbyl glyconamide, or mixtures thereof. A selection from at least one benzylidene alditol compound is particularly preferred.

Very particularly preferred viscoelastic and solid filling substances are characterized in that said filling substance contains at least one benzylidene alditol compound of formula (I) as the organic gelator compound

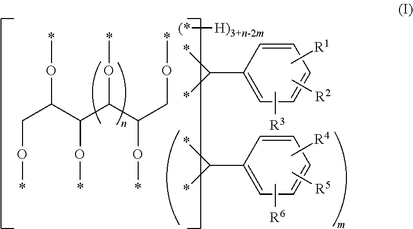

where
*—represents a covalent single bond between an oxygen atom of the alditol backbone and the provided functional group,
   n represents 0 or 1, preferably 1,
   m represents 0 or 1, preferably 1,
   R¹, R² and R³ represent, independently of one another, a hydrogen atom, a halogen atom, a C₁-C₄ alkyl group, a cyano group, a nitro group, an amino group, a carboxyl group, a hydroxy group, a —C(═O)—NH—NH₂ group, a —NH—C(═O)—(C₂-C₄-alkyl) group, a C₁-C₄ alkoxy group, a C₁-C₄ alkoxy C₂-C₄ alkyl group, with two of the functional groups forming, together with the remainder of the molecule, a 5-membered or 6-membered ring,
   R⁴, R⁵ and R⁶ represent, independently of one another, a hydrogen atom, a halogen atom, a C₁-C₄ alkyl group, a cyano group, a nitro group, an amino group, a carboxyl group, a hydroxy group, a
   —C(═O)—NH—NH₂ group, a —NH—C(═O)—(C₂-C₄-alkyl) group, a C₁-C₄ alkoxy group, a C₁-C₄ alkoxy C₂-C₄ alkyl group, with two of the functional groups forming, together with the remainder of the molecule, a 5-membered or 6-membered ring.

Due to the stereochemistry of the alditols, it should be mentioned that said benzylidene alditols according to the invention are suitable in the L configuration or in the D configuration or in a mixture of the two. Due to natural availability, the benzylidene alditol compounds are preferably used according to the invention in the D configuration. It has been found to be preferable for the alditol backbone of the benzylidene alditol compound according to formula (I) contained in said filling substance to be derived from D-glucitol, D-mannitol, D-arabinitol, D-ribitol, D-xylitol, L-glucitol, L-mannitol, L-arabinitol, L-ribitol, or L-xylitol.

Particularly preferred are said filling substances which are characterized in that R¹, R², R³, R⁴, R⁵ and R⁶ according to the benzylidene alditol compound of formula (I) are, independently of one another, a hydrogen atom, methyl, ethyl, chlorine, fluorine, or methoxy, preferably a hydrogen atom.

n according to the benzylidene alditol compound of formula (I) preferably represents 1.

m according to the benzylidene alditol compound of formula (I) preferably represents 1.

More than very particularly preferably, the viscoelastic and solid filling substance according to the invention contains, as a benzylidene alditol compound of formula (I), at least one compound of formula (I-1)

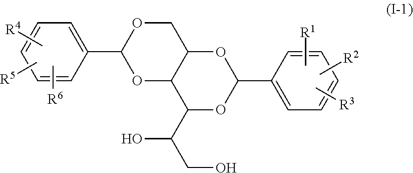

where R¹, R², R³, R⁴, R⁵ and R⁶ are as defined in formula (I). Most preferably, according to formula (I-1), R′, R², R³, R⁴, R⁵ and R⁶ represent, independently of one another, a hydrogen atom, methyl, ethyl, chlorine, fluorine, or methoxy, preferably a hydrogen atom.

Most preferably, the benzylidene alditol compound of formula (I) is selected from 1,3:2,4-di-O-benzylidene-D-sorbitol; 1,3:2,4-di-O-(p-methylbenzylidene)-D-sorbitol; 1,3:2,4-di-O-(p-chlorobenzylidene)-D-sorbitol; 1,3:2,4-di-O-(2,4-dimethylbenzylidene)-D-sorbitol; 1,3:2,4-di-O-(p-ethylbenzylidene)-D-sorbitol; 1,3:2,4-Di-O-(3,4-dimethylbenzylidene)-D-sorbitol or mixtures thereof.

Preferred viscoelastic, solid filling substances contain at least one 2,5-diketopiperazine compound of formula (I) as the organic gelator compound

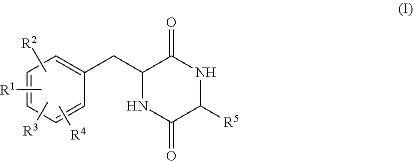

where
R¹, R², R³ and R⁴ represent, independently of one another, a hydrogen atom, a hydroxy group, a (C₁-C₆)-alkyl group, a (C₂-C₆)-alkenyl group, a (C₂-C₆))-acyl group, a (C₂-C₆)-acyloxy group, a (C₁-C₆)-alkoxy group, an amino group, a (C₂-C₆)-acylamino group, a (C₁-C₆)-alkylaminocarbonyl group, an aryl group, an aroyl group, an aroyloxy group, an aryloxy group, an aryl-(C₁-C₄)-alkyloxy group, an aryl-(C₁-C₃)-alkyl group, a heteroaryl group, a heteroaryl-(C₁-C₃)-alkyl group, a (C₁-C₄)-hydroxyalkyl group, a (C₁-C₄)-aminoalkyl group, a carboxy-(C₁-C₃)-alkyl group, where at least two of the functional groups R¹ to R⁴ can form, together with the remainder of the molecule, a 5-membered or 6-membered ring,
R⁵ represents a hydrogen atom, a linear (C₁ to C₆)-alkyl group, a branched (C₃ to C₁₀)-alkyl group, a (C₃ to C₆)-cycloalkyl group, a (C₂-C₆)-alkenyl group, a (C₂-C₆)-alkynyl group, a (C₁-C₄)-hydroxyalkyl group, a (C₁-C₄)-alkoxy-(C₁-C₄)-alkyl group, a (C₁-C₄)-acyloxy-(C₁-C₄)-alkyl group, an aryloxy-(C₁-C₄)-alkyl group, an O-(aryl-(C₁-C₄)-alkyl)oxy-(C₁-C₄)-alkyl group, a (C₁-C₄)-alkylsulfanyl-(C₁-C₄)-alkyl group, an aryl group, an aryl-(C₁-C₃)-alkyl group, a heteroaryl group, a heteroaryl-(C₁-C₃)-alkyl group, a (C₁-C₄)-hydroxyalkyl group, a (C₁-C₄)-aminoalkyl group, an N—(C₁-C₄)-alkylamino-(C₁-C₄)-alkyl group, an N,N—(C₁-C₄)-dialkylamino-(C₁-C₄)-alkyl group, an N—(C₂-C₈)-acylamino-(C₁-C₄)-alkyl group, an N—(C₂-C₈)-acyl-N—(C₁-C₄)-alkylamino-(C₁-C₄)-alkyl group, an N—(C₂-C₈)-arroyl-N—(C₁-C₄)-alkylamino-(C₁-C₄)-alkyl group, an N,N—(C₂-C₈)-diacylamino-(C₁-C₄)-alkyl group, an N-(aryl-(C₁-C₄)-alkyl)amino-(C₁-C₄)-alkyl group, an N,N-di(aryl-(C₁-C₄)-alkyl)amino-(C₁-C₄)-alkyl group, a (C₁-C₄)-carboxyalkyl group, a (C₁-C₄)-alkoxycarbonyl-(C₁-C₃)-alkyl group, a (C₁-C₄)-acyloxy-(C₁-C₃)-alkyl group, a guanidino-(C₁-C₃)-alkyl group, an aminocarbonyl(C₁-C₄)-alkyl group, an N—(C₁-C₄)-alkylaminocarbonyl-(C₁-C₄)-alkyl group, an N,N-di((C₁-C₄)-alkyl)aminocarbonyl-(C₁-C₄)-alkyl group, an N—(C₂-C₈)-acylaminocarbonyl-(C₁-C₄)-alkyl group, an N,N—(C₂-C₈)-diacylaminocarbonyl-(C₁-C₄)-alkyl group, an N—(C₂-C₈)-acyl-N—(C₁-C₄)-alkylaminocarbonyl-(C₁-C₄)-alkyl group, an N-(aryl-(C₁-C₄)-alkyl)aminocarbonyl-(C₁-C₄)-alkyl group, an N-(aryl-(C₁-C₄)-alkyl)-N—(C₁-C₆)-alkylaminocarbonyl-(C₁-C₄)-alkyl group or an N,N-di(aryl-(C₁-C₄)-alkyl)aminocarbonyl-(C₁-C₄)-alkyl group.

It is preferred according to the invention if R³ and R⁴ according to formula (II) represent a hydrogen atom. It is particularly preferred according to the invention if R², R³ and R⁴ according to formula (II) represent a hydrogen atom. Very particularly preferred viscoelastic and solid filling substances according to the invention therefore contain at least one 2,5-diketopiperazine compound according to formula (II-a)

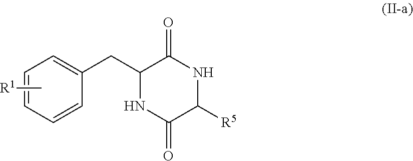

where R¹ and R⁵ are as defined under formula (II) (vide supra).

It has been found to be preferred if the functional group R¹ according to formula (II) and according to formula (II-a) binds in the para position of the phenyl ring. Within the meaning of the present invention, such filling substances according to the invention are preferred which contain at least one 2,5-diketopiperazine compound according to formula (II-b),

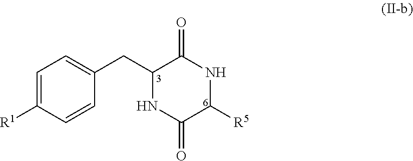

where R¹ and R⁵ are defined as above under formula (II) (vide supra). For illustration purposes, the numbers 3 and 6 positioned on the ring atoms in formula (II-b) mark positions 3 and 6 of the diketopiperazine ring, as they are generally used in the context of the invention for naming all 2,5-diketopiperazines according to the invention.

The 2,5-diketopiperazine compounds of formula (II) have centers of chirality at least on the carbon atoms in positions 3 and 6 of the 2,5-diketopiperazine ring. The numbering of ring positions 3 and 6 was illustrated by way of example in formula (II-b). The 2,5-diketopiperazine compound of formula (II) of the filling substance according to the invention is preferably the configuration isomer 3S, 6S, 3R, 6S, 3S, 6R based on the stereochemistry of the carbon atoms at the 3 and 6 position of the 2,5-diketopiperazine ring, 3R, 6R, or mixtures thereof, particularly preferably 3S, 6S.

Preferred portions contain at least one 2,5-diketopiperazine compound of formula (II) as an organic gelator compound, selected from 3-benzyl-6-carboxyethyl-2,5-diketopiperazine and 3-benzyl-6-carboxymethyl-2,5-diketopiperazine, 3-benzyl-6-(p-hydroxybenzyl)-2,5-diketopiperazine, 3-benzyl-6-iso-propyl-2,5-diketopiperazine, 3-benzyl-6-(4-aminobutyl)-2,5-diketopiperazine, 3,6-di(benzyl)-2,5-diketopiperazine, 3,6-di(p-hydroxybenzyl)-2,5-diketopiperazine, 3,6-di(p-(benzyl oxy)benzyl)-2,5-diketopiperazine, 3-benzyl-6-(4-imidazolyl)methyl-2,5-diketopiperazine, 3-benzyl-6-methyl-2,5-diketopiperazine, 3-benzyl-6-(2-(benzyloxycarbonyl)ethyl)-2,5-diketopiperazine or mixtures thereof in said filling substance. In turn, compounds having the aforementioned configuration isomers are preferably suitable for selection.

It is also possible for the portions according to the invention to contain at least one diarylamidocystine compound of formula (III) in said filling substance as the organic gelator compound

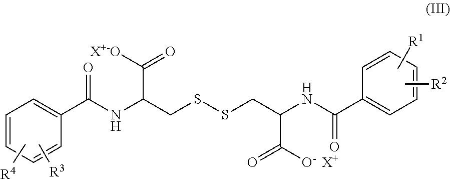

where
X⁺ represents, independently of one another, a hydrogen atom or an equivalent of a cation,
R¹, R², R³, and R⁴ represent, independently of one another, a hydrogen atom, a halogen atom, a C₁-C₄ alkyl group, a C₁-C₄ alkoxy group, a C₂-C₄ hydroxyalkyl group, a hydroxyl group, an amino group, an N—(C₁-C₄-alkyl)amino group, an N,N-Di(C₁-C₄-alkyl)amino group, an N—(C₂-C₄-hydroxyalkyl)amino group, an N,N-Di(C₂-C₄-hydroxyalkyl)amino group, or R¹ with R² or R³ with R⁴ forms a 5-membered or 6-membered annulated ring, which in turn can each be substituted with at least one group from C₁-C₄ alkyl group, C₁-C₄ alkoxy group, C₂-C₄ hydroxyalkyl group, hydroxyl group, amino group, N—(C₁-C₄-alkyl)amino group, N,N-Di(C₁-C₄-alkyl)amino group, N—(C₂-C₄-hydroxyalkyl)amino group, N,N-Di(C₂-C₄-hydroxyalkyl)amino group.

Each of the stereocenters contained in the compound of formula (III) can represent, independently of one another, the L or D stereoisomer. It is preferable according to the invention for the above-mentioned cystine compound of formula (III) to be derived from the L stereoisomer of the cysteine.

The above-mentioned filling substances can contain at least one compound of formula (III), in which R¹, R², R³ and R⁴ represent, independently of one another, a hydrogen atom, a halogen atom, a C₁-C₄ alkyl group, a C₁-C₄ alkoxy group, a C₂-C₄ hydroxyalkyl group, a hydroxyl group, or R¹ with R² or R³ with R⁴ forms a 5-membered or 6-membered annulated ring, which in turn can each be substituted with at least one group from C₁-C₄ alkyl group, C₁-C₄ alkoxy group, C₂-C₄ hydroxyalkyl group, or hydroxyl group. In particular, those filling substances which contain N,N′-dibenzoylcystine (R¹═R²═R³═R⁴=hydrogen atom; X⁺=independently of one another, a hydrogen atom or an equivalent of a cation), in particular N,N′-dibenzoyl-L-cystine, as a diarylamidocystine compound of formula (III) are particularly suitable.

The N—(C₈-C₂₄)-hydrocarbylglyconamide compounds suitable as organic gelator compounds preferably have the formula (IV)

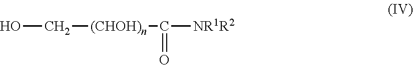

where
n is 2 to 4, preferably 3 or 4, in particular 4;
R¹ is selected from hydrogen, C₁-C₁₆ alkyl functional groups, C₁-C₃ hydroxy or methoxyalkyl functional groups, preferably C₁-C₃ alkyl, hydroxyalkyl or methoxyalkyl functional groups, particularly preferably methyl;
R² is selected from C₈-C₂₄ alkyl functional groups, C₈-C₂₄ monoalkenyl functional groups, C₅-C₂₄ dialkenyl functional groups, C₅-C₂₄ trialkenyl functional groups, C₅-C₂₄ hydroxyalkyl functional groups, C₅-C₂₄ hydroxyalkenyl functional groups,
C₁-C₃ hydroxyalkyl functional groups or methoxy-C₁-C₃-alkyl functional groups, preferably C₈-Cis alkyl functional groups and mixtures thereof, more preferably C₈, C₁₀, C₁₂, C₁₄, C₁₆ and Cis alkyl functional groups and mixtures thereof, most preferably C₁₂ and C₁₄ alkyl functional groups or a mixture thereof.

In particularly preferred embodiments, the functional group

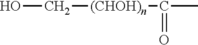

a functional group derived from a glycuronic acid, in particular the glycuronic acid of a hexose (n=4). In particular, glucuronic acid should be mentioned as a preferred functional group. R¹ is preferably H or a short-chain alkyl functional group, in particular methyl. R² is preferably a long-chain alkyl functional group, for example a C₈-Cis alkyl functional group.

Compounds of formula (IV-1) are therefore very particularly preferred

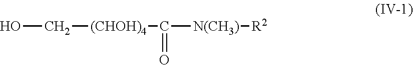

where R² has the meanings given for formula (IV).

The filling substance according to the invention of the portion according to the invention optionally contains water. It is preferred if water is contained in said filling substance in a total amount of from 0 to 30 wt. %, more preferably between 0 and 30 wt. %, particularly preferably from 0 to 25 wt. %, more preferably between 0 and 25 wt. %, very particularly preferably from 0 to 20 wt. %, more preferably between 0 and 20 wt. %, based on the total weight of the filling substance. The proportion of water in the filling substance is very particularly preferably 20 wt. % or less, more preferably 15 wt. % or less, even more preferably 12 wt. % or less, in particular between 4 and 11 wt. %. The amounts in wt. % refer to the total weight of the filling substance in each case.

Viscoelastic, solid filling substances that can be preferably used are characterized in that they additionally contain at least one organic solvent having a molecular weight of at most 500 g/mol. It is in turn particularly preferred if the said organic solvent is selected from (C₂-C₈)-alkanols having at least one hydroxyl group (very particularly preferably from ethanol, ethylene glycol, 1,2-propanediol, glycerol, 1,3-propanediol, n-propanol, isopropanol, 1,1,1-trimethylolpropane, 2-methyl-1,3-propanediol, 2-hydroxymethyl-1,3-propanediol), triethylene glycol, butyl diglycol, polyethylene glycols having a weight average molar mass M_{w} of at most 500 g/mol, glycerine carbonate, propylene carbonate, 1-methoxy-2-propanol, 3-methoxy-3-methyl-1-butanol, butyl lactate, 2-isobutyl-2-methyl-4-hydroxymethyl-1,3-dioxolane, 2,2-dimethyl-4-hydroxymethyl-1,3-dioxolane, dipropylene glycol, or mixtures thereof.

Said organic solvent is particularly preferably contained in said at least one filling substance in a total amount of 5 to 40 wt. %, in particular 10 to 35 wt. %, based on the total weight of said at least one filling substance.

It is preferred according to the invention if the viscoelastic and solid filling substance is present in the portion as a shaped body.

A shaped body is a single body that stabilizes itself in the shape imparted to it. This dimensionally stable body is formed from a molding compound (e.g. a composition) in such a way that this molding compound is deliberately brought into a predetermined shape, for example by pouring a liquid composition into a casting mold (for example the shell according to the invention) and then curing the liquid composition, for example as part of a sol-gel process. All conceivable shapes are possible, such as spheres, cubes, cuboids, round discs, tubs, bowls, prisms, octahedra, tetrahedra, egg shapes, dogs, cats, mice, horses, torsos, busts, pillows, automobiles, oval discs having an embossed trademark, and much more.

It is preferred according to the invention if the shaped body of the viscoelastic, solid filling substance has a weight of at least 1 g, preferably at least 5 g, particularly preferably at least 10 g.

It is preferred according to the invention if the shaped body according to the invention of the viscoelastic, solid filling substance has a weight of at most 80 g, in particular at most 70 g, particularly preferably at most 50 g, very particularly preferably at most 40 g, most preferably at most 30 g. In this context, the aforementioned minimum weights of the shaped bodies are particularly preferred.

The shaped body of the viscoelastic, solid filling substance very particularly preferably has a weight of from 10 to 80 g, in particular from 10 to 70 g, more preferably from 10 to 50 g, most preferably from 10 to 30 g, for example 15 g or 25 g. It is again preferred if the said shaped body contains surfactant in the total amounts marked as preferred (vide supra).

According to the invention, preferred viscoelastic, solid filling substances additionally contain at least one active ingredient selected from polyalkoxylated polyamine, soil-release active ingredient, enzyme, builder, optical brightener (preferably in portions for textile washing), pH adjuster, perfume, dye, dye transfer inhibitor or mixtures thereof.

It is preferred according to the invention if the viscoelastic, solid filling substance according to the invention (in particular as a textiles washing agent) contains at least one polyalkoxylated polyamine in addition to the surfactant.

In the context of the present invention and its individual aspects, the polyalkoxylated polyamine is a polymer having an N-atom-containing backbone which carries polyalkoxy groups on the N atoms. The polyamine has primary amino functions at the ends (terminus and/or side chains) and preferably both secondary and tertiary amino functions internally; optionally, it may also have merely secondary amino functions internally, such that a linear polyamine, and not a branched chain polyamine, is produced. The ratio of primary to secondary amino groups in the polyamine is preferably in the range of from 1:0.5 to 1:1.5, in particular in the range of from 1:0.7 to 1:1. The ratio of primary to tertiary amino groups in the polyamine is preferably in the range of from 1:0.2 to 1:1, in particular in the range of from 1:0.5 to 1:0.8. The polyamine preferably has an average molar mass in the range of from 500 g/mol to 50,000 g/mol, in particular from 550 g/mol to 5,000 g/mol. The N atoms in the polyamine are separated from one another by alkylene groups, preferably by alkylene groups having 2 to 12 C atoms, in particular 2 to 6 C atoms, although it is not necessary for all the alkylene groups to have the same number of C atoms. Ethylene groups, 1,2-propylene groups, 1,3-propylene groups, and mixtures thereof are particularly preferred. Polyamines which carry ethylene groups as said alkylene group are also referred to as polyethyleneimine or PEI. PEI is a polymer that is particularly preferred according to the invention and has an N-atom-containing backbone.

The primary amino functions in the polyamine can carry 1 or 2 polyalkoxy groups and the secondary amino functions can carry 1 polyalkoxy group, although it is not necessary for every amino function to be alkoxy group-substituted. The average number of alkoxy groups per primary and secondary amino function in the polyalkoxylated polyamine is preferably from 1 to 100, in particular from 5 to 50. The alkoxy groups in the polyalkoxylated polyamine are preferably polypropoxy groups which are directly bound to N atoms, and/or polyethoxy groups which are bound to potentially present propoxy functional groups and to N atoms which do not carry propoxy groups.

Polyethoxylated polyamines are obtained by reacting polyamines with ethylene oxide (abbreviated to EO). The polyalkoxylated polyamines containing ethoxy and propoxy groups are preferably obtainable by reacting polyamines with propylene oxide (abbreviated to PO) and subsequent reaction with ethylene oxide.

The average number of propoxy groups per primary and secondary amino function in the polyalkoxylated polyamine is preferably from 1 to 40, in particular from 5 to 20.

The average number of ethoxy groups per primary and secondary amino function in the polyalkoxylated polyamine is preferably from 10 to 60, in particular from 15 to 30.

If desired, the terminal OH function polyalkoxy substituents in the polyalkoxylated polyamine can be partially or completely etherified with a C₁-C₁₀ alkyl group, in particular a C₁-C₃ alkyl group.

Polyalkoxylated polyamines which are particularly preferred according to the invention can be selected from polyamine reacted with 45EO per primary and secondary amino function, PEIs reacted with 43EO per primary and secondary amino function, PEIs reacted with 15EO+5PO per primary and secondary amino function, PEIs reacted with 15PO+30EO per primary and secondary amino function, PEIs reacted with 5PO+39.5EO per primary and secondary amino function, PEIs reacted with 5PO+15EO per primary and secondary amino function, PEIs reacted with 10PO+35EO per primary and secondary amino function, PEIs reacted with 15PO+30EO per primary and secondary amino function and PEIs reacted with 15PO+5EO per primary and secondary amino function. A very particularly preferred alkoxylated polyamine is PEI having a content of from 10 to 20 nitrogen atoms reacted with 20 units of EO per primary or secondary amino function of the polyamine.

A further preferred subject of the invention is the use of polyalkoxylated polyamines which can be obtained by reacting polyamines with ethylene oxide and optionally also propylene oxide. If polyamines polyalkoxylated with ethylene oxide and propylene oxide are used, the proportion of propylene oxide in terms of the total amount of the alkylene oxide is preferably from 2 mol. % to 18 mol. %, in particular from 8 mol. % to 15 mol. %.

The viscoelastic, solid filling substance according to the invention additionally contains, based on the weight thereof, polyalkoxylated polyamines, preferably in a total amount of from 0.5 to 12 wt. %, in particular from 5.0 to 9.0 wt. %.

In a further preferred embodiment, the viscoelastic, solid filling substance according to the invention, in particular as a textiles washing agent, additionally contains at least one soil-release active ingredient. Substances which allow the removal of dirt are often referred to as soil-release active ingredients or as soil repellents since they are capable of making the treated surface, preferably textiles, repellant to soil. Owing to their chemical similarity to polyester fibers, particularly effective active ingredients which allow the removal of dirt, but can also exhibit the desired effect on fabrics made of other materials, are copolyesters containing dicarboxylic acid units, alkylene glycol units and polyalkylene glycol units. Such polyesters which allow the removal of dirt and the use thereof, preferably in detergents for textiles, have long been known.

For example, polymers of ethylene terephthalate and polyethylene oxide terephthalate in which the polyethylene glycol units have molecular weights of from 750 to 5,000 and the molar ratio of ethylene terephthalate to polyethylene oxide terephthalate is from 50:50 to 90:10, and the use thereof in detergents are described in the German patent DE 28 57 292. Polymers that have a molecular weight of from 15,000 to 50,000 and consist of ethylene terephthalate and polyethylene oxide terephthalate in which the polyethylene glycol units have molecular weights of from 1,000 to 10,000 and the molar ratio of ethylene terephthalate to polyethylene oxide terephthalate is from 2:1 to 6:1 can be used in detergents according to the German patent DE 33 24 258. European patent EP 066 944 relates to textile treatment agents containing a copolyester of ethylene glycol, polyethylene glycol, aromatic dicarboxylic acid and sulfonated aromatic dicarboxylic acid in certain molar ratios. European patent EP 185 427 discloses polyesters that are end-capped with methyl or ethyl groups and have ethylene and/or propylene terephthalate and polyethylene oxide terephthalate units, and detergents containing soil-release polymers of this kind. European patent EP 241 984 relates to a polyester which, in addition to oxyethylene groups and terephthalic acid units, also contains substituted ethylene units and glycerol units. European patent EP 241 985 discloses polyesters which, in addition to oxyethylene groups and terephthalic acid units, contain 1,2-propylene, 1,2-butylene and/or 3-methoxy-1,2-propylene groups and glycerol units, and which are end-capped with C₁ to C₄ alkyl groups. European patent EP 253 567 relates to soil-release polymers that have a molar mass of from 900 to 9,000 and consist of ethylene terephthalate and polyethylene oxide terephthalate, wherein the polyethylene glycol units have molecular weights of from 300 to 3,000 and the molar ratio of ethylene terephthalate to polyethylene oxide terephthalate is 0.6 to 0.95. European patent application EP 272 033 discloses polyesters that are end-capped at least in portions with C₁-4 alkyl or acyl functional groups and that have polypropylene terephthalate and polyoxyethylene terephthalate units. European patent EP 274 907 describes sulfoethyl-end-capped soil-release polyesters containing terephthalate. In European patent application EP 357 280, soil-release polyesters having terephthalate, alkylene glycol and poly-C₂₋₄ glycol units are produced by sulfonation of unsaturated end groups.

In a preferred embodiment of the invention, the viscoelastic, solid filling substance according to the invention contains at least one polyester which allows the removal of dirt and contains the structural units EI to E-III or EI to E-IV,

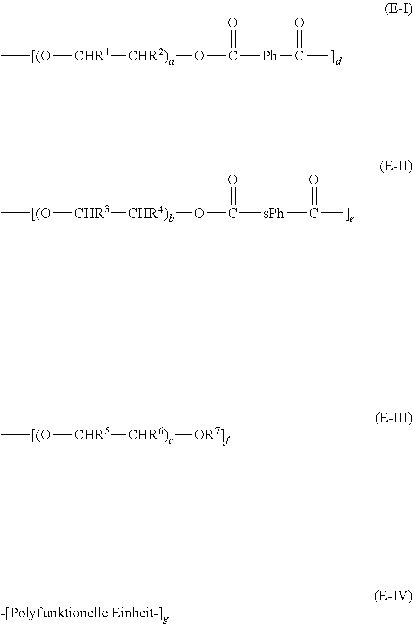

in which
a, b and c each represent, independently of one another, a number from 1 to 200,
d, e and f each represent, independently of one another, a number from 1 to 50,
g represents a number from 0 to 5,
Ph is a 1,4-phenylene functional group,
sPh represents a 1,3-phenylene functional group substituted with a—SO₃M group in position 5,
M represents Li, Na, K, Mg/2, Ca/2, AI/3, ammonium, mono-, di-, tri- or tetraalkylammonium, the alkyl functional groups of the ammonium ions being C₁-C₂₂ alkyl or C₂-C₁₀ hydroxyalkyl functional groups or any mixtures thereof,
R¹, R², R³, R⁴, R⁵ and R⁶ each represent, independently of one another, hydrogen or a C₁-C₁₈ n- or iso-alkyl group,
R⁷ represents a linear or branched C₁-C₃₀ alkyl group or a linear or branched C₂-C₃₀ alkenyl group, a cycloalkyl group having 5 to 9 carbon atoms, a C₆-C₃₀ aryl group or a C₆-C₃₀ arylalkyl group, and
the polyfunctional unit represents a unit having 3 to 6 functional groups capable of esterification reaction.

Preference is given to those polyesters in which R¹, R², R³, R⁴, R⁵ and R⁶ are each, independently of one another, hydrogen or methyl, R⁷ is methyl, a, b and c are each, independently of one another, a number from 1 to 200, in particular from 1 to 20, particularly preferably from 1 to 5, extremely preferably a and b=1 and c can be a number from 2 to 10, d is a number between 1 and 25, in particular between 1 and 10, particularly preferably between 1 and 5, e is a number between 1 and 30, in particular between 2 and 15, particularly preferably between 3 and 10, and f is a number between 0.05 and 15, in particular between 0.1 and 10, and particularly preferably between 0.25 and 3. Polyesters of this kind can be obtained, for example, by polycondensation of terephthalic acid dialkyl ester, 5-sulfoisophthalic acid dialkyl ester, alkylene glycols, optionally polyalkylene glycols (where a, b and/or c>1) and polyalkylene glycols capped at one end (corresponding to unit E-III). It should be noted that, for numbers a, b, c>1, there is a polymer backbone and thus the coefficients can assume, as an average, any value within the specified interval. This value reflects the number-average molecular weight. An ester of terephthalic acid having one or more difunctional, aliphatic alcohols is considered as unit (E-I), with ethylene glycol (R¹ and R² each being H) and/or 1,2-propylene glycol (R¹═H and R²═—CH₃ or vice versa) and/or shorter-chain polyethylene glycols and/or poly[ethylene glycol-co-propylene glycol] having number-average molecular weights of from 100 to 2,000 g/mol being preferably used. The structures can contain, for example, 1 to 50 units (E-I) per polymer chain. An ester of 5-sulfoisophthalic acid having one or more difunctional, aliphatic alcohols is considered as unit (E-II), with the above-mentioned esters preferably being used in this case. There can be, for example, 1 to 50 units (E-II) in the structures. Poly[ethylene glycol-co-propylene glycol] monomethyl ethers having average molecular weights of from 100 to 2,000 g/mol and polyethylene glycol monomethyl ethers of general formula CH₃—O—(C₂H₄O)ₙ—H where n=1 to 99, in particular 1 to 20 and particularly preferably 2 to 10, are preferably used as polyalkylene glycol monoalkyl ethers according to unit (E-III) that are non-ionically capped at one end. Since the theoretical maximum average molecular weight, to be achieved using quantitative conversion, of a polyester structure is specified by the use of such ethers that are capped at one end, the preferred use amount of structural unit (E-III) is that which is necessary for achieving the average molecular weights described below. With the exception of linear polyesters which result from structural units (E-I), (E-II) and (E-III), the use of crosslinked or branched polyester structures is also according to the invention. This is expressed by the presence of a crosslinking polyfunctional structural unit (E-IV) having at least three to at most 6 functional groups capable of an esterification reaction. Acid, alcohol, ester, anhydride or epoxy groups, for example, can be named as functional groups in this case. Different functionalities in one molecule are also possible. Examples of this are citric acid, malic acid, tartaric acid and gallic acid, particularly preferably 2,2-dihydroxymethylpropionic acid. Polyhydric alcohols such as pentaerythrol, glycerol, sorbitol and/or trimethylolpropane can also be used. These may also be polyvalent aliphatic or aromatic carboxylic acids, such as benzene-1,2,3-tricarboxylic acid (hemimellitic acid), benzene-1,2,4-tricarboxylic acid (trimellitic acid), or benzene-1,3,5-tricarboxylic acid (trimesic acid). The weight proportion of crosslinking monomers, based on the total mass of the polyester, can be up to 10 wt. %, in particular up to 5 wt. %, and particularly preferably up to 3 wt. %, for example. The polyesters, containing the structural units (EI), (E-II) and (E-III) and optionally (E-IV), generally have number-average molecular weights in the range of from 700 to 50,000 g/mol, it being possible to determine the number-average molecular weight by means of size-exclusion chromatography in aqueous solution, using calibration with reference to closely distributed polyacrylic acid Na salt standards. Preferably, the number-average molecular weights are in the range of from 800 to 25,000 g/mol, in particular from 1,000 to 15,000 g/mol, particularly preferably from 1,200 to 12,000 g/mol. Preferably, solid polyesters having softening points above 40° C. are used according to the invention as a component of the particle of the second type; said polyesters preferably have a softening point of between 50 and 200° C., particularly preferably between 80° C. and 150° C., and extremely preferably between 100° C. and 120° C. The polyesters can be synthesized using known methods, for example by the above-mentioned components first being heated at normal pressure with the addition of a catalyst and then forming the required molecular weights in the vacuum by hyperstoichiometric amounts of the glycols used being distilled off. The known transesterification and condensation catalysts, such as titanium tetraisopropylate, dibutyltin oxide, alkaline or alkaline-earth metal alcoholates, or antimony trioxide/calcium acetate, are suitable for the reaction. Reference is made to EP 442 101 for further details.

The filling substance according to the invention, for example the granular mixture and/or, if present, a further phase, preferably a viscoelastic, solid filling substance, can additionally contain at least one enzyme as a washing or cleaning agent. In principle, all the enzymes found in the prior art for textile treatment can be used in this regard. This at least one enzyme is preferably one or more enzymes which can develop catalytic activity in a surfactant-containing liquor, in particular a protease, amylase, lipase, cellulase, hemicellulase, mannanase, pectin-cleaving enzyme, tannase, xylanase, xanthanase, β-glucosidase, carrageenanase, perhydrolase, oxidase, oxidoreductase and mixtures thereof. Preferred suitable hydrolytic enzymes include in particular proteases, amylases, in particular α-amylases, cellulases, lipases, hemicellulases, in particular pectinases, mannanases, β-glucanases, and mixtures thereof. Proteases, amylases and/or lipases and mixtures thereof are particularly preferred, and proteases are very particularly preferred. These enzymes are in principle of natural origin; starting from the natural molecules, variants that have been improved for use in washing or cleaning agents are available, which are preferably used accordingly.

Among the proteases, the subtilisin-type proteases are preferred. Examples of these are the subtilisins BPN′ and Carlsberg, protease PB92, subtilisins 147 and 309, the alkaline protease from Bacillus lentus, subtilisin DY, and the enzymes thermitase, proteinase K and proteases TW3 and TW7, which belong to the subtilases but no longer to the subtilisins in the narrower sense. Subtilisin Carlsberg is available in a developed form under the trade name Alcalase® from Novozymes A/S, Bagsvaerd, Denmark. Subtilisins 147 and 309 are marketed by Novozymes under the trade names Esperase® and Savinase®, respectively. The protease variants marketed under the name BLAP® are derived from the protease from Bacillus lentus DSM 5483. Other proteases that can be used are, for example, the enzymes available under the trade names Durazym®, Relase®, Everlase®, Nafizym®, Natalase®, Kannase® and Ovozyme® from Novozymes, the enzymes available under the trade names Purafect®, Purafect® OxP, Purafect® Prime, Excellase® and Properase® from Genencor, the enzyme available under the trade name Protosol® from Advanced Biochemicals Ltd., Thane, India, the enzyme available under the trade name Wuxi® from Wuxi Snyder Bioproducts Ltd., China, the enzymes available under the trade names Proleather® and Protease P® from Amano Pharmaceuticals Ltd., Nagoya, Japan, and the enzyme available under the name Proteinase K-16 from Kao Corp., Tokyo, Japan. The proteases from Bacillus gibsonii and Bacillus pumilus are particularly preferably used.

Examples of amylases that can be used according to the invention are α-amylases from Bacillus licheniformis, from B. amyloliquefaciens or from B. stearothermophilus, as well as the developments thereof that have been improved for use in washing or cleaning agents. The enzyme from B. licheniformis is available from Novozymes under the name Termamyl® and from Genencor under the name Purastar®ST. Development products of this α-amylase are available from Novozymes under the trade names Duramyl® and Termamyl®ultra, from Genencor under the name Purastar®OxAm, and from Daiwa Seiko Inc., Tokyo, Japan, as Keistase®. The α-amylase from B. amyloliquefaciens is marketed by Novozymes under the name BAN®, and derived variants from the α-amylase from B. stearothermophilus are marketed under the names BSG® and Novamyl®, also by Novozymes. Others that are particularly noteworthy for this purpose are the α-amylases from Bacillus sp. A 7-7 (DSM 12368) and cyclodextrin glucanotransferase (CGTase) from B. agaradherens (DSM 9948). Fusion products of all mentioned molecules can also be used. Furthermore, the developments of the α-amylase from Aspergillus niger and A. oryzae, available under the trade name Fungamyl® from Novozymes, are suitable. Other commercial products that can advantageously be used are, for example, Amylase-LT®, and Stainzyme® or Stainzyme Ultra® or Stainzyme Plus®, the latter also from Novozymes. Variants of these enzymes that can be obtained by point mutations can also be used according to the invention.

Examples of lipases or cutinases that can be used according to the invention, which are contained in particular due to their triglyceride-cleaving activities, but also in order to produce peracids in situ from suitable precursors, are the lipases that can be originally obtained or developed from Humicola lanuginosa (Thermomyces lanuginosis), in particular those with the amino acid exchange D96L. These are marketed for example by Novozymes under the trade names Lipolase®, Lipolase®Ultra, LipoPrime®, Lipozyme® and Lipex®. Moreover, the cutinases which have been originally isolated from Fusarium solani pisi and Humicola insolens can also be used, for example. Lipases that can also be used are available from Amano under the names Lipase CE®, Lipase P®, Lipase B®, and Lipase CES®, Lipase AKG®, Bacillus sp. Lipase®, Lipase AP®, Lipase M-AP® and Lipase AML®. From Genencor, the lipases or cutinases of which the starting enzymes have been isolated originally from Pseudomonas mendocina and Fusarium solanii can be used, for example. The preparations M1 Lipase® and Lipomax® originally marketed by Gist-Brocades, the enzymes marketed by Meito Sangyo KK, Japan, under the names Lipase MY-30®, Lipase OF® and Lipase PL®, and the product Lumafast® from Genencor should be mentioned as other important commercial products.

Depending on their purpose, cellulases can be present as pure enzymes, as enzyme preparations or in the form of mixtures in which the individual components are advantageously complementary in terms of their different performance aspects, in particular in portions for textile washing. These performance aspects include in particular anything from contributions of the cellulase to the primary washing performance of the agent (cleaning performance), the secondary washing performance of the agent (anti-redeposition or graying inhibitors) and softening (effect on fabric), to producing a “stonewashed” effect. A usable fungal cellulase preparation that is rich in endoglucanase (EG) and the developments thereof are provided by Novozymes under the trade name Celluzyme®. The products Endolase® and Carezyme® also available from Novozymes are based on 50 kD-EG and 43 kD-EG, respectively, from H. insolens DSM 1800. Other commercial products from this company that can be used are Cellusoft®, Renozyme® and Celluclean®. It is also possible to use, for example, 20 kD-EG from Melanocarpus, which are available from AB Enzymes, Finland under the trade names Ecostone® and Biotouch®. Other commercial products from AB Enzymes are Econase® and Ecopulp®. Further suitable cellulases are from Bacillus sp. CBS 670.93 and CBS 669.93, with the cellulase from Bacillus sp. CBS 670.93 being available from Genencor under the trade name Puradax®. Other commercial products from Genencor are “Genencor detergent cellulase L” and IndiAge®Neutra. Variants of these enzymes that can be obtained by point mutations can also be used according to the invention. Particularly preferred cellulases are Thielavia terrestris cellulase variants, cellulases from Melanocarpus, in particular Melanocarpus albomyces, EGIII-type cellulases from Trichoderma reesei, or variants that can be obtained therefrom.

Furthermore, other enzymes which can be grouped together under the term “hemicellulases” can be used in particular to remove specific problematic stains on the substrate. These include, for example, mannanases, xanthan lyases, xanthanases, xyloglucanases, xylanases, pullulanases, pectin-cleaving enzymes, and β-glucanases. The β-glucanase obtained from Bacillus subtilis is available from Novozymes under the name Cereflo®. Hemicellulases that are particularly preferred according to the invention are mannanases which are marketed, for example, under the trade names Mannaway® by Novozymes or Purabrite® by Genencor. In the context of the present invention, the pectin-cleaving enzymes also include enzymes having the names pectinase, pectate lyase, pectin esterase, pectin demethoxylase, pectin methoxylase, pectin methylesterase, pectase, pectin methylesterase, pectinesterase, pectin pectyl hydrolase, pectin depolymerase, endopolygalacturonase, pectolase, pectin hydrolase, pectin polygalacturonase, endopolygalacturonase, poly-α-1,4-galacturonide, glycanohydrolase, endogalacturonase, endo-D-galacturonase, galacturan 1,4-α-galacturonidase, exopolygalacturonase, poly(galacturonate) hydrolase, exo-D-galacturonase, exo-D-galacturonanase, exopoly-D-galacturonase, exo-poly-α-galacturonosidase, exopolygalacturonosidase, or exopolygalacturanosidase. Examples of enzymes that are suitable in this regard are available for example under the names Gamanase®, Pektinex AR®, XPect® or Pectaway® from Novozymes, under the names Rohapect UF®, Rohapect TPL®, Rohapect PTE100®, Rohapect MPE®, Rohapect MA plus HC, Rohapect DA12L®, Rohapect 10L®, Rohapect B1L® from AB Enzymes, and under the name Pyrolase® from Diversa Corp., San Diego, Calif., USA.

Of all these enzymes, particularly preferred are those which have been stabilized in a comparatively stable manner against oxidation or by means of point mutagenesis, for example. This includes in particular the above-mentioned commercial products Everlase® and Purafect®OxP as examples of proteases of this kind and Duramyl® as an example of an α-amylase of this kind.

The viscoelastic, solid filling substance according to the invention contains enzymes preferably in total amounts of from 1×10⁻⁸ to 5 wt. % based on active protein. Preferably, the enzymes are contained in a total amount of from 0.001 to 2 wt. %, more preferably from 0.01 to 1.5 wt. %, even more preferably from 0.05 to 1.25 wt. %, and particularly preferably from 0.01 to 0.5 wt. %.

The use of builder substances (builders) such as silicates, aluminum silicates (in particular zeolites), salts of organic di- and polycarboxylic acids, as well as mixtures of these substances, preferably water-soluble builder substances, can be advantageous.

In an embodiment that is preferred according to the invention, the use of phosphates (including polyphosphates) is omitted either largely or completely. In this embodiment, the viscoelastic, solid filling substance according to the invention preferably contains less than 5 wt. %, particularly preferably less than 3 wt. %, in particular less than 1 wt. %, phosphate(s). Particularly preferably, the viscoelastic, solid filling substance according to the invention in this embodiment is completely phosphate-free, i.e. the compositions contain less than 0.1 wt. % phosphate(s).

The builders include, in particular, carbonates, citrates, phosphonates, organic builders, and silicates. The proportion by weight of the total builders with respect to the total weight of the filling substance according to the invention, in particular the granular amount and/or the viscoelastic, solid composition, is preferably from 15 to 80 wt. % and in particular from 20 to 70 wt. %, for dishwashing detergents.

Some examples of organic builders that are suitable according to the invention are the polycarboxylic acids (polycarboxylates) that can be used in the form of their sodium salts, with polycarboxylic acids being understood as being those carboxylic acids that carry more than one, in particular two to eight, acid functions, preferably two to six, in particular two, three, four, or five acid functions in the entire molecule. As polycarboxylic acids, dicarboxylic acids, tricarboxylic acids, tetracarboxylic acids, and pentacarboxylic acids, in particular di-, tri-, and tetracarboxylic acids, are thus preferred. The polycarboxylic acids can also carry additional functional groups such as hydroxyl or amino groups, for example. For example, these include citric acid, adipic acid, succinic acid, glutaric acid, malic acid, tartaric acid, maleic acid, fumaric acid, saccharic acids (preferably aldaric acids, for example galactaric acid and glucaric acid), aminocarboxylic acids, in particular aminodicarboxylic acids, aminotricarboxylic acids, aminotetracarboxylic acids such as, for example, nitrilotriacetic acid (NTA), glutamic-N,N-diacetic acid (also called N,N-bis(carboxymethyl)-L-glutamic acid or GLDA), methyl glycine diacetic acid (MGDA) and derivatives thereof and mixtures thereof. Preferred salts are the salts of the polycarboxylic acids such as citric acid, adipic acid, succinic acid, glutaric acid, tartaric acid, GLDA, MGDA, and mixtures thereof.

Other substances that are suitable as organic builders are polymeric polycarboxylates (organic polymers with a plurality of (in particular greater than ten) carboxylate functions in the macromolecule), polyaspartates, polyacetals, and dextrins.

Besides their builder effect, the free acids also typically have the quality of an acidification component. Particularly noteworthy here are citric acid, succinic acid, glutaric acid, adipic acid, gluconic acid, and any mixtures thereof.

Particularly preferred filling substances according to the invention contain one or more salts of citric acid, i.e. citrates, as one of their essential builders. These are contained in the filling substances according to the invention, in particular in the at least one granular mixture and/or the viscoelastic, solid filling substances (in particular for textile washing), preferably in a proportion of from 0.3 to 10 wt. %, in particular from 0.5 to 8 wt. %, particularly from 0.7 to 6.0 wt. %, particularly preferably 0.8 to 5.0 wt. %, based in each case on the total weight of the filling substance. One or more salts of citric acid are contained in the filling substances according to the invention, in particular in the at least one granular mixture and/or the viscoelastic, solid filling substances (in particular for cleaning hard surfaces, in particular for cleaning dishes), in a proportion of from 2 to 40 wt. %, in particular from 5 to 30 wt. %, particularly from 7 to 28 wt. %, particularly preferably from 10 to 25 wt. %, very particularly preferably from 15 to 20 wt. %, in each case based on the total weight of the composition.

The filling substances according to the invention, in particular in the at least one granular mixture and/or the viscoelastic, solid filling substances, can contain, in particular, phosphonates as a further builder. A hydroxy alkane and/or amino alkane phosphonate is preferably used as a phosphonate compound. Among the hydroxyalkanephosphonates, 1-hydroxyethane-1,1-diphosphonate (HEDP) is of particular importance. Ethylenediamine tetramethylene phosphonate (EDTMP), diethylenetriamine pentamethylene phosphonate (DTPMP) and higher homologs thereof are preferably considered. Phosphonates are preferably contained in filling substances according to the invention in amounts of from 0.1 to 10 wt. %, in particular in amounts of from 0.5 to 8 wt. %, very particularly preferably from 2.5 to 7.5 wt. %, in each case based on the total weight of the composition.

The combined use of citrate, (hydrogen) carbonate and phosphonate is particularly preferred (especially for use in dishwashing detergents). These can be used in the above-mentioned amounts. In particular, amounts of from 10 to 25 wt. % citrate, 10 to 30 wt. % carbonate (or hydrogen carbonate), and 2.5 to 7.5 wt. % phosphonate are used in this combination in the filling substances according to the invention, in particular in the at least one granular mixture and/or the viscoelastic, solid filling substances, in each case based on the total weight of the composition.

Additional particularly preferred filling substances according to the invention, in particular the at least one granular mixture and/or the viscoelastic, solid filling substances, in particular for use as a washing or cleaning agent, preferably as a dishwashing detergent, more preferably as an automatic dishwasher detergent, are characterized in that, in addition to citrate and (hydrogen) carbonate and, optionally, phosphonate, they contain at least one additional phosphorus-free builder. In particular, it is selected from aminocarboxylic acids, with the additional phosphorous-free builder preferably being selected from methyl glycine diacetic acid (MGDA), glutamic acid diacetate (GLDA), aspartic acid diacetate (ASDA), hydroxyethyliminodiacetate (HEIDA), iminodisuccinate (IDS), and ethylenediamine disuccinate (EDDS), particularly preferably from MGDA or GLDA. An example of a particularly preferred combination is citrate, (hydrogen) carbonate, and MGDA as well as, optionally, phosphonate.

The proportion by weight of the additional phosphorous-free builder, in particular of the MGDA and/or GLDA, is preferably from 0 to 40 wt. %, in particular from 5 to 30 wt. %, more particularly from 7 to 25 wt. %. The use of MGDA or GLDA, in particular MGDA, as granular material is particularly preferred. Advantageous in this regard are MGDA granules that contain as little water as possible and/or have a lower hygroscopicity (water absorption at 25° C., normal pressure) than non-granulated powders. The combination of at least three, in particular at least four, builders from the above-mentioned group has been found to be advantageous for the cleaning and rinsing performance of the portions according to the invention, in particular portions for use as dishwashing detergents, preferably automatic dishwasher detergents. Besides those, additional builders can also be contained.

Polymeric polycarboxylates are also suitable as organic builders. These are, for example, the alkali metal salts of polyacrylic acid or polymethacrylic acid, for example those having a relative molecular mass of from 500 to 70,000 g/mol. Suitable polymers are in particular polyacrylates which preferably have a molecular mass of from 1,000 to 20,000 g/mol. Due to their superior solubility, the short-chain polyacrylates, which have molar masses of from 1,100 to 10,000 g/mol, and particularly preferably from 1,200 to 5,000 g/mol, can in turn be preferred from this group.

The filling substances according to the invention, in particular the at least one granular mixture and/or the viscoelastic, solid filling substances, can also contain, as a builder, crystalline layered silicates of general formula NaMSiₓO₂ₓ₊₁.y H₂O, where M represents sodium or hydrogen, x is a number from 1.9 to 22, preferably from 1.9 to 4, with 2, 3, or 4 being particularly preferred values for x, and y represents a number from 0 to 33, preferably from 0 to 20. It is also possible to use amorphous sodium silicates with a modulus Na₂O:SiO₂ modulus of from 1:2 to 1:3.3, preferably from 1:2 to 1:2.8, and in particular from 1:2 to 1:2.6 which preferably exhibit retarded dissolution and secondary washing properties.

It is also preferred, especially for portions which are to be used as dishwashing detergents, in particular automatic dishwasher detergents, that they contain at least one copolymer comprising at least one sulfonic acid group-containing monomer in the shell material as the active ingredient and/or in the filling substances according to the invention, in particular the at least one granular mixture and/or the viscoelastic, solid filling substances. A sulfopolymer, preferably a copolymeric polysulfonate, preferably a hydrophobically modified copolymeric polysulfonate, is preferably used. The copolymers can have two, three, four, or more different monomer units. Preferred copolymeric polysulfonates contain, besides sulfonic acid group-containing monomer(s), at least one monomer from the group of the unsaturated carboxylic acids.

As the unsaturated carboxylic acid(s), unsaturated carboxylic acids of the formula R¹(R²)C═C(R³)COOH are particularly preferably used, in which R¹ to R³, independently of one another, represent —H, —CH₃, a straight-chain or branched saturated alkyl functional group having 2 to 12 carbon atoms, a straight-chain or branched, mono- or polyunsaturated alkenyl functional group having 2 to 12 carbon atoms, —NH₂, —OH, or —COOH-substituted alkyl or alkenyl functional groups as defined above, or represent —COOH or —COOR⁴, where R⁴ is a saturated or unsaturated, straight-chain or branched hydrocarbon functional group having 1 to 12 carbon atoms.

Particularly preferred unsaturated carboxylic acids are acrylic acid, methacrylic acid, ethacrylic acid, α-chloroacrylic acid, α-cyanoacrylic acid, crotonic acid, α-phenylacrylic acid, maleic acid, maleic anhydride, fumaric acid, itaconic acid, citraconic acid, methylene malonic acid, sorbic acid, cinnamic acid, or mixtures thereof. The unsaturated dicarboxylic acids can obviously also be used.

For sulfonic acid group-containing monomers, those of the formula R⁵(R⁶)C═C(R⁷)—X—SO₃H are preferred, in which R⁵ to R⁷, independently of one another, represent —H, —CH₃, a straight-chain or branched saturated alkyl functional group having 2 to 12 carbon atoms, a straight-chain or branched, mono- or polyunsaturated alkenyl functional group having 2 to 12 carbon atoms, —NH₂, —OH, or —COOH-substituted alkyl or alkenyl functional groups, or represent —COOH or —COOR⁴, where R⁴ is a saturated or unsaturated, straight-chain or branched hydrocarbon functional group having 1 to 12 carbon atoms, and X represents an optionally present spacer group that is selected from —(CH₂)ₙ—, where n=0 to 4, —COO—(CH₂)ₖ—, where k=1 to 6, —C(O)—NH—C(CH₃)₂—, —C(O)—NH—C(CH₃)₂—CH₂— and —C(O)—NH—CH(CH₃)—CH₂—.

Amongst said monomers, those of formulas H₂C═CH—X—SO₃H, H₂C═C(CH₃)—X—SO₃H or HO₃S—X—(R⁶)C═C(R⁷)—X—SO₃H are preferred, in which R⁶ and R⁷, independently of one another, are selected from —H, —CH₃, —CH₂CH₃, —CH₂CH₂CH₃ and —CH(CH₃)₂, and X represents an optionally present spacer group that is selected from —(CH₂)ₙ—, where n=0 to 4, —COO—(CH₂)ₖ—, where k=1 to 6, —C(O)—NH—C(CH₃)₂—, —C(O)—NH—C(CH₃)₂—CH₂— and —C(O)—NH—CH(CH₃)—CH₂—.

Particularly preferred sulfonic acid group-containing monomers are 1-acrylamido-1-propanesulfonic acid, 2-acrylamido-2-propanesulfonic acid, 2-acrylamido-2-methyl-1-propanesulfonic acid, 2-methacrylamido-2-methyl-1-propanesulfonic acid, 3-methacrylamido-2-hydroxy-propanesulfonic acid, allyl sulfonic acid, methallyl sulfonic acid, allyloxybenzene sulfonic acid, methallyloxybenzene sulfonic acid, 2-hydroxy-3-(2-propenyloxy)propanesulfonic acid, 2-methyl-2-propene-1-sulfonic acid, styrene sulfonic acid, vinylsulfonic acid, 3-sulfopropyl acrylate, 3-sulfopropyl methacrylate, sulfomethacrylamide, sulfomethylmethacrylamide, and mixtures of the above acids or water-soluble salts thereof. The sulfonic acid groups can be present in the polymers fully or partially in neutralized form, i.e. the acidic hydrogen atom of the sulfonic acid group can be replaced in some or all of the sulfonic acid groups with metal ions, preferably alkali metal ions, and in particular with sodium ions. The use of partially or fully neutralized sulfonic acid group-containing copolymers is preferred according to the invention.

In copolymers that contain only carboxylic acid group-containing monomers and sulfonic acid group-containing monomers, the monomer distribution of the copolymers that are preferably used according to the invention is preferably 5 to 95 wt. % in each case; particularly preferably, the proportion of the sulfonic acid group-containing monomer is 50 to 90 wt. %, and the proportion of the carboxylic acid group-containing monomer is 10 to 50 wt. %, with the monomers preferably being selected from those mentioned above. The molar mass of the sulfo-copolymers that are preferably used according to the invention can be varied in order to adapt the properties of the polymers to the desired intended use. Preferred cleaning agents are characterized in that the copolymers have molar masses of from 2,000 to 200,000 g·mol⁻¹, preferably from 4,000 to 25,000 g·mol⁻¹ and in particular from 5,000 to 15,000 g·mol⁻¹.

In another preferred embodiment, the copolymers comprise not only carboxyl group-containing monomers and sulfonic acid group-containing monomers but also at least one non-ionic, preferably hydrophobic monomer. In particular, the rinsing performance of dishwashing detergents according to the invention was able to be improved through the use of these hydrophobically modified polymers.

Particularly preferably, the shell material and/or the filling substance according to the invention, preferably the filling substance comprising at least one granular mixture, and/or optionally the viscoelastic, solid filling substance, further comprises an anionic copolymer, a copolymer comprising
i) carboxylic acid group-containing monomers
ii) sulfonic acid group-containing monomers
iii) non-ionic monomers, in particular hydrophobic monomers, being used as the anionic copolymer.

As the non-ionic monomers, monomers of the general formula R¹(R²)C═C(R³)—X—R⁴ are preferably used, in which R¹ to R³ represent, independently of one another, —H, —CH₃ or —C₂H₅, X represents an optionally present spacer group selected from —CH₂—, —C(O)O— and —C(O)—NH—, and R⁴ represents a straight-chain or branched saturated alkyl functional group having 2 to 22 carbon atoms or an unsaturated, preferably aromatic functional group having 6 to 22 carbon atoms.

Particularly preferred non-ionic monomers are butene, isobutene, pentene, 3-methylbutene, 2-methylbutene, cyclopentene, hexene, hexene-1,2-methlypentene-1,3-methlypentene-1, cyclohexene, methylcyclopentene, cycloheptene, methylcyclohexene, 2,4,4-trimethylpentene-1,2,4,4-trimethylpentene-2,2,3-dimethylhexene-1,2,4-dimethylhexene-1,2,5-dimethylhexene-1,3,5-dimethylhexene-1,4,4-dimethylhexane-1, ethylcyclohexene, 1-octene, α-olefins having 10 or more carbon atoms such as 1-decene, 1-dodecene, 1-hexadecene, 1-octadecene and C₂₂ α-olefin, 2-styrene, α-methylstyrene, 3-methyl styrene, 4-propyl styrene, 4-cyclohexylstyrene, 4-dodecyl styrene, 2-ethyl-4-benzyl styrene, 1-vinyl naphthalene, 2-vinyl naphthalene, acrylic acid methyl ester, acrylic acid ethyl ester, acrylic acid propyl ester, acrylic acid butyl ester, acrylic acid pentyl ester, acrylic acid hexyl ester, methacrylic acid methyl ester, N-(methyl)acrylamide, acrylic acid-2-ethylhexyl ester, methacrylic acid-2-ethylhexyl ester, N-(2-ethylhexyl)acrylamide, acrylic acid octyl ester, methacrylic acid octyl ester, N-(octyl)acrylamide, acrylic acid lauryl ester, methacrylic acid lauryl ester, N-(lauryl)acrylamide, acrylic acid stearyl ester, methacrylic acid stearyl ester, N-(stearyl)acrylamide, acrylic acid behenyl ester, methacrylic acid behenyl ester and N-(behenyl)acrylamide, or mixtures thereof, in particular acrylic acid, ethyl acrylate, 2-acrylamido-2-methylpropansulfonic acid (AMRS) and mixtures thereof.

The proportion of copolymers comprising at least one sulfonic acid group-containing monomer, preferably AMRS, is preferably 1 wt. % to 35 wt. %, in particular 3 wt. % to 30 wt. %, particularly 4 wt. % to 25 wt. %, preferably 5 wt. % to 20 wt. %, for example 10 wt. %, based on the total weight of the entire portion.

An optical brightener is preferably selected from the substance classes of distyrylbiphenyls, stilbenes, 4,4′-diamino-2,2′-stilbene disulfonic acids, cumarines, dihydroquinolones, 1,3-diarylpyrazolines, naphthalic acid imides, benzoxazole systems, benzisoxazole systems, benzimidazole systems, pyrene derivatives substituted with heterocycles, and mixtures thereof.

Particularly preferred optical brighteners include disodium-4,4′-bis-(2-morpholino-4-anilino-s-triazin-6-ylamino)stilbene disulfonate (for example available as Tinopal® DMS from BASF SE), disodium-2,2′-bis-(phenyl-styryl)disulfonate (for example available as Tinopal® CBS from BASF SE), 4,4′-bis[(4-anilino-6-[bis(2-hydroxyethyl)amino]-1,3,5-triazin-2-yl)amino]stilbene-2,2′-disulfonic acid (for example available as Tinopal® UNPA from BASF SE), hexasodium-2,2′-vinylenebis[(3-sulphonato-4,1-phenylene)imino[6-(diethylamino)-1,3,5-triazin-4,2-diyflimino]]bis-(benzene-1,4-disulfonate) (for example available as Tinopal® SFP from BASF SE), 2,2′-(2,5-thiophendiyl)bis[5-1,1-dimethylethyl)-benzoxazole (for example available as Tinopal® SFP from BASF SE) and/or 2,5-bis(benzoxazol-2-yl)thiophene.

It is preferable for the dye transfer inhibitor to be a polymer or a copolymer of cyclic amines such as vinylpyrrolidone and/or vinylimidazole. Polymers suitable as dye transfer inhibitors include polyvinylpyrrolidone (PVP), polyvinylimidazole (PVI), copolymers of vinylpyrrolidone and vinylimidazole (PVP/PVI), polyvinylpyridine-N-oxide, poly-N-carboxymethyl-4-vinylpyridium chloride, polyethylene glycol-modified copolymers of vinylpyrrolidone and vinylimidazole, and mixtures thereof. Particularly preferably, polyvinylpyrrolidone (PVP), polyvinylimidazole (PVI) or copolymers of vinylpyrrolidone and vinylimidazole (PVP/PVI) are used as dye transfer inhibitors. The polyvinylpyrrolidones (PVP) used preferably have an average molecular weight of from 2,500 to 400,000 and are commercially available from ISP Chemicals as PVP K 15, PVP K 30, PVP K 60 or PVP K 90, or from BASF as Sokalan® HP 50 or Sokalan® HP 53. The copolymers of vinylpyrrolidone and vinylimidazole (PVP/PVI) used preferably have a molecular weight in the range of from 5,000 to 100,000. A PVP/PVI copolymer is commercially available from BASF under the name Sokalan® HP 56, for example. Other dye transfer inhibitors that can be extremely preferably used are polyethylene glycol-modified copolymers of vinylpyrrolidone and vinylimidazole, which are available from BASF under the name Sokalan® HP 66, for example.

In the context of a preferred embodiment according to the invention, the viscoelastic, solid filling substance according to the invention contains incorporated solid particles (also referred to as particles in the following). Such dispersed solid particles are to be understood as solid substances which do not dissolve in the liquefied phase of the viscoelastic and solid filling substance according to the invention and are present as a separate “phase” within the viscoelastic and solid filling substance at temperatures of up to 5° C. units above the sol-gel temperature of the viscoelastic and solid filling substance according to the invention. During the production of the viscoelastic filling substances according to the invention, these particles are suspended in the liquid phase above the sol-gel temperature and then the liquid phase is cooled below the sol-gel temperature to obtain the viscoelastic filling substance according to the invention.

The solid particles are preferably selected from polymers, pearlescing pigments, microcapsules, speckles, bleaching agents (for example sodium percarbonate), or mixtures thereof.

Within the meaning of the present invention, microcapsules include any type of capsule known to a person skilled in the art, but in particular core-shell capsules and matrix capsules. Matrix capsules are porous shaped bodies that have a structure similar to a sponge. Core-shell capsules are shaped bodies that have a core and a shell. Capsules that have an average diameter X_{50.3} (volume average) of from 0.1 to 200 μm, preferably from 1 to 100 μm, more preferably from 5 to 80 μm, particularly preferably from 10 to 50 μm and in particular from 15 to 40 μm are suitable as microcapsules. The average particle size diameter X_{50.3} is be determined by sieving or by means of a Camsizer particle size analyzer from the company Retsch.

The microcapsules of the invention preferably contain at least one active ingredient, preferably at least one odorant. These preferred microcapsules are perfume microcapsules.

In a preferred embodiment of the invention, the microcapsules have a semi-permeable capsule wall (shell).

A semi-permeable capsule wall within the meaning of the present invention is a capsule wall that is semi-permeable, i.e. continuously releases small quantities of the capsule core over time, without the capsules e.g. being destroyed or opened e.g. by tearing. These capsules continuously release small quantities of the active ingredient contained in the capsule, e.g. perfume, over a long period of time.

In another preferred embodiment of the invention, the microcapsules have an impermeable shell. An impermeable shell within the meaning of the present invention is a capsule wall that is substantially not permeable, i.e. releases the capsule core only by the capsule being damaged or opened. These capsules contain significant quantities of the at least one odorant in the capsule core, and therefore when the capsule is damaged or opened, a very intense fragrance is provided. The fragrance intensities thus achieved are generally so high that lower amounts of the microcapsules can be used in order to achieve the same fragrance intensity as for conventional microcapsules.

In a preferred embodiment of the invention, the viscoelastic, solid filling substance according to the invention contains both microcapsules having a semipermeable shell and microcapsules having an impermeable shell. By using both types of capsule, a significantly improved fragrance intensity can be provided over the entire laundry cycle.

In another preferred embodiment of the invention, the composition according to the invention may also contain two or more different microcapsule types having semipermeable or impermeable shells.

High-molecular compounds are usually considered as materials for the shell of the microcapsules, such as protein compounds, for example gelatin, albumin, casein and others, cellulose derivatives, for example methylcellulose, ethylcellulose, cellulose acetate, cellulose nitrate, carboxymethylcellulose and others, and especially also synthetic polymers such as polyamides, polyethylene glycols, polyurethanes, epoxy resins and others. Preferably, melamine formaldehyde polymer, melamine urea polymer, melamine urea formaldehyde polymer, polyacrylate polymer or polyacrylate copolymer are used as the wall material, i.e. as the shell. Capsules according to the invention are for example, but not exclusively, described in US 2003/0125222 A1, DE 10 2008 051 799 A1 or WO 01/49817.

Preferred melamine formaldehyde microcapsules are prepared by melamine formaldehyde precondensates and/or the C₁-C₄ alkyl ethers thereof in water, by the at least one odor modulator compound and optionally other ingredients, such as at least one odorant, being condensed in the presence of a protective colloid. Suitable protective colloids are e.g. cellulose derivatives, such as hydroxyethyl cellulose, carboxymethyl cellulose and methylcellulose, polyvinylpyrrolidone, copolymers of N-vinylpyrrolidone, polyvinyl alcohols, partially hydrolyzed polyvinyl acetates, gelatin, arabic gum, xanthan gum, alginates, pectins, degraded starches, casein, polyacrylic acid, polymethacrylic acid, copolymerisates of acrylic acid and methacrylic acid, sulfonic acid group-containing water-soluble polymers having a content of sulfoethyl acrylate, sulfoethyl methacrylate or sulfopropyl methacrylate, and polymerisates of N-(sulfoethyl)-maleinimide, 2-acrylamido-2-alkyl sulfonic acids, styrene sulfonic acids and formaldehyde and condensates of phenol sulfonic acids and formaldehyde.

It is preferable for the surface of the microcapsules used according to the invention to be coated entirely or in part with at least one cationic polymer. Accordingly, at least one cationic polymer from polyquaternium-1, polyquaternium-2, polyquaternium-4, polyquaternium-5, polyquaternium-6, polyquaternium-7, polyquaternium-8, polyquaternium-9, polyquaternium-10, polyquaternium-11, polyquaternium-12, polyquaternium-13, polyquaternium-14, polyquaternium-15, polyquaternium-16, polyquaternium-17, polyquaternium-18, polyquaternium-19, polyquaternium-20, polyquaternium-22, polyquaternium-24, polyquaternium-27, polyquaternium-28, polyquaternium-29, polyquaternium-30, polyquaternium-31, polyquaternium-32, polyquaternium-33, polyquaternium-34, polyquaternium-35, polyquaternium-36, polyquaternium-37, polyquaternium-39, polyquaternium-43, polyquaternium-44, polyquaternium-45, polyquaternium-46, polyquaternium-47, polyquaternium-48, polyquaternium-49, polyquaternium-50, polyquaternium-51, polyquaternium-56, polyquaternium-57, polyquaternium-61, polyquaternium-69 or polyquaternium-86 is suitable as a cationic polymer for coating the microcapsules. Polyquaternium-7 is very particularly preferred. The polyquaternium nomenclature used in this application for the cationic polymers is taken from the declaration for cationic polymers according to the International Nomenclature of Cosmetic Ingredients (INCI declaration) for cosmetic raw materials.

Microcapsules that can preferably be used have an average diameter X_{50.3} in the range of from 1 to 100 preferably from 5 to 95 in particular from 10 to 90 for example from 10 to 80

The shell of the microcapsules surrounding the core or (filled) cavity preferably has an average thickness in the range of from approximately 5 to 500 nm, preferably of from approximately 50 nm to 200 nm, in particular of from approximately 70 nm to approximately 180 nm.

Pearlescing pigments are pigments that have a pearlescent shine. Pearlescing pigments consist of thin sheets that have a high refraction index, and partially reflect the light and are partially transparent to the light. The pearlescent shine is generated by interference of the light hitting the pigment (interference pigment). Pearlescing pigments are usually thin sheets of the above-mentioned material, or contain the above-mentioned material as thin, multilayered films or as components arranged in parallel in a suitable carrier material.

The pearlescing pigments that can be used according to the invention are either natural pearlescing pigments such as fish silver (guanine/hypoxanthine mixed crystals from fish scales) or mother of pearl (from ground seashells), monocrystalline, sheet-like pearlescing pigments such as bismuth oxychloride and pearlescing pigments with a mica base and a mica/metal oxide base. The latter pearlescing pigments are mica that has been provided with a metal oxide coating.

Pearlescing pigments having a mica base and mica/metal oxide base are preferred according to the invention. Mica is a phyllosilicate. The most important representatives of these silicates are muscovite, phlogopite, paragonite, biotite, lepidolite, and margarite. In order to produce the pearlescing pigments in conjunction with metal oxides, mica, primarily muscovite or phlogopite, is coated with a metal oxide. Suitable metal oxides are, inter alia, TiO₂, Cr₂O₃, and Fe₂O₃. Interference pigments and colored luster pigments are obtained as pearlescing pigments according to the invention by suitable coating. These pearlescing pigment types additionally have color effects as well as a glittering optical effect. Furthermore, the pearlescing pigments that can be used according to the invention also contain a color pigment that does not derive from a metal oxide.

The grain size of the pearlescing pigments that are preferably used is preferably between 1.0 μm and 100 μm, particularly preferably between 10.0 and 60.0 μm, at an average diameter X_{50.3} (volume average).

Within the meaning of the invention, “speckles” are understood to mean macroparticles, in particular macrocapsules, that have an average diameter X_{50.3} (volume average) of more than 300 μm, in particular from 300 to 1,500 μm, preferably from 400 to 1,000 μm.

Speckles are preferably matrix capsules. The matrix is preferably colored. The matrix is formed for example by gelation, polyanion-polycation interactions or polyelectrolyte-metal ion interactions, and this is well known in the prior art, just like the production of particles using these matrix-forming materials. An example of a matrix-forming material is alginate. In order to produce alginate-based speckles, an aqueous alginate solution, optionally also containing the active ingredient or active ingredients to be included, is subject to dripping and is then hardened in a precipitation bath containing Ca²⁺ ions or Al³⁺ ions. Alternatively, other matrix-forming materials may be used instead of alginate.

In a preferred embodiment, the filling substances according to the invention, in particular the granular mixture and/or the viscoelastic, solid filling substances, in particular as dishwashing detergents, contain, as an additional component, at least one zinc salt as a glass corrosion inhibitor. The zinc salt can be an inorganic or organic zinc salt. The zinc salt to be used according to the invention preferably has a solubility in water of greater than 100 mg/1, preferably greater than 500 mg/1, particularly preferably greater than 1 g/l, and in particular greater than 5 g/l (all solubilities at 20° C. water temperature). The inorganic zinc salt is preferably selected from the group consisting of zinc bromide, zinc chloride, zinc iodide, zinc nitrate, and zinc sulfate. The organic zinc salt is preferably selected from the group consisting of zinc salts of monomeric or polymeric organic acids, particularly from the group of zinc acetate, zinc acetyl acetonate, zinc benzoate, zinc formiate, zinc lactate, zinc gluconate, zinc ricinoleate, zinc abietate, zinc valerate, and zinc-p-toluene sulfonate. In an embodiment that is particularly preferred according to the invention, zinc acetate is used as a zinc salt. The zinc salt is preferably contained in filling substances according to the invention, in particular in the at least one granular mixture and/or the viscoelastic, solid filling substances, in an amount of from 0.01 wt. % to 5 wt. %, particularly preferably in an amount of from 0.05 wt. % to 3 wt. %, in particular in an amount of from 0.1 wt. % to 2 wt. %, based on the total weight of the composition. In addition or alternatively to the above-mentioned salts (particularly the zinc salts), polyethylenimines such as those which are available under the name Lupasol® (BASF) are preferably used as glass corrosion inhibitors in an amount of from 0 to 5 wt. %, in particular from 0.01 to 2 wt. %.

Examples of filling substances which can be used in particular for washing agent portions are the filling substances F1 to F6 in the following table:

| | F1 | F2 | F3 | F4 | F5 | F6 |
|---|---|---|---|---|---|---|
| | [wt. %] | [wt. %] | [wt. %] | [wt. %] | [wt. %] | [wt. %] |
| C₁₁₋₁₃ alkylbenzene sulfonic acid | 23.0 | 26.0 | 23.0 | 9.0 | 3.0 | 6.0 |
| (C₁₂₋₁₄) fatty alcohol ether sulfate | | | | 9.0 | 4.6 | 6.0 |
| having 2 units of ethylene oxide | | | | | | |
| C₁₃₋₁₅ alkyl alcohol branched at | 24.0 | 27.0 | 24.0 | 6.0 | | 3.0 |
| the 2 position, ethoxylated with 8 | | | | | | |
| mol ethylene oxide | | | | | | |
| Fatty alcohol ether ethoxylated | | | | | 3.7 | |
| with 7 mol ethylene oxide | | | | | | |
| Glycerol | 9.0 | 9.0 | 9.0 | | | |
| 2-aminoethanol | 6.8 | 6.8 | 6.8 | | | |
| Sodium hydroxide | | | | 4.0 | 0.6 | 2.0 |
| Ethoxylated polyethyleneimine | 5.0 | 5.0 | 5.0 | | | |
| C₁₂₋₁₈ fatty acid | 7.5 | 7.5 | 7.5 | 1.0 | 1.3 | 3.0 |
| Diethylenetriamine-N,N,N′,N′,N″- | 0.6 | 0.6 | 0.6 | 3.0 | 0.2 | 1.0 |
| penta(methylenephosphonic acid), | | | | | | |
| heptasodium salt (sodium | | | | | | |
| DTPMP) | | | | | | |
| Citric acid | | | | up to pH | up to pH | 2.0 |
| | | | | 8.5 | 8.5 | |
| Boric acid | | | | 1.0 | 0.5 | 1.0 |
| 1,2-propylene glycol | 4.5 | 4.5 | 4.5 | 2.0 | 0.5 | 1.0 |
| Ethanol | 4.0 | 4.0 | 4.0 | 1.0 | 0.2 | 1.0 |
| Sodium bisulfite | 0.1 | 0.1 | 0.1 | | | |
| Denatonium benzoate | 0.001 | 0.001 | 0.001 | 0.001 | 0.001 | 0.001 |
| Soil-release polymer made from | 1.0 | 1.0 | 0.6 | 0.5 | | 0.5 |
| ethylene terephthalate and | | | | | | |
| polyethylene oxide terephthalate | | | | | | |
| Copolymers of N- | | | 0.15 | 0.2 | | |
| vinylpyrrolidone and N- | | | | | | |
| vinylimidazole (dye transfer | | | | | | |
| inhibitor) | | | | | | |
| 1,3:2,4-di-O-benzylidene-D- | 1.2 | 1.2 | 1.2 | 1.2 | 1.2 | 1.2 |
| sorbitol | | | | | | |
| Perfume, dye, protease, amylase, | 1.7 | 1.7 | 1.5 | 2.6 | 1.0 | 2.6 |
| lipase, cellulase, optical | | (without | (without | | | |
| brightener | | dye) | optical | | | |
| | | | brightener) | | | |
| Water | up to 100 | up to 100 | up to 100 | up to 100 | up to 100 | up to 100 |

For a dishwashing agent, in particular an automatic dishwashing agent, it is preferred and advantageous if the filling substance, comprising at least one granular mixture, has a composition according to the tables below.

The granular mixtures which can be used as a filling substance preferably have the following compositions:

| | Wt. % |
|---|---|
| Citrate, Na salt | 10-25 |
| Phosphonate (e.g. HEDP) | 0-10 |
| MGDA, Na salt | 0-40 |
| Disilicate, Na salt | 0-40 |
| Soda | 10-30 |
| Percarbonate, Na salt | 5.0-20.0 |
| Bleach catalyst (preferably Mn-based) | 0.0-0.8 |
| Bleach activator (e.g. TAED) | 1.0-4.0 |
| Non-ionic surfactant(s), e.g. fatty alcohol alkoxylate, | 1.5-15.0 |
| preferably 20-40 EO, optionally end-capped | |
| Polycarboxylate | 0.5-15 |
| Cationic copolymer | 0.0-1.0 |
| Sulfonic acid group-containing acrylate copolymer | 0.0-25 |
| Disintegrant - (e.g. crosslinked PVP) | 0.0-3.0 |
| Protease preparation (tq) | 1.0-7 |
| Amylase preparation (tq) | 0.2-6 |
| Silver protection (e.g. benzotriazole or cysteine) | 0.0-1.0 |
| Perfume | 0.0-0.5 |
| Dye solution | 0.0-1.5 |
| Zn salt (e.g. acetate) | 0.01-0.5 |
| Sodium sulfate | 0.0-25 |
| Water | 0.0-3 |
| pH adjuster (e.g. citric acid) | 0.0-5 |
| Processing aids | 0-10 |

The granular mixtures according to the table above are free-flowing and can easily be poured into the shells according to the invention.

The granular mixtures which can be used as filling substances particularly preferably have the following compositions.

| | Wt. % |
|---|---|
| Citrate, Na salt | 15-20 |
| Phosphonate (e.g. HEDP) | 2.5-7.5 |
| MGDA, Na salt | 0-25 |
| Disilicate, Na salt | 5-35 |
| Soda | 10-25 |
| Percarbonate, Na salt | 10-15 |
| Bleach catalyst (preferably Mn-based) | 0.02-0.5 |
| Bleach activator (e.g. TAED) | 1-3 |
| Non-ionic surfactant(s), e.g. fatty alcohol alkoxylate, | 2.5-10 |
| preferably 20-40 EO, optionally end-capped | |
| Polycarboxylate | 4-10 |
| Sulfonic acid group-containing acrylate copolymer | 4.0-15 |
| Cationic copolymer | 0-0.75 |
| Disintegrant - (e.g. crosslinked PVP) | 0-1.5 |
| Protease preparation (tq) | 1.5-5 |
| Amylase preparation (tq) | 0.5-3 |
| Silver protection (benzotriazole or cysteine) | 0-0.5 |
| Perfume | 0.05-0.25 |
| Dye solution | 0.0-1 |
| Zn salt (e.g. acetate) | 0.1-0.3 |
| Sodium sulfate | 0.0-10 |
| Water | 0.0-1.5 |
| pH adjuster (e.g. citric acid) | 0-1.5 |
| Processing aids | 0-5 |

The granular mixtures according to Table 2 above are also free-flowing and can easily be poured into the shells according to the invention.

Points 1 to 61 below describe specific embodiments of the invention. The reference numerals of the figures have been given below for the sake of clarity and not to restrict the scope of points 1 to 61:
1. A device (1) for producing a water-soluble shell (2) for receiving a filling substance (9), the device comprising a basin (3) which is filled with a melt (4) of a shell material (5), wherein the shell material (5) is polymer-containing and water-soluble and solid under normal conditions, and a male mold (6) which is movably arranged in the region of the basin (3), can be automatically submerged into the melt (4) and can be removed from the basin (3) in order to form a water-soluble shell (2) (preferably abutting the male mold (6), particularly preferably abutting the male mold (6) after the male mold (6) is removed from the basin (3)) made of the shell material (5).
2. The device (1) according to point 1, wherein the male mold (6) has a temperature regulator.
3. The device (1) according to either of the preceding points, wherein the basin (3) substantially has an inverted shape of the male mold (6).
4. The device (1) according to one of the preceding points, wherein the shell material (5) contains at least one active ingredient.
5. The device (1) according to one of the preceding points, wherein the shell material (5) contains at least one bittering agent, in particular denatonium benzoate.
6. The device (1) according to one of the preceding points, wherein the shell material (5) is elastic under normal conditions.
7. The device (1) according to one of the preceding points, wherein granules (7) are contained in the melt (4).
8. The device (1) according to point 7, wherein the granules (7) contain at least one active ingredient.
9. The device (1) according to one of the preceding points, wherein at least one further basin (3b) is provided with at least one further melt (4b) of a further shell material (5b), wherein the male mold (6) having the shell (2; 2a) abutting it can be automatically submerged into the further melt (4b) and can be removed from the further melt (4b) in order to form a further water-soluble shell (2b) abutting the water-soluble shell (2; 2a) abutting the male mold (6).
10. The device (1) according to point 9, wherein the shell materials (5a, 5b) contain different active ingredients and/or the melts (4a, 4b) contain different granules (7).
11. The device (1) according to either point 9 or 10, wherein the shell materials (5a, 5b) have different optical properties when they are solid.
12. The device (1) according to one of the preceding points, wherein one end of the male mold (6) has a portion comprising a filling substance (9).
13. The device (1) according to one of the preceding points, wherein the male mold (6) is designed in such a way that a rigid shell (2) abutting it cannot be stripped off
14. The device (1) according to point 13, wherein the male mold (6) is wider in a distal region than in a proximal region.
15. The device (1) according to either point 13 or 14, wherein the male mold (6) has an unevenness (11).
16. The device (1) according to one of the preceding points, wherein the male mold (6) can be set in vibration.
17. A method for producing a water-soluble shell (2) for receiving a filling substance (9), wherein
   a device (1) according to one of points 1-16 is provided,
   a melt (4) is produced from shell material (5), wherein the ingredients of the shell material that are solid under normal conditions are preferably comminuted before melting such that a powder having an average particle size X_{50.3} (volume average) of less than 100 μm is present,
   the male mold (6) is lowered into the melt at a temperature below a melting temperature of the melt (4) such that a contact surface of the male mold (6) is covered with shell material (5),
   a shell (2) is formed by solidifying the shell material (5) on the male mold (6), and
   the male mold (6) having a shell (2) adhering thereto is lifted out of the basin (3) before, during or after solidification, and
   the shell (2) is released from the male mold (3).
18. The method according to point 17, wherein the male mold (6) is lowered into the melt (4) to a depth which is greater than a maximum width of the male mold (6).
19. The method according to either point 17 or 18, wherein the shell (2) is released by rolling it out or turning it inside out.
20. The method according to one of points 17 to 19, wherein one end of the male mold (6) has a portion comprising a filling substance (9) and the portion is separated when the shell (2) is released such that the shell (2) is detached having the filling substance (9) arranged therein.
21. The method according to one of points 17 to 20, wherein the shell (2) is detached under the effect of sound waves, in particular ultrasonic waves.
22. The method according to one of points 17 to 21, wherein the shell (2) is hardened by drying it with hot air.
23. The method according to one of points 17 to 22, wherein a layer is vapor-deposited onto the shell (2).
24. A method for producing a portion (12) for use as a washing or cleaning agent, comprising the steps of
   providing a shell (2) by means of a method according to one of points 17 to 23,
   filling the shell (2) with at least one filling substance (9) comprising at least one granular mixture which preferably comprises at least one washing and/or cleaning agent active substance, and
   optionally, but preferably, closing the shell (2).
25. The method according to point 24, wherein the shell (2) is closed by means of sealing with a water-soluble film.
26. The method according to either point 24 or 25, wherein the shell (2) is closed by wrapping it in a shrink film made of water-soluble film.
27. The method according to points 24 to 26, wherein the shell (2) is closed by applying a lid made of shell material (5) or its melt (4), preferably made of the shell material (5) which was provided for the shell (2).
28. The method according to items 24 to 27, wherein the shell (2) is at least partially, preferably completely, closed by applying a viscoelastic and solid covering substance (14).
29. A shell (2) for a portion (12) suitable for use as a washing or cleaning agent, produced by a method according to one of points 17 to 23.
30. A portion (12) for use as a washing or cleaning agent containing
   (a) a shell (2) made of a melt (4) of a polymer-containing and water-soluble shell material (5) which is solid under normal conditions, and
   (b) a filling substance (9) located in said shell (2) and comprising at least one granular mixture which preferably contains at least one washing and/or cleaning agent active substance, and
   (c) optionally a further phase, preferably a viscoelastic and solid phase.
31. The portion (12) according to point 30, characterized in that at least one polymer is contained as a polymer of the shell material, selected from (optionally acetalized) polyvinyl alcohol (PVOH), copolymers of polyvinyl alcohol, polyvinyl pyrrolidone, polyethylene oxide, gelatin, cellulose and their derivatives, acrylic acid-containing polymers, polyacrylamides, oxazoline polymers, polystyrene sulfonates, polyurethanes, polyesters, polyethers and mixtures thereof, preferably from (optionally acetalized) polyvinyl alcohol (PVOH), copolymers of polyvinyl alcohol, polyethylene oxide, gelatin and mixtures thereof.
32. The portion (12) according to either point 30 or 31, characterized in that the shell (2) additionally contains at least one bittern, in particular denatonium benzoate.
33. The portion (12) according to one of points 30 to 32, characterized in that the shell (2) is produced by a method according to one of points 24 to 28.
34. The portion (12) according to one of points 30 to 33, characterized in that the at least one washing and/or cleaning agent active ingredient is selected from the group of builders, enzymes, copolymers comprising at least one sulfonic acid group-containing monomer, alkalizing agents, optical brighteners, color transfer inhibitors, soil-release polymers, bleaching agents, bleach activators, bleach catalysts, silver protecting agents and/or glass corrosion inhibitors.
35. The portion (12) according to one of points 30 to 34, characterized in that it contains a total amount of all filling substances of from 1 to 50 g, preferably in an amount of from 3 to 40 g, in particular in an amount of from 5 to 35 g, particularly preferably in an amount of from 7 to 30 g, particularly preferably in an amount of from 10 to 25 g.
36. The portion (12) according to one of points 30 to 35, characterized in that the at least one granular mixture is contained in an amount of from 1 to 40 g, preferably in an amount of from 5 to 35 g, in particular in an amount of from 7 to 30 g, particularly preferably in an amount of from 10 to 25 g, particularly preferably in an amount of from 12 to 20 g.
37. The portion (12) according to one of points 30 to 36, characterized in that, in addition to the filling substance comprising at least one granular mixture, a further phase, preferably a viscoelastic and solid phase, is contained, which is preferably arranged a) next to and/or b) on the filling substance comprising at least one granular mixture, and/or c) partially covers, preferably completely covers and/or closes, at least one opening of the shell (2).
38. The portion (12) according to one of points 30 to 37, characterized in that the further phase, preferably viscoelastic and solid phase, contains at least one polymer selected from (optionally acetalized) polyvinyl alcohol (PVOH), copolymers of polyvinyl alcohol, polyvinylpyrrolidone, polyethylene oxide, gelatin, cellulose and derivatives thereof, acrylic acid-containing polymers, polyacrylamides, oxazoline polymers, polystyrene sulfonates, polyurethanes, polyesters, polyethers and mixtures thereof, preferably from (optionally acetalized) polyvinyl alcohol (PVOH), copolymers of polyvinyl alcohol, polyethylene oxide, gelatin and mixtures thereof.
39. The portion (12) according to one of points 30 to 38, characterized in that the further phase, preferably viscoelastic and solid phase, contains, based on the total weight of said further phase,
   (i) a total amount of from 0.1 to 70 wt. % of at least one surfactant, and
   (ii) a total amount of at least 0.5 wt. % of at least one organic gelator compound having a molar mass of <1000 g/mol, a solubility in water of less than 0.1 g/l (20° C.) and a structure containing at least one hydrocarbon structural unit having 6 to 20 carbon atoms (preferably at least one carbocyclic, aromatic structural unit) and additionally an organic structural unit covalently bonded to the aforementioned hydrocarbon unit which structural unit has at least two groups selected from —OH, —NH—, or mixtures thereof and
   (iii) optionally water.
40. The portion (12) according to one of points 30 to 39, characterized in that said further phase, preferably a viscoelastic and solid phase, has a storage modulus of between 10³ Pa and 10⁸ Pa, preferably between 10⁴ Pa and 10⁸ Pa and a loss modulus (at 20° C., with a deformation of 0.1% and a frequency of 1 Hz), and the storage modulus in the frequency range between 10′ Hz and 10 Hz is at least twice as great as the loss modulus, preferably at least five times as great as the loss modulus, particularly preferably at least ten times as great as the loss modulus.
41. The portion (12) according to one of points 30 to 40, characterized in that the storage modulus of said further phase, preferably viscoelastic and solid phase, is in a range of from 10⁵ Pa to 10⁷ Pa.
42. The portion (12) according to one of points 39 to 41, characterized in that the organic gelator compound is selected from benzylidene alditol compound, diketopiperazine compound, dibenzylcystine compound, hydrogenated castor oil, hydroxystearic acid, N—(C₈-C₂₄)-hydrocarbyl glyconamide, or mixtures thereof.
43. The portion (12) according to one of points 39 to 42, characterized in that said further phase, preferably a viscoelastic and solid phase, contains at least one benzylidene alditol compound of formula (I) as the organic gelator compound

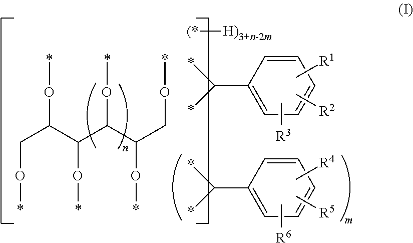

where
*—represents a covalent single bond between an oxygen atom of the alditol backbone and the provided functional group,
n represents 0 or 1, preferably 1,
m represents 0 or 1, preferably 1,
R¹, R² and R³ represent, independently of one another, a hydrogen atom, a halogen atom, a C₁-C₄ alkyl group, a cyano group, a nitro group, an amino group, a carboxyl group, a hydroxy group, a —C(═O)—NH—NH₂ group, a —NH—C(═O)—(C₂-C₄-alkyl) group, a C₁-C₄ alkoxy group, a C₁-C₄ alkoxy C₂-C₄ alkyl group, with two of the functional groups forming, together with the remainder of the molecule, a 5-membered or 6-membered ring,
R⁴, R⁵ and R⁶ represent, independently of one another, a hydrogen atom, a halogen atom, a C₁-C₄ alkyl group, a cyano group, a nitro group, an amino group, a carboxyl group, a hydroxy group, a —C(═O)—NH—NH₂ group, a —NH—C(═O)—(C₂-C₄-alkyl) group, a C₁-C₄ alkoxy group, a C₁-C₄ alkoxy C₂-C₄ alkyl group, with two of the functional groups forming, together with the remainder of the molecule, a 5-membered or 6-membered ring.
44. The portion (12) according to point 43, characterized in that the alditol backbone according to formula (I) is derived from D-glucitol, D-mannitol, D-arabinitol, D-ribitol, D-xylitol, L-glucitol, L-mannitol, L-arabinitol, L-ribitol, or L-xylitol.
45. The portion (12) according to either point 43 or 44, characterized in that R¹, R², R³, R⁴, R⁵ and R⁶ are, independently of one another, a hydrogen atom, methyl, ethyl, chlorine, fluorine, or methoxy, preferably a hydrogen atom.
46. The portion (12) according to one of items 39 to 45, characterized in that said further phase, preferably viscoelastic and solid phase, contains at least one benzylidene alditol compound of formula (I-1) as the organic gelator compound

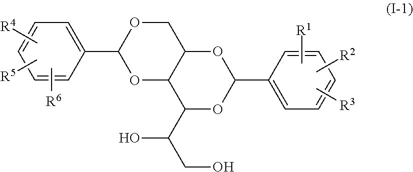

where R¹, R², R³, R⁴, R⁵ and R⁶ are as defined in point 43.
47. The portion (12) according to one of points 39 to 46, characterized in that said further phase, preferably a viscoelastic and solid phase, contains at least one benzylidene alditol compound composed of 1,3:2,4-di-O-benzylidene-D-sorbitol; 1,3:2,4-di-O-(p-methylbenzylidene)-D-sorbitol; 1,3:2,4-di-O-(p-chlorobenzylidene)-D-sorbitol; 1,3:2,4-di-O-(2,4-dimethylbenzylidene)-D-sorbitol; 1,3:2,4-di-O-(p-ethylbenzylidene)-D-sorbitol; 1,3:2,4-Di-O-(3,4-dimethylbenzylidene)-D-sorbitol or mixtures thereof, as the organic gelator compound.
48. The portion (12) according to one of points 39 to 47, characterized in that, based on the total weight of the further phase, preferably viscoelastic and solid phase, the organic gelator compound is contained in a total amount of from 0.5 to 10.0 wt. %, in particular from 0.8 to 5.0 wt. %, more preferably between 1.0 wt. % and 4.5 wt. %, very particularly preferably between 1.0 and 4.0 wt. %.
49. The portion (12) according to one of points 30 to 48, characterized in that, based on the total weight of said further phase, preferably viscoelastic and solid phase, water is contained in a total amount of between 0 and 45 wt. %, in particular between 0 and 25 wt. %.
50. The portion (12) according to one of points 30 to 49, characterized in that said further phase, preferably viscoelastic and solid phase, additionally contains at least one organic solvent having a molecular weight of at most 500 g/mol (preferably selected from (C₂-C₈) alkanols having at least one hydroxyl group (particularly preferably ethanol, ethylene glycol, 2-propanediol, glycerol, 1,3-propanediol, n-propanol, isopropanol, 1,1,1-trimethylolpropane, 2-methyl-1,3-propanediol, 2-hydroxymethyl-1,3-propanediol), triethylene glycol, butyl diglycol, polyethylene glycols having a weight-average molar mass M_{w} of at most 500 g/mol, glycerol carbonate, propylene carbonate, 1-methoxy-2-propanol, 3-methoxy-3-methyl-1-butanol, butyl lactate, 2-isobutyl-2-methyl-4-hydroxymethyl-1,3-dioxolane, 2,2-dimethyl-4-hydroxymethyl-1,3-dioxolane, dipropylene glycol, or mixtures thereof).
51. The portion (12) according to point 50, characterized in that the above-mentioned organic solvent is contained in the further phase, based on the total weight of said further phase, preferably viscoelastic and solid phase, in a total amount of from 5 to 40 wt. %, in particular from 10 to 35 wt. %.
52. The portion (12) according to one of points 30 to 51, characterized in that at least one anionic surfactant, preferably at least one anionic surfactant selected from the group consisting of C₈₋₁₈ alkylbenzenesulfonates, olefin sulfonates, C₁₂₋₁₈ alkane sulfonates, ester sulfonates, alkyl sulfates, alkenyl sulfates, fatty alcohol ether sulfates and mixtures thereof, is contained in said further phase, preferably viscoelastic and solid phase.
53. The portion (12) according to one of points 30 to 52, characterized in that at least one anionic surfactant of formula (T-1) is contained in said further phase, preferably viscoelastic and solid phase,

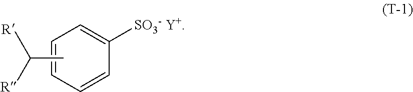

where
R′ and R″ are, independently of one another, H or alkyl, and together contain 9 to 19, preferably 9 to 15 and in particular 9 to 13, C atoms, and Y⁺ is a monovalent cation or the nth part of an n-valent cation (in particular Na⁺).
54. The portion (12) according to one of points 30 to 53, characterized in that at least one non-ionic surfactant is contained in said further phase, preferably viscoelastic and solid phase.
55. The portion (12) according to one of points 30 to 54, characterized in that said further phase, preferably viscoelastic and solid phase, contains at least one non-ionic surfactant of the formula (T-2)

R²—O—(XO)ₘ—H, (T-2)
where
R² represents a linear or branched C₈-C₁₈ alkyl group, an aryl group or an alkyl aryl group,
XO represents, independently of one another, an ethylene oxide (EO) grouping or a propylene oxide (PO) grouping,
m represents integers from 1 to 50.
56. The portion (12) according to one of points 30 to 55, characterized in that surfactant is contained in a total amount of from 5 to 70 wt. %, more preferably from 5 to 65 wt. %, more preferably from 5 to 60 wt. %, more preferably from 10 to 70 wt. %, more preferably from 10 to 65 wt. %, more preferably from 10 to 60 wt. %, more preferably from 15 to 70 wt. %, more preferably from 15 to 65 wt. %, more preferably from 15 to 60 wt. %, particularly preferably from 20 to 70 wt. %, more preferably from 20 to 65 wt. %, more preferably from 20 to 60 wt. %, very particularly preferably from 25 to 70 wt. %, more preferably from 25 to 65 wt. %, more preferably from 25 to 60 wt. %, even more preferably from 30 to 70 wt. %, more preferably from 30 to 65 wt. %, more preferably from 30 to 60 wt. %, in said further phase, preferably viscoelastic and solid phase, based on the total weight of said phase.
57. The portion (12) according to one of points 30 to 56, characterized in that surfactant is contained in the entire filling substance in a total amount of from 0.1 to 5.0 wt. %, in particular 0.2 to 4.0 wt. %, based on the total weight of the entire filling substance.
58. The portion (12) according to one of points 30 to 56, characterized in that said at least one further phase, preferably viscoelastic and solid phase, is in the design of a shaped body.
59. The portion (12) according to item 58, characterized in that the shaped body has a weight of at least 1 g, particularly preferably at least 5 g, very particularly preferably from 10 to 30 g.
60. The portion (12) according to one of points 30 to 59, characterized in that it is water-soluble.
61. The portion (12) according to one of points 30 to 60, characterized in that said further phase, preferably viscoelastic and solid phase, is transparent.

For an embodiment of the portion for use as a washing agent, points 1 to 56 and 58 to 60 above are in turn particularly preferred.

For an embodiment of the portion for use as a dishwashing detergent, points 1 to 51, 54, 55 and 57 to 60 above are in turn particularly preferred.

The invention is not restricted to the embodiments mentioned above. Deviations from this are also conceivable. For example, any number of male molds, for example arranged in parallel, can be provided. The portion can also be sealed by closing it using a form-fitting lid, for example made of the shell material.

### LIST OF REFERENCE NUMERALS

1 Device
2 Shell
3 Basin
4 Melt
5 Shell material
6 Male mold
7 Granules
8 End of the male mold
9 Filling substance
10 Separating surface
11 Unevenness
12 Portion for use as a washing or cleaning agent
13 Lid or covering substance
101-108 Steps

What is claimed is:

1. A device for producing a water-soluble shell for receiving a filling substance, the device comprising a basin which is filled with a melt of a shell material, wherein the shell material is polymer-containing and water-soluble and solid under normal conditions, and a male mold which is movably arranged in the region of the basin, can be automatically submerged into the melt and can be removed from the basin in order to form a water-soluble shell, optionally abutting the male mold, made of the shell material.

2. The device according to claim 1, wherein the male mold has a temperature regulator.

3. The device according to claim 1, wherein the basin substantially has an inverted shape of the male mold.

4. The device according to claim 1, wherein the male mold which is arranged movably in the region of the basin can be automatically submerged into the melt and can be removed from the basin in order to form a water-soluble shell abutting the male mold made of the shell material (5).

5. The device according to claim 1, wherein at least one further basin is provided with at least one further melt of a further shell material, wherein the male mold having the shell abutting it can be automatically submerged into the further melt and can be removed from the further melt in order to form a further water-soluble shell abutting the water-soluble shell abutting the male mold.

6. The device according to claim 5, wherein the shell materials have different optical properties when they are solid.

7. The device according to claim 1, wherein one end of the male mold has a portion comprising a filling substance.

8. The device according to claim 1, wherein the male mold is designed such that a rigid shell abutting it cannot be stripped off.

9. The device according to claim 8, wherein the male mold is wider in a distal region than in a proximal region.

10. The device according to claim 8, wherein the male mold has an unevenness.

11. The device according to claim 8, wherein the male mold can be set in vibration.

12. A method for producing a water-soluble shell for receiving a filling substance, wherein
a device according to claim 1 is provided,
the male mold is lowered into the melt at a temperature below a melting temperature of the melt such that a contact surface of the male mold is covered with shell material,
a shell is formed by solidifying the shell material on the male mold, and
the male mold having a shell adhering thereto is lifted out of the basin before, during or after solidification, and
the shell is released from the male mold.

13. The method according to claim 12, wherein the male mold is lowered into the melt to a depth which is greater than a maximum width of the male mold.

14. The method according to claim 12, wherein the shell is released by rolling it out or turning it inside out.

15. The method according to claim 12, wherein one end of the male mold has a portion comprising a filling substance and the portion is separated therefrom when the shell is released such that the shell is detached with the filling substance arranged therein.

16. A shell, for a portion as a washing or cleaning agent, produced by the method according to claim 12.

17. A portion of a washing or cleaning agent containing
(a) a shell made of a melt of a polymer-containing and water-soluble shell material which is solid under normal conditions, and
(b) a filling substance located in said shell and comprising at least one granular mixture which contains at least one washing and/or cleaning agent active substance, and
(c) optionally a further phase.

18. The portion according to claim 17, wherein at least one polymer is contained as a polymer of the shell material, selected from (optionally acetalized) polyvinyl alcohol (PVOH), copolymers of polyvinyl alcohol, polyvinylpyrrolidone, polyethylene oxide, gelatins, celluloses and derivatives thereof, acrylic acid-containing polymers, polyacrylamides, oxazoline polymers, polystyrene sulfonates, polyurethanes, polyesters, polyethers and mixtures thereof.

19. The portion according to claim 17, wherein the at least one washing and/or cleaning agent active substance is selected from the group of builders, enzymes, copolymers comprising at least one sulfonic acid group-containing monomer, alkalizing agents, optical brighteners, color transfer inhibitors, soil-release polymers, bleaching agents, bleach activators, bleach catalysts, silver protecting agents and/or glass corrosion inhibitors.

20. The portion according to claim 17, wherein in addition to the at least one granular mixture, a further phase, is contained, which is arranged a) next to and/or b) on the filling substance comprising at least one granular mixture, and/or c) partially and/or completely covers and/or closes, at least one opening of the shell.
